(19) United States
(12) Patent Application Publication
(10) Pub. No.: US 2026/0339911 A1
(43) Pub. Date: Oct. 29, 2026

(54) TECHNIQUES FOR TRACKING AND RECLAIMING FREE SPACE IN A LOG-STRUCTURED SYSTEM

(71) Applicant: Dell Products L.P., Hopkinton, MA (US)

(72) Inventors: Andrew T. Feld, Keene, NH (US); Ajay Karri, South Grafton, MA (US); James Vega McCoy, Holliston, MA (US); Christopher Seibel, Walpole, MA (US); Vamsi K. Vankamamidi, Hopkinton, MA (US)

(73) Assignee: Dell Products L.P., Hopkinton, MA (US)

(21) Appl. No.: 19/181,845

(22) Filed: Apr. 17, 2025

(51) Int. Cl. G06F 16/22

(52) U.S. Cl. CPC G06F 16/2219

(57) ABSTRACT

Techniques can include: storing an updated version of a MD page which invalidates an older version of the MD page stored in a PLB; updating a translation table (TT) entry to map to a new physical location of the updated version; recording a first deferred decrement operation associated with the PLB corresponding to the invalidated older version of the MD page; performing garbage collection (GC) processing using the TT to combine valid MD pages from source PLBs, including the PLB, to a target PLB; and performing deferred decrement processing for the PLB to process deferred decrement operations, including the first deferred decrement operation, associated with the PLB, including: updating space accounting information for the PLB based on a policy that indicates, for each deferred decrement operation, whether to apply the deferred decrement operation to the reference count of the PLB or the delayed count of the PLB.

### BACKGROUND

Systems include different resources used by one or more host processors. The resources and the host processors in the system are interconnected by one or more communication connections, such as network connections. These resources include data storage devices such as those included in data storage systems. The data storage systems are typically coupled to one or more host processors and provide storage services to each host processor. Multiple data storage systems from one or more different vendors can be connected to provide common data storage for the one or more host processors.

A host performs a variety of data processing tasks and operations using the data storage system. For example, a host issues I/O operations, such as data read and write operations, that are subsequently received at a data storage system. The host systems store and retrieve data by issuing the I/O operations to the data storage system containing a plurality of host interface units, disk drives (or more generally storage devices), and disk interface units. The host systems access the storage devices through a plurality of channels provided therewith. The host systems provide data and access control information through the channels to a storage device of the data storage system. Data stored on the storage device is provided from the data storage system to the host systems also through the channels. The host systems do not address the storage devices of the data storage system directly, but rather, access what appears to the host systems as a plurality of files, objects, logical units, logical devices or logical volumes. Thus, the I/O operations issued by the host are directed to a particular storage entity, such as a file or logical device. The logical devices generally include physical storage provisioned from portions of one or more physical drives. Allowing multiple host systems to access the single data storage system allows the host systems to share data stored therein.

### SUMMARY OF THE PRESENT DISCLOSURE

Various embodiments of the techniques herein can include a computer-implemented method, a system and a non-transitory computer readable medium. The system can include one or more processors, and a memory comprising code that, when executed, performs the method. The non-transitory computer readable medium can include code stored thereon that, when executed, performs the method. The method can comprise: storing N metadata (MD) pages in a first physical large block (PLB) of non-volatile storage, wherein the N MD pages include a first version of a first MD page, wherein a translation table (TT) includes TT entries used to map logical addresses of MD pages to corresponding physical locations of current valid versions of the MD pages, wherein N TT entries of the TT corresponding respectively to the N MD pages reference N corresponding physical locations of the first PLB where the N MD pages are stored, wherein a first TT entry E1 of the TT maps the logical address LA1 of the first MD page to a first physical location PA1 where the first version of the first MD page is stored in the first PLB; incrementing a reference count of the first PLB by N, wherein the reference count denotes a number of MD pages currently stored in the first PLB; storing a second version of the first MD page at a second physical address PA2 in a second PLB of non-volatile storage, wherein the second version of the first MD page denotes a more recent version of the first MD page than the first version of the first MD page, wherein said storing the second version of the first MD page results in the first version of the first MD page of the first PLB being invalidated; in response to said storing the second version of the first MD page, performing processing including: updating the first TT entry E1 to map LA1 to PA2 in the second PLB where the second version of the first MD page is stored; and recording a first deferred decrement operation associated with the first PLB, wherein the first deferred decrement operation corresponds to the first version of the first MD page being invalidated; performing garbage collection (GC) processing to combine content from multiple source PLBs to a target PLB, including: selecting the first PLB as one of the multiple source PLBs based, at least in part, on the reference count of the first PLB; scanning the first PLB to determine which MD pages stored on the first PLB are valid, wherein said scanning includes determining, using the TT, that the first version of the first MD page stored at PA1 of the first PLB is invalid; copying first valid MD pages from the first PLB to the target PLB; for each of the first valid MD pages copied from the first PLB to the target PLB, decrementing the reference count of the first PLB by one; setting a delayed count of the first PLB to the reference count of the first PLB; and setting the reference count of the first PLB to zero to denote that the first PLB has 100% free storage capacity; and performing deferred decrement processing for the first PLB to process deferred decrement operations, including the first deferred decrement operation, associated with the first PLB, including: updating space accounting information for the first PLB based, at least in part, on a policy, wherein the space accounting information for the first PLB includes the reference count of the first PLB and the delayed count of the first PLB, wherein the policy indicates, for each deferred decrement operation whether to apply said each deferred decrement operation to the reference count of the first PLB or the delayed count of the first PLB.

In at least one embodiment, the policy can specify that, if the delayed count is greater than 0, to apply said each deferred decrement operation to the delayed count of the first PLB, and to otherwise apply said each deferred decrement operation to the reference count of the first PLB. Applying said each deferred decrement operation to the delayed count can include decrementing the delayed count by 1. Applying said each deferred decrement operation to the reference count can include decrementing the reference count by 1.In at least one embodiment, recording the first deferred decrement operation associated with the first PLB can include creating a first predecessor entry of the TT, wherein the first predecessor entry denotes the first version of the first MD page being invalidated, wherein the first predecessor entry is associated with the first TT entry E1 of the TT corresponding to the first MD page, wherein the first predecessor entry denotes the first deferred decrement operation. The deferred decrement processing for the first PLB can include performing a deferred decrement operation for each of one or more predecessor entries associated with the first PLB, wherein said each predecessor entry denotes an invalid MD page stored on the first PLB. The TT can include an in-memory TT and a persisted TT stored on non-volatile storage in a log structured storage system (LSS). TT updates to the TT can be recorded in a TT log and applied to the in-memory TT. The TT updates can include a first TT update to update the first TT entry E1 to map LA1 to PA2 in the second PLB where the second version of the first MD page is stored. The persisted TT can be a first version of the TT. First processing can be performed to flush the TT log and destage an updated version of the persisted TT. The first processing can include: performing said deferred decrement processing for the first PLB; flushing the TT log including the TT updates; and applying the TT updates to the first version of the persisted TT to generate an updated TT which is destaged as a second version of the persisted TT.

In at least one embodiment, determining, using the TT, that the first version of the first MD page stored at PA1 of the first PLB is invalid, can include: determining whether the first TT entry E1 maps LA1 to PA1; and responsive to determining that the first TT entry E1 does not map LA1 to PA1, determining that the first version of the first MD page stored at PA1 is invalid. The first PLB can include a first TT back pointer for the first version of the first MD page, wherein the first TT back pointer references the first TT entry E1. A first version of a second MD page can be stored at a third physical location PA3 of the first PLB, wherein a second TT entry E2 can map a second logical address LA2 of the second MD page to a current physical location of a valid version of the second MD page, wherein the second TT entry E2 can map LA2 to PA3, and wherein a second TT back pointer of the first PLB can reference the second TT entry E2.

In at least one embodiment, scanning the first PLB to determine which MD pages stored on the first PLB are valid can include determining, using the TT, that the first version of the second MD page stored at PA3 of the first PLB is valid. Determining, using the TT, that the first version of the second MD page stored at PA3 of the first PLB is valid, can include: locating the second TT entry E2 using the second TT back pointer; determining whether the second TT entry E2 maps LA2 to PA3; and responsive to determining that the second TT entry E2 maps LA1 to PA3, determining that the first version of the second MD page stored at PA3 is valid.

### BRIEF DESCRIPTION OF THE DRAWINGS

Features and advantages of the present disclosure will become more apparent from the following detailed description of exemplary embodiments thereof taken in conjunction with the accompanying drawings in which:

FIG. 1 is an example of components that may be included in a system in accordance with the techniques of the present disclosure.

FIG. 2A is an example illustrating the I/O path or data path in connection with processing data in at least one embodiment in accordance with the techniques of the present disclosure.

FIGS. 2B, 2C and 2D are examples illustrating use of a log or journal recording client operations in at least one embodiment in accordance with the techniques of the present disclosure.

FIGS. 3, 4 and 5 are examples of mapping information in the form of a metadata structure that can be used in connection with mapping logical addresses to physical addresses or storage locations in at least one embodiment in accordance with the techniques of the present disclosure.

FIGS. 6, 7, 9, 10, 12, 13, 14, 15, 16A, 16B, 16C and 17 are examples illustrating structures and data flows in at least one embodiment in accordance with the techniques of the present disclosure.

FIG. 8 is an example of illustrating logical to physical address translation of metadata pages included in a chain of mapping information.

FIG. 11 is an example illustrating various logical and physical address spaces in at least one embodiment in accordance with the techniques of the present disclosure.

FIGS. 18A and 18B are flowcharts of processing steps that can be performed in at least one embodiment in accordance with the techniques of the present disclosure.

### DETAILED DESCRIPTION OF EMBODIMENT(S)

A data storage system can use a log for recording user or client updates, and can also use a metadata log for recording updates to metadata pages. The metadata (MD) pages can be used in connection with chains of mapping information that map user data (UD) logical addresses to storage locations including content stored at the UD logical addresses. An entry from the log of user or client updates (sometimes referred to as the UD log) can be an update, such as a client write I/O, to a logical address (e.g., LUN or logical device and LBA or logical block address) which writes content to a UD page. Flushing the entry from the UD log can include writing the updated UD page to a backend storage location on non-volatile storage (e.g., BE (back end) PD (physical storage device) location). Additionally, flushing the entry from the UD log can include updating the corresponding MD pages which map the UD logical address to its corresponding BE PD location including the content stored at the UD logical address. In at least one existing system, the mapping information including MD pages can thus be updated. For example, such updating of the mapping information can include updating a chain of MD pages used in connection with mapping the UD logical address to the BE PD location including the content stored at the logical address.

Updating the corresponding mapping information and MD pages can include loading all the MD pages into the cache if any such MD pages are not already in cache. The MD pages of the mapping information can be characterized as a chain forming an access sequence including a top MD page, a mid MD page, a leaf MD page, and a VLB (virtual or virtualized layer block) page, where each page in the foregoing sequence is accessed serially and also in the strict sequential order of the sequence.

The data storage system can maintain the persistently stored user data or client data as a log structured system (LSS) which can be characterized by typically not performing in place updates which overwrite existing content. In the LSS for user data, flushing one or more UD log entries of updates to a UD page stored at an existing physical storage location (e.g., on BE PDs) can include determining an updated version of the UD page and storing the updated version of the UD page at a new physical storage location that is different from the existing physical storage location. Thus, the physical storage location of the UD page (as stored persistently on the BE PDs) can move or change each time an updated version of the UD page is written to the BE PDs, where such updated version of the UD page can be the result of flushing one or more entries from the UD log which update the same UD page, and then persistently storing the updated version of the UD page on the BE PDs.

The MD pages used in connection with mapping information as noted above can be stored persistently using in-place updates or overwrites such that processing overwrites the existing version of a MD page as stored at a physical storage location on the BE PDs with an updated version of the MD page. The physical storage location (e.g., on BE PDs) of each MD page can thus remain static or fixed so that in-place updates overwrite the same existing persistent physical storage location of the MD page. With mapping information including a chain of MD pages that reference each other using such physical storage locations, such in-place updates or overwrites of MD pages can be desirable where each MD page remains in the same physical storage location on BE storage.

As an alternative, the persistent or non-volatile physical storage, such as on the BE PDs, used for storing the MD pages can be maintained as an LSS in a manner similar to the LSS storing user data or content. With an LSS for MD pages, an updated MD page can be determined as a result of applying one or more entries of the metadata log which update the MD page. A current version of the MD page (before applying the updates) can be stored at an existing physical storage location on non-volatile persistent storage (e.g., on BE PDs). The updated version of the MD page can be determined and then rewritten or stored at a new physical storage location that is different from the existing physical storage location. Thus, with an LSS for metadata (sometimes also referred to as an LSM or log-structured metadata storage), the physical storage location or address of the MD page can move or change each time an updated version of the MD page is written to the BE PDs, where such updated version of the MD page can be the result of flushing one or more entries from the metadata log which update the same MD page, and then persistently storing the updated version of the MD page at the new physical storage location on the BE PDs. Persistent physical storage for a MD page can be allocated at a physical address from the BE PDs.

In at least one embodiment in accordance with the techniques of the present disclosure providing for storing updated MD pages at new physical storage locations in an LSS rather than performing overwriting or in-place updates, logical addresses of MD pages can be used to reference the MD pages as opposed to referencing MD pages, and entries thereof, using physical storage locations or addresses. In at least one embodiment, the logical address of a MD page can be an indirect pointer or indirect address of the corresponding physical storage location or address of the persistently stored MD page. In at least one embodiment, a logical address of a MD page can be mapped to the physical address or storage location on the BE PDs where the MD page is stored. Thus, as the MD page is updated and its corresponding physical storage location changes over time, the logical address of the MID page can remain the same and the physical storage location or address on the BE PDs storing the persisted MD page can be allowed to change. When the logical address of the MID page is used to reference the MD page from the BE PDs, the logical address of the MD page can be translated or mapped to its current physical storage location on the BE PDs. Thus, designing an LSS for storing the MD pages can generally include some form of dynamic translation of logical to physical addresses or locations for the MD pages.

In at least one embodiment in accordance with the techniques of the present disclosure, a translation table (TT) can be used to map or translate a logical address of a MD page to its current physical storage location or address such as on BE PDs providing non-volatile storage. In at least one embodiment, as the physical storage location of a MD page changes from a first physical storage location or address PA1 to a second physical storage or address PA2, the TT used to map the MD page's logical address to the new physical storage location can also be updated. In at least one embodiment, the TT can be updated to reference the new physical storage location PA2 of the MD page rather than the prior physical storage location PA1. In at least one embodiment, the logical addresses of the MD pages can remain the same even though the physical addresses or storage locations of persistently stored versions of the MD pages can change as the MD pages are updated and rewritten to new physical addresses or storage locations in accordance with the LSS. In at least one embodiment, the TT can include TT entries that are indexed or accessed using MD page logical addresses. Each MD page's logical address can map to a corresponding TT entry which further maps to or references the current physical address or location of the current version of the MD page as stored in the LSM.

In at least one embodiment, the TT itself can be stored on non-volatile storage such as the BE PDs, where the persisted TT on the BE PDs can also be managed as an LSS. In at least one embodiment, one or more TTs can be characterized as another form of MD used in connection with the LSS for MD pages including top, mid, leaf MID pages and also including VLB (virtual or virtualized layer block) pages of mapping information. In at least one embodiment, updates to a TT can be stored in a TT log in a manner similar to the metadata log used for recording updates to metadata pages. Updates to the TT can be flushed from the TT log, and then applied to a current persistent copy of the TT stored on non-volatile storage to generate an updated version of the TT. The updated version of the TT can then be stored persistently on non-volatile storage in a new storage location that is different from the existing storage location of the current persistent copy of the TT (as just prior to updating). Thus in at least one embodiment, flushing the TT updates of the TT log can include rewriting or storing the entire TT persistently at the new storage location. In at least one embodiment, multiple instances of the most recent consecutive versions of the TT can be maintained on non-volatile storage. In this manner in such an embodiment, each time the TT log is flushed, the oldest version of the multiple persisted TT copies or instances can be replaced with a most recent version of the TT. In this manner, the techniques of the disclosure in at least one embodiment provide an LSS approach for use with various types of metadata further including the TT itself. In an LSS, as updated versions of pages are written out to PLBs or physical large blocks of non-volatile storage on the BE PDs, older prior versions of the pages also stored on PLBs of the BE PDs now denote stale invalid data or content having corresponding storage that can be reclaimed for reuse. In the LSS, garbage collection (GC) can be performed, for example, to combine valid content of two partially filled source PLBs having holes of such stale invalid data into a single target or destination PLB. In the foregoing each of the two source PLBs may contain no more than 50% of valid content (and thus have at least 50% free storage), the target PLB can have 100% free storage, and the foregoing GC operation can generate 1 net free PLB. GC processing can use space accounting information regarding the PLBs to determine and select source PLBs with at least 50% free storage capacity and select the target PLB with 100% free storage capacity. The space accounting information can denote or be used to determine the amount of free storage capacity of the PLBs. More generally as discussed elsewhere herein GC processing can be performed to aggregate and thus move or relocate content from two or more source PLBs to a single free target PLB, where the two or more source PLBs collectively have a total combined utilization (denoting consumed storage for storing content) of not more than 100% whereby the valid content of all such source PLBs can be stored in the single target PLB. For example, content from two source PLBs can be combined where a first source PLB has 40% utilization and a second source PLB has 60% utilization.

The LSS used for persistently storing metadata can be referred to as an LSM as noted above. Thus the LSM can denote PLBs of the BE PDs used to persistently store metadata pages in an LSS. To improve performance, techniques used to manage the LSM and its storage can delay updating the space accounting information of the PLBs to indicate that the storage locations of the stale invalid content are free. When a new version of a MD page is written to a first PLB thereby invalidating an existing version of the MD page stored on a second PLB, the PLB storage accounting information of the second PLB may not be immediately updated to reflect that the storage associated with the existing version of the MID page is now free and can be reused. Rather in at least one embodiment, such PLB space accounting can be deferred, for example, to be performed in connection with flushing the TT log and destaging a new version of the TT to non-volatile storage of the LSM.

To further illustrate, a PLB having first content that becomes stale or invalid at a first point in time can have its space accounting information updated at a later second point in time such that the PLB's space accounting information between the first and second points in time can understate the amount of free storage capacity of the PLB. For example, the PLB's space accounting information can indicate it has 50% of consumed storage but the PLB may actually have 100% free storage if the 50% of consumed storage denoted by the space account information actually contains stale invalid content such as stale invalid versions of MD pages that have been rewritten or updated. In some embodiments, updates to space accounting information of multiple PLBs can be delayed, aggregated and processed as a batch or group. Thus depending on when GC processing is performed, GC processing can use PLB space accounting information which understates the actual free storage capacity of a PLB. Use of such inaccurate PLB space accounting information can lead to inefficiencies in connection with selecting PLBs to use in connection with GC processing, and also in connection with performing any data copying in connection with the GC processing. For example, it may be desirable to only copy valid content. However, based, at least in part, on the inaccurate PLB space accounting information and the inability to correctly determine whether content of a PLB is valid or invalid at the time of GC processing, such copying may also include copying invalid stale content having storage that has not yet been reclaimed.

Accordingly, the techniques of the present disclosure can be utilized to provide for more accurate tracking and determination of free storage capacity of PLBs during GC processing. In at least one embodiment, the techniques of the present disclosure can be used in connection with the LSM storing metadata pages. In at least one embodiment with PLBs of the LSM, the techniques of the present disclosure can further provide for determining at the time of GC processing whether content of the LSM PLBs is invalid or stale, for example, to avoid copying, moving or relocating the invalid stale content of a source PLB to a target PLB as part of GC processing operations.

In at least one embodiment, a new version N of a MD page L1 can be persistently stored at a new physical location PA2, where the immediate prior version N−1 of the MD page L1 can be stored at PA1. PA1 and PA2 can be non-volatile storage locations of BE PDs used for persistently storing MD pages of the LSM. As a result of storing version N of the MD page L1 at PA2, an update Ul can be recorded in the TT log to update L1's TT entry TT1 to reference PA2 rather than PA1. In at least one embodiment, an in-memory TT can also be updated to reflect the update U1 to the TT entry TT1, where the entry TT1 indicates that MD page L1 is now stored at PA2. In at least one embodiment, the in-memory TT can generally track the changes or updates made by TT log entries to corresponding TT entries. The in-memory TT can track a history of updates or changes to LSM physical storage locations of a MD page as new versions of the MD page are stored in the LSM. Thus the in-memory TT can track the current physical address or location of the current valid version of a MD page as well as references or physical addresses of stale invalid versions of MD pages since the last TT log flush/TT destage. In the foregoing such stale versions of MD pages have not yet had their corresponding decref processed and not yet accounted for in the reference count of PLB space accounting information. In at least one embodiment, as a new instance of a MD page is written to a new physical address or location, the prior LSM physical address or location of the prior version of the MD page can be tracked by the in-memory TT as a predecessor (e.g., identified by information of a predecessor structure or entry) associated with the corresponding MD page and corresponding TT entry of the corresponding MD page. The predecessor entry can denote a stale or invalid delta entry or TT log entry for a logical address LA1 of a MD page that has been overwritten prior to destaging the TT log including the TT log entry. Thus the predecessor entry can denote a physical address or location of an invalid version of the MD page that has been rewritten prior to destaging the TT log instance associated with the predecessor entry. More generally in at least one embodiment, the TT can be used to determine what stored MD of a PLB of the LSM is valid or otherwise invalid during GC processing in order to avoid copying, moving or relocating such invalid content as part of GC processing operations.

In at least one embodiment, PLB space accounting information can be evaluated and accordingly updated during TT destage when flushing the TT log. Thus in at least one embodiment, updating the PLB space accounting information, such as PLB utilization, to accurately account for invalid content can be deferred or delayed until flushing the TT log and destaging the next instance of the TT to persistent storage of the LSM. In at least one embodiment, PLB space accounting information can include a reference count that is maintained for each PLB of the LSM storing MD pages, where the reference count for the PLB denotes a number of valid MD pages stored in the PLB. PLB space accounting can include updating the space accounting information to account for any invalidated or stale content stored on the PLB where such associated storage of the PLB can be considered as free and available for reuse. PLB space accounting can include updating the reference count, and other information, of the PLB to account for any invalidated stale content stored on the PLB. Generally deferring the updating of PLB reference counts (performed as part of PLB space accounting) can also sometimes be referred to as deferred decref processing based, at least in part, on the deferred decrementing of PLB reference counts to reflect any stale invalid MD pages stored in corresponding PLBs. Generally, decref processing as applied to a PLB reference count for a PLB can include decrementing the PLB reference count to reflect any invalid MD pages stored in the PLB. Thus when a MD page instance M1 stored at a first location PA1 on the PLB becomes invalid or stale because a newer version M2 of the MD page is written to another PLB of the LSM, the PLB's reference count can be decremented by 1 to indicate that i) an additional page of storage, such as at the first location PA1 storing stale or invalid content M1, is free and can now be reused. In at least one embodiment, a new version of the TT can be destaged and written out to a new storage location of the LSM each time the TT log is flushed to thereby process all decrefs for corresponding invalid MD pages of PLBs. In at least one embodiment, a decref can be performed for each predecessor entry corresponding to a stale or invalid version of a MD page. Thus in at least one embodiment, flushing the TT log and destaging a new version of the TT to non-volatile storage can include updating PLB space accounting information of LSM PLBs storing MD pages. Updating the PLB space accounting information can include performing the deferred decref processing to accordingly update or decrement counts, such as reference counts, of the LSM PLBs where the reference counts are decremented to account for any stale or invalid MD pages such as those associated with predecessor entries of the TT log being flushed.

In at least one embodiment using LSM, a MD page P1 can have a version N stored in a first PLB1. When a new version N+1 of a MD page P1 is written out to a second PLB2 of the LSM, version N of P1 as stored in PLB1 can be considered stale or invalid, where the space accounting information for PLB1 can be updated to reflect the fact that the page of storage of PLB1 containing version N of P1 is free. In at least one embodiment, the foregoing can be performed by decrementing, via a decref operation, the reference count of PLB1 's space accounting information. In at least one embodiment, the foregoing decref operation as well as other decref operations to update the reference count of PLB1 's space accounting information to account for invalid stale content can be collected or aggregated (e.g., deferred) and not yet committed or performed. In at least one embodiment using an LSM, such decrefs can then be batched and committed during the next TT log flush and next TT destage as part of deferred decref processing.

In at least one embodiment, during GC processing, PLBs can be selected based on their respective reference counts of space account information, which can be inaccurate in that it can overstate the amount of consumed or utilized storage containing valid content due to deferred space accounting. When MD pages of a PLB become invalid, processing of corresponding decrefs to a reference count for the PLB can be delayed and batched where such decrefs can then be processed as part of space accounting during TT log flushing and destaging a new version of the TT persistently to the LSM. During GC processing in at least one embodiment, the TT can be used to determine which MD pages stored on source PLBs are valid MD pages (e.g., valid content) so as to move, copy or relocate only valid content from source PLBs to a target PLB.

In at least one embodiment, a delayed storage count (sometimes referred to as delayed count) can be included in space accounting information for each PLB. In at least one embodiment, the delayed storage count for a PLB can be updated in connection with GC processing to track remaining deferred decrefs (e.g., corresponding to stale or invalid content) for the PLB that need to be processed during the next TT log flushing and destaging the TT such as, for example, when the PLB is used as a source PLB whose content is moved, relocated or copied to a target PLB as part of GC processing. For example, consider GC processing that includes determining which pages of the partially filled source PLB contain valid content and accordingly updating the reference count, such as by decrementing the source PLB's reference count by the actual number of valid MD pages whose content is moved to the target PLB. GC processing can then include moving only the determined valid MD pages from the partially filled source PLB to a target PLB. After performing the foregoing move, the reference count of the source PLB can be decremented by the number of valid MD pages moved by GC processing to the target PLB. Subsequently, the leftover or remaining value of the reference count can be transferred to the delayed storage count field of the source PLB and the source PLB can be considered 100% free. Put another way, after performing the foregoing move of GC processing, i) the source PLB's delayed count can be set to the current value of the source PLB's reference count; and ii) the source PLB's reference count can be set to zero to thereby indicate that the source PLB has 100% free storage available for use. Thus 100% of the source PLB can be used for storing new content prior to the next TT destage and next TT log flush. In at least one embodiment, the delayed count for the source PLB can denote the number of deferred decrefs or decrements for stale or invalid pages of the source PLB that need to be processed (e.g., committed) during the next PLB space accounting of the source PLB during the next TT log flush and TT destage.

At a later point in time (after the foregoing GC processing move) when the TT log is next flushed for the next TT destage, the deferred decrefs (e.g., corresponding to invalid pages) of the source PLB can be processed, including committed, to the source PLB's space accounting information. In at least one embodiment, the deferred decrefs for a PLB, such as the above source PLB, can be applied against the delayed count and/or the reference count of the PLB's space accounting information. In at least one embodiment, there can be M deferred decrefs corresponding to M invalid MD pages of the PLB which have not yet been accounted for in the PLB's space accounting information, where the M deferred decrefs can be processed and committed to the PLB's space accounting information as part of decref processing when flushing the TT log and destaging an updated TT. In at least one embodiment, the foregoing decref processing of the M deferred decrefs can include first applying the M deferred decrefs against the delayed count, where the delayed count and M are each decremented by 1 until the delayed count reaches 0. If M is still greater than 0, M can then be applied against the reference count, where the reference count and M are each decremented by 1 until M reaches 0. Applying a decref against the delayed count can include decrementing by 1 the delayed count of the PLB's space accounting information. Applying a decref against the reference count can include decrementing by 1 the reference count of the PLB's space accounting information. In at least one embodiment, deferred decref processing can be included in first processing that flushes the TT log and destages a new TT. The deferred decref processing for a PLB can include committing in a single transaction i) deferred decrefs or decrements to the delayed count of the PLB; and ii) deferred decrefs or decrements to the reference count of the PLB. In at least one embodiment of LSM, the foregoing decrefs or decrements to a PLB's counts (e.g., reference count and delayed count) can be committed as corresponding records to an appropriate log including updates to the PLB's space accounting information. At a later point in time, the log can be flushed whereby the updates are applied to a persisted copy of the PLB's space accounting information. In at least one embodiment, the PLB's space accounting information can be included in a corresponding PLB descriptor.

Thus in at least one embodiment, the delayed count for a PLB (that is cleaned by GC processing whereby GC processing moves the PLB's content to a target PLB) can denote remaining deferred decrefs or decref operations for the PLB that have not been processed for corresponding invalid MD pages stored in the PLB. In at least one embodiment, the delayed decref processing for a PLB performed during the next TT log flush and next TT destage can include processing one or more deferred decref operations each corresponding to a single invalid MD page of content stored on the PLB. For each deferred decref operation for the PLB, a determination can be made as to whether to decrement the PLB's delayed count or reference count. Generally, a decref operation of the deferred decref processing for the PLB can be applied to decrement the PLB's delayed count if the delayed count is greater than 0 prior to the decrement. Otherwise, the decref operation for the PLB can be applied to decrement the PLB's reference count. In this manner, the delayed count of the PLB can be used as a temporary or placeholder count buffer denoting the number of delayed decrefs to be processed during delayed decref processing with the next TT log flush and next TT destage. Put another way, the delayed count can be consumed and thus reduced to zero during the delayed decref processing of the next TT log flush and next TT destage when the PLB's space accounting is updated to reflect the actual current state of the PLB with respect to valid content stored on the PLB.

In at least one embodiment, space accounting information for a MD PLB of the LSM can include both a reference count and a delayed count for the particular MD PLB. In at least one embodiment, the reference count but not the delayed count can be used in connection with reporting and determining the PLB's storage utilization or consumption. In at least one embodiment, each MD PLB can be capable of storing a maximum number of MID pages where reference count can be an integer from 0 to the maximum number. Thus in at least one embodiment when performing GC processing for LSM storage, the reference count but not the delayed count for MD PLBs of the LSM can be used in an initial determination of a level or percentage of the MD PLB storage that as utilized or consumed for storing MD pages. Subsequent GC processing can then further use, for example, the TT, to determine the actual pages of a selected MD PLB which are considered valid and which are alternatively considered invalid or stale. GC processing can clean a MD PLB which can be freed and reused. GC processing can decrement the reference count of the MD PLB by 1 for each valid MD page copied to a target PLB. After all valid MD pages of the MD PLB have been copied to the target PLB and after the MD PLB's reference count is also accordingly decremented for each copied MD page, any positive integer quantity remaining in the MD PLB's reference count can denote the number of deferred decrefs for invalid MD pages for the MD PLB which have not yet been processed. In at least one embodiment, the foregoing positive integer valued reference count for the MD PLB can be transferred to the delayed count for the MD PLB. In this manner, the reference count for the MD PLB can be 0 denoting the PLB storage utilization and thus 100% free capacity; and the delayed count for the MD PLB can be used to track the number of deferred decrefs to be processed later such as at the next TT log flush and next TT destage. At the next TT log flush and TT log destage, deferred decref processing can be performed for the MD PLB where the decrefs (corresponding to invalid stale MD pages) that have been deferred and collected since the prior TT log flush/TT destage can be processed and applied to the MD PLB's delayed count and reference count based on a specified policy. The policy, such as noted above, can indicate to decrement the delayed count for each of the MID PLB's deferred decrefs until the delayed count=0. Once the delayed count=0, each decref can be applied against the reference count to thereby decrement the reference count by 1 to account for an invalid MD page. In this manner, deferred decref processing can be performed where the reference count is updated to accurately reflect the number of valid MD pages stored on the MD PLB, and where the delayed count is used as a temporary buffer to hold a prior reference count value denoting a number of transferred unprocessed deferred decrefs.

The foregoing and other aspects of the techniques of the present disclosure are described in more detail in the following paragraphs.

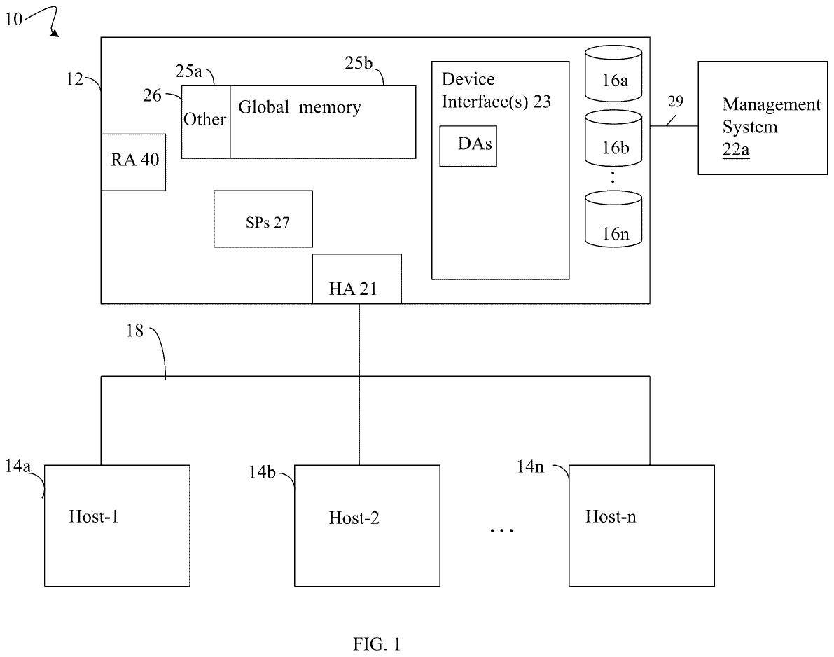

Referring to the FIG. 1, shown is an example of an embodiment of a SAN 10 that is used in connection with performing the techniques described herein. The SAN 10 includes a data storage system 12 connected to the host systems (also sometimes referred to as hosts) 14a-14n through the communication medium 18. In this embodiment of the SAN 10, the n hosts 14a-14n access the data storage system 12, for example, in performing input/output (I/O) operations or data requests. The communication medium 18 can be any one or more of a variety of networks or other type of communication connections as known to those skilled in the art. The communication medium 18 can be a network connection, bus, and/or other type of data link, such as a hardwire or other connections known in the art. For example, the communication medium 18 can be the Internet, an intranet, a network, or other wireless or other hardwired connection(s) by which the host systems 14a-14n access and communicate with the data storage system 12, and also communicate with other components included in the SAN 10.

Each of the host systems 14a-14n and the data storage system 12 included in the SAN 10 are connected to the communication medium 18 by any one of a variety of connections as provided and supported in accordance with the type of communication medium 18. The processors included in the host systems 14a-14n and data storage system 12 can be any one of a variety of proprietary or commercially available single or multi-processor system, such as an Intel-based processor, or other type of commercially available processor able to support traffic in accordance with each particular embodiment and application.

It should be noted that the particular examples of the hardware and software included in the data storage system 12 are described herein in more detail, and can vary with each particular embodiment. Each of the hosts 14a-14n and the data storage system 12 can all be located at the same physical site, or, alternatively, be located in different physical locations. The communication medium 18 used for communication between the host systems 14a-14n and the data storage system 12 of the SAN 10 can use a variety of different communication protocols such as block-based protocols (e.g., SCSI, FC, isCSI), file system-based protocols (e.g., NFS or network file server), and the like. Some or all of the connections by which the hosts 14a-14n and the data storage system 12 are connected to the communication medium 18 can pass through other communication devices, such as switching equipment, a phone line, a repeater, a multiplexer or even a satellite.

Each of the host systems 14a-14n can perform data operations. In the embodiment of the FIG. 1, any one of the host computers 14a-14n issues a data request to the data storage system 12 to perform a data operation. For example, an application executing on one of the host computers 14a-14n performs a read or write operation resulting in one or more data requests to the data storage system 12.

It should be noted that although the element 12 is illustrated as a single data storage system, such as a single data storage array, the element 12 also represents, for example, multiple data storage arrays alone, or in combination with, other data storage devices, systems, appliances, and/or components having suitable connectivity to the SAN 10 in an embodiment using the techniques herein. It should also be noted that an embodiment can include data storage arrays or other components from one or more vendors. In subsequent examples illustrating the techniques herein, reference is made to a single data storage array by a vendor. However, as will be appreciated by those skilled in the art, the techniques herein are applicable for use with other data storage arrays by other vendors and with other components than as described herein for purposes of example.

In at least one embodiment, the data storage system 12 is a data storage appliance or a data storage array including a plurality of data storage devices (PDs) 16a-16n. The data storage devices 16a-16n include one or more types of data storage devices such as, for example, one or more rotating disk drives and/or one or more solid state drives (SSDs). An SSD is a data storage device that uses solid-state memory to store persistent data. SSDs refer to solid state electronics devices as distinguished from electromechanical devices, such as hard drives, having moving parts. Flash devices or flash memory-based SSDs are one type of SSD that contains no moving mechanical parts. In at least one embodiment, the flash devices can be constructed using nonvolatile semiconductor NAND flash memory. The flash devices include, for example, one or more SLC (single level cell) devices and/or MLC (multi level cell) devices.

In at least one embodiment, the data storage system or array includes different types of controllers, adapters or directors, such as an HA 21 (host adapter), RA 40 (remote adapter), and/or device interface(s) 23. Each of the adapters (sometimes also known as controllers, directors or interface components) can be implemented using hardware including a processor with a local memory with code stored thereon for execution in connection with performing different operations. The HAs are used to manage communications and data operations between one or more host systems and the global memory (GM). In an embodiment, the HA is a Fibre Channel Adapter (FA) or other adapter which facilitates host communication. The HA 21 can be characterized as a front end component of the data storage system which receives a request from one of the hosts 14a-n. In at least one embodiment, the data storage array or system includes one or more RAs used, for example, to facilitate communications between data storage arrays. The data storage array also includes one or more device interfaces 23 for facilitating data transfers to/from the data storage devices 16a-16n. The data storage device interfaces 23 include device interface modules, for example, one or more disk adapters (DAs) (e.g., disk controllers) for interfacing with the flash drives or other physical storage devices (e.g., PDS 16a-n). The DAs can also be characterized as back end components of the data storage system which interface with the physical data storage devices.

One or more internal logical communication paths exist between the device interfaces 23, the RAs 40, the HAs 21, and the memory 26. An embodiment, for example, uses one or more internal busses and/or communication modules. In at least one embodiment, the global memory portion 25b is used to facilitate data transfers and other communications between the device interfaces, the HAs and/or the RAs in a data storage array. In one embodiment, the device interfaces 23 performs data operations using a system cache included in the global memory 25b, for example, when communicating with other device interfaces and other components of the data storage array. The other portion 25a is that portion of the memory used in connection with other designations that can vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, can also be included in an embodiment.

The host systems 14a-14n provide data and access control information through channels to the storage systems 12, and the storage systems 12 also provide data to the host systems 14a-n also through the channels. The host systems 14a-n do not address the drives or devices 16a-16n of the storage systems directly, but rather access to data is provided to one or more host systems from what the host systems view as a plurality of logical devices, logical volumes (LVs) also referred to herein as logical units (e.g., LUNs). A logical unit (LUN) can be characterized as a disk array or data storage system reference to an amount of storage space that has been formatted and allocated for use to one or more hosts. A logical unit has a logical unit number that is an I/O address for the logical unit. As used herein, a LUN or LUNs refers to the different logical units of storage referenced by such logical unit numbers. The LUNs have storage provisioned from portions of one or more physical disk drives or more generally physical storage devices. For example, one or more LUNs can reside on a single physical disk drive, data of a single LUN can reside on multiple different physical devices, and the like. Data in a single data storage system, such as a single data storage array, can be accessible to multiple hosts allowing the hosts to share the data residing therein. The HAs are used in connection with communications between a data storage array and a host system. The RAs are used in facilitating communications between two data storage arrays. The DAs include one or more types of device interfaced used in connection with facilitating data transfers to/from the associated disk drive(s) and LUN(s) residing thereon. For example, such device interfaces can include a device interface used in connection with facilitating data transfers to/from the associated flash devices and LUN(s) residing thereon. It should be noted that an embodiment can use the same or a different device interface for one or more different types of devices than as described herein.

In an embodiment in accordance with the techniques herein, the data storage system as described can be characterized as having one or more logical mapping layers in which a logical device of the data storage system is exposed to the host whereby the logical device is mapped by such mapping layers of the data storage system to one or more physical devices. Additionally, the host can also have one or more additional mapping layers so that, for example, a host side logical device or volume is mapped to one or more data storage system logical devices as presented to the host.

It should be noted that although examples of the techniques herein are made with respect to a physical data storage system and its physical components (e.g., physical hardware for each HA, DA, HA port and the like), the techniques herein can be performed in a physical data storage system including one or more emulated or virtualized components (e.g., emulated or virtualized ports, emulated or virtualized DAs or HAs), and also a virtualized or emulated data storage system including virtualized or emulated components.

Also shown in the FIG. 1 is a management system 22a used to manage and monitor the data storage system 12. In one embodiment, the management system 22a is a computer system which includes data storage system management software or application that executes in a web browser. A data storage system manager can, for example, view information about a current data storage configuration such as LUNs, storage pools, and the like, on a user interface (UI) in a display device of the management system 22a. Alternatively, and more generally, the management software can execute on any suitable processor in any suitable system. For example, the data storage system management software can execute on a processor of the data storage system 12.

Information regarding the data storage system configuration is stored in any suitable data container, such as a database. The data storage system configuration information stored in the database generally describes the various physical and logical entities in the current data storage system configuration. The data storage system configuration information describes, for example, the LUNs configured in the system, properties and status information of the configured LUNs (e.g., LUN storage capacity, unused or available storage capacity of a LUN, consumed or used capacity of a LUN), configured RAID groups, properties and status information of the configured RAID groups (e.g., the RAID level of a RAID group, the particular PDs that are members of the configured RAID group), the PDs in the system, properties and status information about the PDs in the system, data storage system performance information such as regarding various storage objects and other entities in the system, and the like.

Consistent with other discussion herein, management commands issued over the control or management path include commands that query or read selected portions of the data storage system configuration, such as information regarding the properties or attributes of one or more LUNs. The management commands also include commands that write, update, or modify the data storage system configuration, such as, for example, to create or provision a new LUN (e.g., which result in modifying one or more database tables such as to add information for the new LUN), and the like.

It should be noted that each of the different controllers or adapters, such as each HA, DA, RA, and the like, can be implemented as a hardware component including, for example, one or more processors, one or more forms of memory, and the like. Code can be stored in one or more of the memories of the component for performing processing.

The device interface, such as a DA, performs I/O operations on a physical device or drive 16a-16n. In the following description, data residing on a LUN is accessed by the device interface following a data request in connection with I/O operations. For example, a host issues an I/O operation that is received by the HA 21. The I/O operation identifies a target location from which data is read from, or written to, depending on whether the I/O operation is, respectively, a read or a write operation request. In at least one embodiment using block storage services, the target location of the received I/O operation is expressed in terms of a LUN and logical address or offset location (e.g., LBA or logical block address) on the LUN. Processing is performed on the data storage system to further map the target location of the received I/O operation, expressed in terms of a LUN and logical address or offset location on the LUN, to its corresponding physical storage device (PD) and location on the PD. The DA which services the particular PD performs processing to either read data from, or write data to, the corresponding physical device location for the I/O operation.

It should be noted that an embodiment of a data storage system can include components having different names from that described herein but which perform functions similar to components as described herein. Additionally, components within a single data storage system, and also between data storage systems, can communicate using any suitable technique described herein for exemplary purposes. For example, the element 12 of the FIG. 1 in one embodiment is a data storage system, such as a data storage array, that includes multiple storage processors (SPs). Each of the SPs 27 is a CPU including one or more “cores” or processors and each have their own memory used for communication between the different front end and back end components rather than utilize a global memory accessible to all storage processors. In such embodiments, the memory 26 represents memory of each such storage processor.

Generally, the techniques herein can be used in connection with any suitable storage system, appliance, device, and the like, in which data is stored. For example, an embodiment can implement the techniques herein using a midrange data storage system as well as a higher end or enterprise data storage system.

The data path or I/O path can be characterized as the path or flow of I/O data through a system. For example, the data or I/O path can be the logical flow through hardware and software components or layers in connection with a user, such as an application executing on a host (e.g., more generally, a data storage client) issuing I/O commands (e.g., SCSI-based commands, and/or file-based commands) that read and/or write user data to a data storage system, and also receive a response (possibly including requested data) in connection such I/O commands.

The control path, also sometimes referred to as the management path, can be characterized as the path or flow of data management or control commands through a system. For example, the control or management path is the logical flow through hardware and software components or layers in connection with issuing data storage management command to and/or from a data storage system, and also receiving responses (possibly including requested data) to such control or management commands. For example, with reference to the FIG. 1, the control commands are issued from data storage management software executing on the management system 22a to the data storage system 12. Such commands, for example, establish or modify data services, provision storage, perform user account management, and the like. Consistent with other discussion herein, management commands result in processing that can include reading and/or modifying information in the database storing data storage system configuration information.

The data path and control path define two sets of different logical flow paths. In at least some of the data storage system configurations, at least part of the hardware and network connections used for each of the data path and control path differ. For example, although both control path and data path generally use a network for communications, some of the hardware and software used can differ. For example, with reference to the FIG. 1, a data storage system has a separate physical connection 29 from a management system 22a to the data storage system 12 being managed whereby control commands are issued over such a physical connection 29. However, user I/O commands are never issued over such a physical connection 29 provided solely for purposes of connecting the management system to the data storage system. In any case, the data path and control path each define two separate logical flow paths.

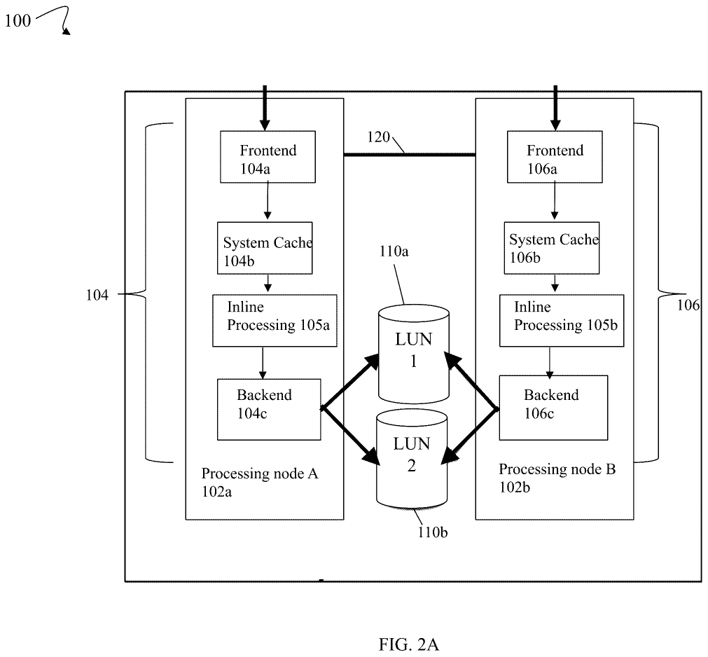

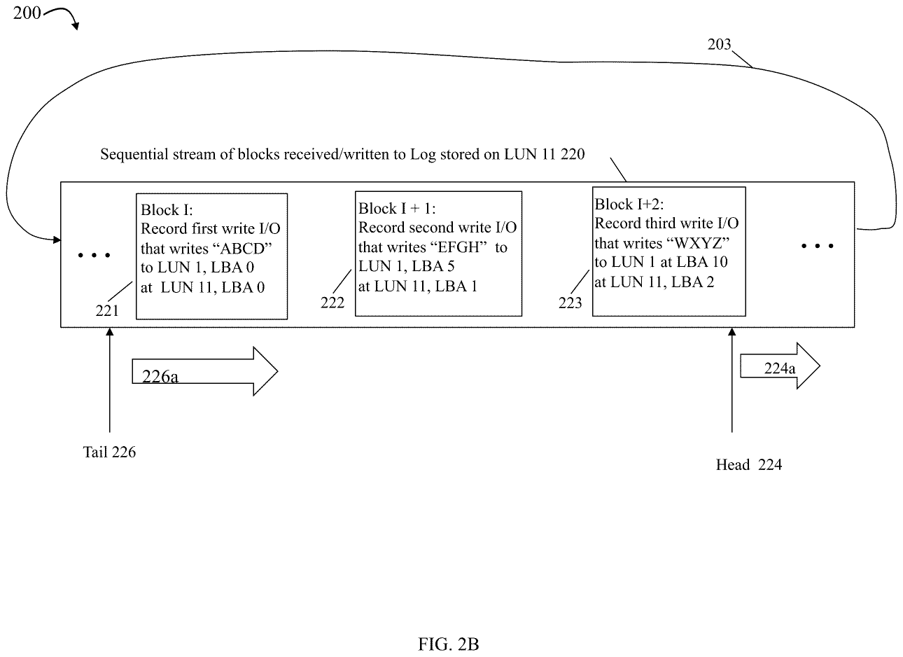

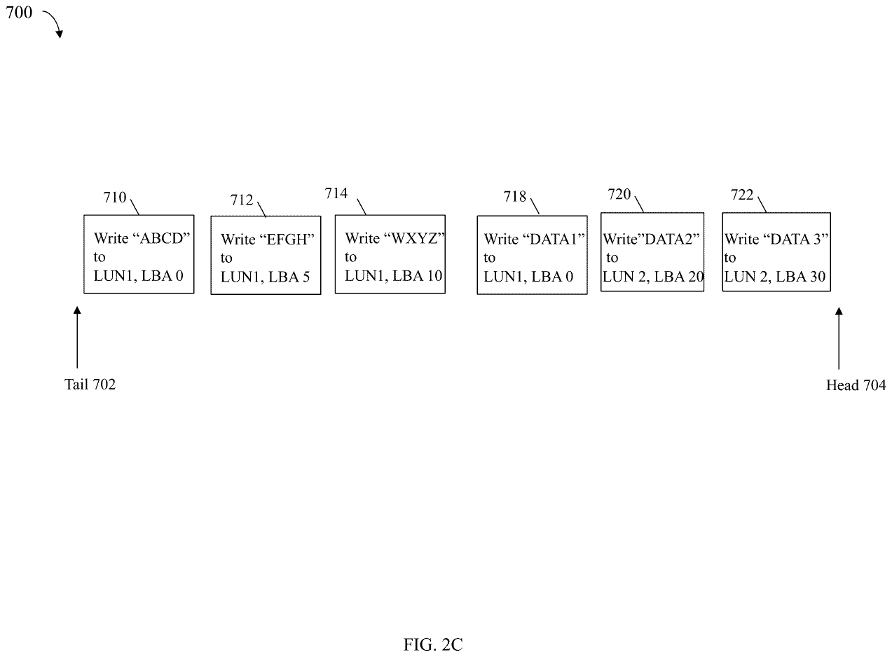

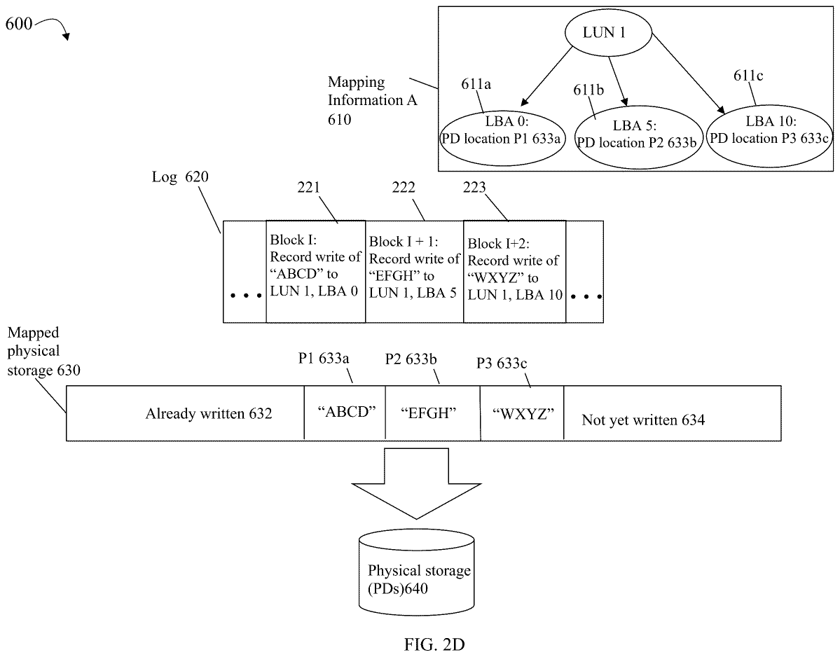

With reference to the FIG. 2A, shown is an example 100 illustrating components that can be included in the data path in at least one existing data storage system in accordance with the techniques of the present disclosure. The example 100 includes two processing nodes A 102a and B 102b and the associated software stacks 104, 106 of the data path, where I/O requests can be received by either processing node 102a or 102b. In the example 200, the data path 104 of processing node A 102a includes: the frontend (FE) component 104a (e.g., an FA or front end adapter) that translates the protocol-specific request into a storage system-specific request; a system cache layer 104b where data is temporarily stored; an inline processing layer 105a; and a backend (BE) component 104c that facilitates movement of the data between the system cache and non-volatile physical storage (e.g., back end physical non-volatile storage devices or PDs accessed by BE components such as DAs as described herein). During movement of data in and out of the system cache layer 104b (e.g., such as in connection with read data from, and writing data to, physical storage 110a, 110b), inline processing can be performed by layer 105a. Such inline processing operations of 105a can be optionally performed and can include any one of more data processing operations in connection with data that is flushed from system cache layer 104b to the back-end non-volatile physical storage 110a, 110b, as well as when retrieving data from the back-end non-volatile physical storage 110a, 110b to be stored in the system cache layer 104b. In at least one embodiment, the inline processing can include, for example, performing one or more data reduction operations such as data deduplication or data compression. The inline processing can include performing any suitable or desirable data processing operations as part of the I/O or data path.

In a manner similar to that as described for data path 104, the data path 106 for processing node B 102b has its own FE component 106a, system cache layer 106b, inline processing layer 105b, and BE component 106c that are respectively similar to the components 104a, 104b, 105a and 104c. The elements 110a, 110b denote the non-volatile BE physical storage provisioned from PDs for the LUNs, whereby an I/O can be directed to a location or logical address of a LUN and where data can be read from, or written to, the logical address. The LUNs 110a, 110b are examples of storage objects representing logical storage entities included in an existing data storage system configuration. Since, in this example, writes, or more generally I/Os, directed to the LUNs 110a, 110b can be received for processing by either of the nodes 102a and 102b, the example 100 illustrates what can also be referred to as an active-active configuration.

In connection with a write operation received from a host and processed by the processing node A 102a, the write data can be written to the system cache 104b, marked as write pending (WP) denoting it needs to be written to the physical storage 110a, 110b and, at a later point in time, the write data can be destaged or flushed from the system cache to the physical storage 110a, 110b by the BE component 104c. The write request can be considered complete once the write data has been stored in the system cache whereby an acknowledgement regarding the completion can be returned to the host (e.g., by component the 104a). At various points in time, the WP data stored in the system cache is flushed or written out to the physical storage 110a, 110b.

In connection with the inline processing layer 105a, prior to storing the original data on the physical storage 110a, 110b, one or more data reduction operations can be performed. For example, the inline processing can include performing data compression processing, data deduplication processing, and the like, that can convert the original data (as stored in the system cache prior to inline processing) to a resulting representation or form which is then written to the physical storage 110a, 110b.

In connection with a read operation to read a block of data, a determination is made as to whether the requested read data block is stored in its original form (in system cache 104b or on physical storage 110a, 110b), or whether the requested read data block is stored in a different modified form or representation. If the requested read data block (which is stored in its original form) is in the system cache, the read data block is retrieved from the system cache 104b and returned to the host. Otherwise, if the requested read data block is not in the system cache 104b but is stored on the physical storage 110a, 110b in its original form, the requested data block is read by the BE component 104c from the backend storage 110a, 110b, stored in the system cache and then returned to the host.

If the requested read data block is not stored in its original form, the original form of the read data block is recreated and stored in the system cache in its original form so that it can be returned to the host. Thus, requested read data stored on physical storage 110a, 110b can be stored in a modified form where processing is performed by 105a to restore or convert the modified form of the data to its original data form prior to returning the requested read data to the host.

Also illustrated in FIG. 2A is an internal network interconnect 120 between the nodes 102a, 102b. In at least one embodiment, the interconnect 120 can be used for internode communication between the nodes 102a, 102b.

In connection with at least one embodiment in accordance with the techniques of the present disclosure, each processor or CPU can include its own private dedicated CPU cache (also sometimes referred to as processor cache) that is not shared with other processors. In at least one embodiment, the CPU cache, as in general with cache memory, can be a form of fast memory (relatively faster than main memory which can be a form of RAM). In at least one embodiment, the CPU or processor cache is on the same die or chip as the processor and typically, like cache memory in general, is far more expensive to produce than normal RAM used as main memory. The processor cache can be substantially faster than the system RAM used as main memory. The processor cache can contain information that the processor will be immediately and repeatedly accessing. The faster memory of the CPU cache can for example, run at a refresh rate that's closer to the CPU's clock speed, which minimizes wasted cycles. In at least one embodiment, there can be two or more levels (e.g., L1, L2 and L3) of cache. The CPU or processor cache can include at least an L1 level cache that is the local or private CPU cache dedicated for use only by that particular processor. The two or more levels of cache in a system can also include at least one other level of cache (LLC or lower level cache) that is shared among the different CPUs. The L1 level cache serving as the dedicated CPU cache of a processor can be the closest of all cache levels (e.g., L1-L3) to the processor which stores copies of the data from frequently used main memory locations. Thus, the system cache as described herein can include the CPU cache (e.g., the L1 level cache or dedicated private CPU/processor cache) as well as other cache levels (e.g., the LLC) as described herein. Portions of the LLC can be used, for example, to initially cache write data which is then flushed to the backend physical storage such as BE PDs providing non-volatile storage. For example, in at least one embodiment, a RAM based memory can be one of the caching layers used as to cache the write data that is then flushed to the backend physical storage. When the processor performs processing, such as in connection with the inline processing 105a, 105b as noted above, data can be loaded from the main memory and/or other lower cache levels into its CPU cache.

In at least one embodiment, the data storage system can be configured to include one or more pairs of nodes, where each pair of nodes can be generally as described and represented as the nodes 102a-b in the FIG. 2A. For example, a data storage system can be configured to include at least one pair of nodes and at most a maximum number of node pairs, such as for example, a maximum of 4 node pairs. The maximum number of node pairs can vary with embodiment. In at least one embodiment, a base enclosure can include the minimum single pair of nodes and up to a specified maximum number of PDs. In some embodiments, a single base enclosure can be scaled up to have additional BE non-volatile storage using one or more expansion enclosures, where each expansion enclosure can include a number of additional PDs. Further, in some embodiments, multiple base enclosures can be grouped together in a load-balancing cluster to provide up to the maximum number of node pairs. Consistent with other discussion herein, each node can include one or more processors and memory. In at least one embodiment, each node can include two multi-core processors with each processor of the node having a core count of between 8 and 28 cores. In at least one embodiment, the PDs can all be non-volatile SSDs, such as flash-based storage devices and storage class memory (SCM) devices. It should be noted that the two nodes configured as a pair can also sometimes be referred to as peer nodes. For example, the node A 102a is the peer node of the node B 102b, and the node B 102b is the peer node of the node A 102a.

In at least one embodiment, the data storage system can be configured to provide both block and file storage services with a system software stack that includes an operating system running directly on the processors of the nodes of the system.

In at least one embodiment, the data storage system can be configured to provide block-only storage services (e.g., no file storage services). A hypervisor can be installed on each of the nodes to provide a virtualized environment of virtual machines (VMs). The system software stack can execute in the virtualized environment deployed on the hypervisor. The system software stack (sometimes referred to as the software stack or stack) can include an operating system running in the context of a VM of the virtualized environment. Additional software components can be included in the system software stack and can also execute in the context of a VM of the virtualized environment.

In at least one embodiment, each pair of nodes can be configured in an active-active configuration as described elsewhere herein, such as in connection with FIG. 2A, where each node of the pair has access to the same PDs providing BE storage for high availability. With the active-active configuration of each pair of nodes, both nodes of the pair process I/O operations or commands and also transfer data to and from the BE PDs attached to the pair. In at least one embodiment, BE PDs attached to one pair of nodes are not shared with other pairs of nodes. A host can access data stored on a BE PD through the node pair associated with or attached to the PD.

In at least one embodiment, each pair of nodes provides a dual node architecture where both nodes of the pair can be generally identical in terms of hardware and software for redundancy and high availability. Consistent with other discussion herein, each node of a pair can perform processing of the different components (e.g., FA, DA, and the like) in the data path or I/O path as well as the control or management path. Thus, in such an embodiment, different components, such as the FA, DA and the like of FIG. 1, can denote logical or functional components implemented by code executing on the one or more processors of each node. Each node of the pair can include its own resources such as its own local (i.e., used only by the node) resources such as local processor(s), local memory, and the like.

Consistent with other discussion herein, a cache can be used for caching write I/O data and other cached information. In one system, the cache used for caching logged writes can be implemented using multiple caching devices or PDs, such as non-volatile (NV) SSDs such as NVRAM devices that are external with respect to both of the nodes or storage controllers. The caching devices or PDs used to implement the cache can be configured in a RAID group of any suitable RAID level for data protection. In at least one embodiment, the caching PDs form a shared non-volatile cache accessible to both nodes of the dual node architecture. It should be noted that in a system where the caching devices or PDs are external with respect to the two nodes, the caching devices or PDs are in addition to other non-volatile PDs accessible to both nodes. The additional PDs provide the BE non-volatile storage for the nodes where the cached data stored on the caching devices or PDs is eventually flushed to the BE PDs as discussed elsewhere herein. In at least one embodiment, a portion of each node's local volatile memory can also be used for caching information, such as blocks or pages of user data and metadata. For example, such node-local cached pages of user data and metadata can be used in connection with servicing reads for such user data and metadata.

In the following paragraphs, the one or more caching devices or PDs may be referred to as a data journal or log used in the data storage system. In such a system, the caching devices or PDs are non-volatile log devices or PDs upon which the log is persistently stored. It should be noted that as discussed elsewhere herein, both nodes can also each have local volatile memory used as a node local cache for storing data, structures and other information. In at least one embodiment, the local volatile memory local to one of the nodes is used exclusively by that one node.

In a data storage system, minimizing the latency of I/O requests is a critical performance metric. In at least one data storage system using the dual node architecture such as described in connection with FIG. 2A, for write operations, latency can be affected by the amount of time taken to store the write data in the log where the write data is visible to both nodes or controllers of the system.

Consistent with other discussion herein, the log file used to log user operations, such as write I/Os, can be used to optimize write operation latency. Generally, a write operation writing data is received by the data storage system from a host or other client. The data storage system then performs processing to persistently record the write operation in the log. Once the write operation is persistently recorded in the log, the data storage system can send an acknowledgement to the client regarding successful completion of the write operation. At some point in time subsequent to logging the write operation the log, the write operation is flushed or destaged from the log to the BE PDs. In connection with flushing the recorded write operation from the log, the data written by the write operation is stored on non-volatile physical storage of a BE PD. The space of the log used to record the write operation that has been flushed can now be reclaimed for reuse.

It should be noted that the flushing of the log can be performed in response to an occurrence of any one or more defined conditions. For example, the log can be flushed in response to determining that the amount of reclaimed log space available for use and allocation is less than a specified threshold amount or size.

In at least one embodiment, a metadata (MD) structure of mapping information can be used in accordance with the techniques herein. The mapping information can be used, for example, to map a logical address, such as a LUN and an LBA or offset, to its corresponding storage location, such as a physical storage location on BE non-volatile PDs of the system. Consistent with discussion elsewhere herein, write requests or operations stored in the log can be flushed to the BE PDs (non-volatile) providing storage locations for the written data. For example, a logged write operation that writes first data to a logical address can be flushed whereby the logged first data is written out to a physical storage location on a BE PD. The mapping information can be used to map the logical address to the physical storage location containing the content or data stored at the logical address. In at least one embodiment, the mapping information includes a MD structure that is hierarchical structure of multiple layers of MD pages or blocks.

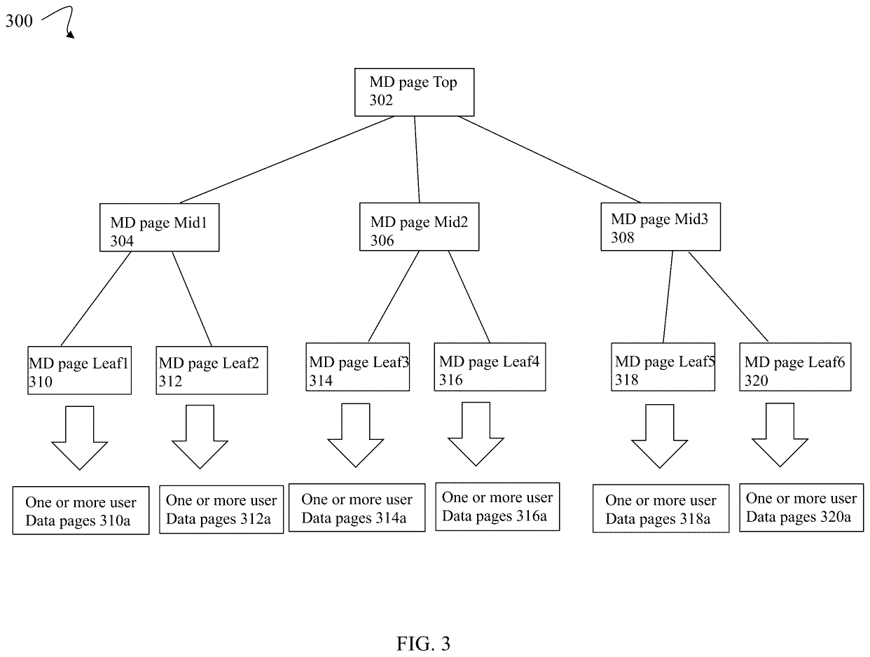

In at least one embodiment, the mapping information or MD structure for a LUN, such as a LUN A, can be in the form of a tree having a plurality of levels of MD pages. More generally, the mapping structure can be in the form of any ordered list or hierarchical structure. In at least one embodiment, the mapping structure for the LUN A can include LUN MD in the form of a tree having 3 levels including a single top or root node (TOP node), a single mid-level (MID node) and a bottom level of leaf nodes (LEAF nodes), where each of the MD page leaf nodes can point to, or reference (directly or indirectly) one or more pages of stored data, such as user data stored on the LUN A. Each node in the tree corresponds to a MD page including MD for the LUN A. More generally, the tree or other hierarchical structure of various MD pages of the mapping structure for the LUN A can include any suitable number of levels, such as more than 3 levels where there are multiple mid-levels. In at least one embodiment the tree of MD pages for the LUN can be a B+ tree, also sometimes referred to as an “N-ary” tree, where “N” indicates that each node in the tree structure can have up to a maximum of N child nodes. For example, in at least one embodiment, the tree of MD pages for the LUN can specify N=512 whereby each node in the tree structure can have up to a maximum of N child nodes. For simplicity of illustration, the tree structure of MD pages, corresponding to the mapping structure in at least one embodiment, is represented in FIG. 3 as including only 3 levels where each node in the tree can have at most 3 child nodes. Generally, the techniques herein can be used with any layered or hierarchical structure of MD pages.

Before describing in more detail the mapping information of MD pages that can be used in an at least one embodiment to map a logical address to a corresponding physical storage location or address, further details are described in connection with using a log for logging user or client operations, such as write I/Os.

Consistent with other discussion herein, the log can be used to optimize write operation latency. Generally, the write operation writing data is received by the data storage system from a host or other client. The data storage system then performs processing to persistently record the write operation in the log. Once the write operation is persistently recorded in the log, the data storage system can send an acknowledgement to the client regarding successful completion of the write operation. At some point in time subsequent to logging the write operation the log, the write operation is flushed or destaged from the log to the BE PDs. In connection with flushing the recorded write operation from the log, the data written by the write operation is stored on non-volatile physical storage of a BE PD. The space of the log used to record the write operation that has been flushed can now be reclaimed for reuse. The write operation can be recorded in the log in any suitable manner and can include, for example, recording a target logical address to which the write operation is directed and recording the data written to the target logical address by the write operation.

In the log, each logged operation can be recorded in the next logically sequential record of the log. For example, a logged write I/O and write data (e.g., write I/O payload) can be recorded in a next logically sequential record of the log. The log can be circular in nature in that once a write operation is recorded in the last record of the log, recording of the next write proceeds with recording in the first record of the log.

The typical I/O pattern for the log as a result of recording write I/Os and possibly other information in successive consecutive log records includes logically sequential and logically contiguous writes (e.g., logically with respect to the logical offset or ordering within the log). Data can also be read from the log as needed (e.g., depending on the particular use or application of the log) so typical I/O patterns can also include reads. The log can have a physical storage layout corresponding to the sequential and contiguous order in which the data is written to the log. Thus, the log data can be written to sequential and consecutive physical storage locations in a manner corresponding to the logical sequential and contiguous order of the data in the log. Additional detail regarding use and implementation of the log in at least one embodiment in accordance with the techniques of the present disclosure is provided below.

Referring to FIG. 2B, shown is an example 200 illustrating a sequential stream 220 of operations or requests received that are written to a log in an embodiment in accordance with the techniques of the present disclosure. In this example, the log can be stored on the LUN 11 where logged operations or requests, such as write I/Os that write user data to a file, target LUN or other storage object, are recorded as records in the log. The element 220 includes information or records of the log for 3 write I/Os or updates which are recorded in the records or blocks I 221, I+1 222 and I+2 223 of the log (e.g., where I denotes an integer offset of a record or logical location in the log). The blocks I 221, I+1 222, and I+2 223 can be written sequentially in the foregoing order for processing in the data storage system. The block 221 can correspond to the record or block I of the log stored at LUN 11, LBA 0 that logs a first write I/O operation. The first write I/O operation can write “ABCD” to the target logical address LUN 1, LBA 0. The block 222 can correspond to the record or block I+1 of the log stored at LUN 11, LBA 1 that logs a second write I/O operation. The second write I/O operation can write “EFGH” to the target logical address LUN 1, LBA 5. The block 223 can correspond to the record or block I+2 of the log stored at LUN 11, LBA 2 that logs a third write I/O operation. The third write I/O operation can write “WXYZ” to the target logical address LUN 1, LBA 10. Thus, each of the foregoing 3 write I/O operations logged in 221, 222 and 223 write to 3 different logical target addresses or locations each denoted by a target LUN and logical offset on the target LUN. As illustrated in the FIG. 2B, the information recorded in each of the foregoing records or blocks 221, 222 and 223 of the log can include the target logical address to which data is written and the write data written to the target logical address.

The head pointer 224 can denote the next free record or block of the log used to record or log the next write I/O operation. The head pointer can be advanced 224a to the next record in the log as each next write I/O operation is recorded. When the head pointer 224 reaches the end of the log by writing to the last sequential block or record of the log, the head pointer can advance 203 to the first sequential block or record of the log in a circular manner and continue processing. The tail pointer 226 can denote the next record or block of a recorded write I/O operation in the log to be destaged and flushed from the log. Recorded or logged write I/Os of the log are processed and flushed whereby the recorded write I/O operation that writes to a target logical address or location (e.g., target LUN and offset) is read from the log and then executed or applied to a non-volatile BE PD location mapped to the target logical address (e.g., where the BE PD location stores the data content of the target logical address). Thus, as records are flushed from the log, the tail pointer 226 can logically advance 226a sequentially (e.g., advance to the right toward the head pointer and toward the end of the log) to a new tail position. Once a record or block of the log is flushed, the record or block is freed for reuse in recording another write I/O operation. When the tail pointer reaches the end of the log by flushing the last sequential block or record of the log, the tail pointer advances 203 to the first sequential block or record of the log in a circular manner and continue processing. Thus, the circular logical manner in which the records or blocks of the log are processed form a ring buffer in which the write I/Os are recorded.

When a write I/O operation writing user data to a target logical address is persistently recorded and stored in the non-volatile log, the write I/O operation is considered complete and can be acknowledged as complete to the host or other client originating the write I/O operation to reduce the write I/O latency and response time. The write I/O operation and write data are destaged at a later point in time during a flushing process that flushes a recorded write of the log to the BE non-volatile PDs, updates and writes any corresponding metadata for the flushed write I/O operation, and frees the record or block of the log (e.g., where the record or block logged the write I/O operation just flushed). The metadata updated as part of the flushing process for the target logical address of the write I/O operation can include mapping information as described elsewhere herein. The mapping information of the metadata for the target logical address can identify the physical address or location on provisioned physical storage on a non-volatile BE PD storing the data of the target logical address. The target logical address can be, for example, a logical address on a logical device, such as a LUN and offset or LBA on the LUN.

The log 200 can be an examples of information that can be included, for example, in a log of user or client write operations, in an embodiment in accordance with the techniques of the present disclosure. In at least one embodiment, the log records such as 221-223 can also each record or denote the write data or data changed (e.g., write I/O operation payload).

The log can be flushed sequentially or in any suitable manner to maintain desired data consistency. In order to maintain data consistency when flushing the log, constraints can be placed on an order in which the records of the log are flushed or logically applied to the stored data while still allowing any desired optimizations. In some embodiments, portions of the log can be flushed in parallel in accordance with any necessary constraints needed in order to maintain data consistency. Such constraints can consider any possible data dependencies between logged writes (e.g., two logged writes that write to the same logical address) and other logged operations in order to ensure write order consistency.

Referring to FIG. 2C, shown is an example 700 illustrating the flushing of logged writes and the physical data layout of user data on BE PDs in at least one embodiment in accordance with the techniques of the present disclosure. FIG. 2D includes the log 620, the mapping information A 610, and the physical storage (i.e., BE PDs) 640. The element 630 represents the physical layout of the user data as stored on the physical storage 640. The element 610 can represent the logical to physical storage mapping information A 610 created for 3 write I/O operations recorded in the log records or blocks 221, 222 and 223.

The mapping information A 610 includes the elements 611a-c denoting the mapping information, respectively, for the 3 target logical address of the 3 recorded write I/O operations in the log records 221, 222, and 223. The element 611a of the mapping information denotes the mapping information for the target logical address LUN1, LBA 0 of the block 221 of the log 620. In particular, the block 221 and mapping information 611a indicate that the user data “ABCD” written to LUN 1, LBA 0 is stored at the physical location (PD location) P1 633a on the physical storage 640. The element 611b of the mapping information denotes the mapping information for the target logical address LUN1, LBA 5 of the block 222 of the log 620. In particular, the block 222 and mapping information 611b indicate that the user data “EFGH” written to LUN 1, LBA 5 is stored at the physical location (PD location) P2 633b on the physical storage 640. The element 611c of the mapping information denotes the mapping information for the target logical address LUN 1, LBA 10 of the block 223 of the log 620. In particular, the block 223 and mapping information 611 indicate that the user data “WXYZ” written to LUN 1, LBA 10 is stored at the physical location (PD location) P3 633c on the physical storage 640.

The mapped physical storage 630 illustrates the sequential contiguous manner in which user data can be stored and written to the physical storage 640 as the log records or blocks are flushed. In this example, the records of the log 620 can be flushed and processing sequentially (e.g., such as described in connection with FIG. 2B) and the user data of the logged writes can be sequentially written to the mapped physical storage 630 as the records of the log are sequentially processed. As the user data pages of the logged writes to the target logical addresses are written out to sequential physical locations on the mapped physical storage 630, corresponding mapping information for the target logical addresses can be updated. The user data of the logged writes can be written to mapped physical storage sequentially as follows: 632, 633a, 633b, 633c and 634. The element 632 denotes the physical locations of the user data written and stored on the BE PDs for the log records processed prior to the block or record 221. The element 633a denotes the PD location P1 of the user data “ABCD” stored at LUN 1, LBA 1. The element 633b denotes the PD location P2 of the user data “EFGH” stored at LUN 1, LBA 5. The element 633c denotes the PD location P3 of the user data “WXYZ” stored at LUN 1, LBA 10. The element 634 denotes the physical locations of the user data written and stored on the BE PDs for the log records processed after the block or record 223.

In one aspect, the data layout (e.g., format or structure) of the log-based data of the log 620 as stored on non-volatile storage can also be physically sequential and contiguous where the non-volatile storage used for the log can be viewed logically as one large log having data that is laid out sequentially in the order it is written to the log.

The data layout of the user data as stored on the BE PDs can also be physically sequential and contiguous. As log records of the log 620 are flushed, the user data written by each flushed log record can be stored at the next sequential physical location on the BE PDs. Thus, flushing the log can result in writing user data pages or blocks to sequential consecutive physical locations on the BE PDs. In some embodiments, multiple logged writes can be flushed in parallel as a larger chunk to the next sequential chunk or portion of the mapped physical storage 630.

Consistent with other discussion herein, the mapped physical storage 630 can correspond to the BE PDs providing BE non-volatile storage used for persistently storing user data as well as metadata, such as the mapping information. With a log-structured system as discussed herein, as recorded writes in the log are processed, the data written by the writes can be written to new physical storage locations on the BE PDs.

Referring to FIG. 3, shown is an example 300 of a tree of MID pages that can be used in an embodiment in accordance with the techniques herein. The example 300 includes a tree of MD pages denoting the mapping structure as discussed above with 3 levels-a top or root level, level 1, including a single MD TOP page; a single mid or middle level, level 2, of MD MID pages; and a bottom level, level 3, of leaf nodes of MD LEAF pages. In the example 300, the top or root level, level 1, includes MD page 302; the mid or middle level, level 2, includes MD pages 304, 306 and 308; and the bottom level, level 3, includes MD pages 310, 312, 314, 316, 318 and 320, which can also be referred to as leaf nodes. As also illustrated in the example 300, each of the leaf MD pages in level 3 of the tree points to, or references (e.g., directly or otherwise indirectly using one more additional levels of indirection of pointers not illustrated) one or more user data pages or blocks including data stored at various LBAs of a LUN such as the LUN A. For example, MD pages 310, 312, 314, 316, 318 and 320 point or reference, respectively, one or more UD pages 310a, 312a, 314a, 316a, 318a and 320a.

The links or connections between a parent node (at level M) and its one or more child nodes (at level M+1) in the tree 300 generally represent mappings between the parent node and the one or more child nodes. In at least one embodiment, the parent node can include a reference used to access (directly or indirectly) each of its one or more child nodes. For example, the root node MD page top 302 can include addresses or pointers used to access each of its child nodes 304, 306 and 308. The mid-level node MD page mid1 304 can include addresses or pointers used to access each of its child leaf nodes 310, 312. The mid-level node MD page mid 306 can include addresses or pointers used to access each of its child leaf nodes 314, 316. The mid-level node MD page mid 308 can include addresses or pointers used to access each of its child leaf nodes 318, 320.

In at least one embodiment, each of the addresses or pointers included in a MD page that references a location in another MD page or references a location in a UD page can be a physical storage location on the back-end PDs. Thus, the traversal between connected nodes of the structure 300 can correspond to traversing physical address or storage locations included in pages or nodes that are parent nodes.

In connection with accessing a particular UD page in at least one embodiment, all MD pages in a path from the root or top level of the tree to the UD page can be traversed in a consecutive serialized order in which such pages appear in the path traversal down the path from the top or root level to the UD page accessed using a particular one of the MD page leaf nodes. For example, assume UD page or block X is included in the set of UD pages 312a. In order to access UD page X of 312a, the following denotes the consecutive serialized order in which the MD pages forming a sequence are accessed: MD page top 302, MD page mid1 304, and MD page leaf2 312. Generally, in at least one embodiment, each of the MD pages can include pointers or addresses to locations of one or more child pages or nodes. Thus, the foregoing traversal of MD pages denotes the sequence of MD pages that are processed in consecutive serialized order in order to access the particular UD page, such as UD page X. In order to access the UD page X as stored on PDs where UD page X includes first data needed to service a read I/O operation in connection with a cache miss of the first data, each of the MD pages in the foregoing sequence (e.g., MD page top 302, MD page mid 1 304, and MD page leaf2 312) needs to be accessed in consecutive serialized order. In at least one embodiment, the sequence of MD pages, and more generally, the path from the MD page top to the UD page X, forms a linked list of nodes of pages. In at least one embodiment, each parent node or MD page of the structure 300 can generally include multiple pointers or references to locations of its child nodes or pages.

For example, MD page top 302 includes pointers to locations of its child nodes, MD pages 304, 306 and 308. MD page mid2 306 includes pointers to locations of its child nodes, MD pages 314 and 316.

The data pages 310a, 312a, 314a, 316a, 318a and 320a include UD stored on particular logical addresses of a LUN's address space, such as the LUN A's logical address space. In at least one embodiment each MD leaf can hold MD for a specified number of LBAs of a LUN. For example, in one embodiment each MD leaf can hold MD for 512 LBAs. For example, with reference to FIG. 3, the data pages 310a, 312a, 314a, 316a, 318a and 320 each include user data stored on particular logical addresses of the LUN A's logical address space. It may be, for example, that element 310a includes user data stored at a first set of LBAs 0-511; and that element 312a includes user data stored at a second set of LBAs 512-1023. Generally, the particular LBAs of the LUN mapped to each MD page can vary with embodiment. For example, in at least one embodiment, consecutive sequential subranges of the LUN's logical address space can be mapped to the MD page leaves. Additionally, when the tree is traversed in a depth first manner, the MD page leaves can correspond to consecutive sequential subranges. For example, the element 310a denotes data pages for LBAs 0-511; the element 312a denotes data pages for the LBAs 512-1023; the element 314a denotes data pages for LBAs 1024-1535; the element 316a denotes data pages for LBAs 1536-2047, and so on.

As generally known in the art, a depth-first traversal is an algorithm for traversing or tree or graph data structures. The algorithm starts at the root node (selecting some arbitrary node as the root node in the case of a graph) and explores as far as possible along each path extending from the root to a leaf node before backtracking up the path to find a yet another unexplored path. In at least one embodiment, traversal of the tree 300 of MID pages in a depth-first manner explores all paths, in sequential order, from the left-most path to the right most path as arranged in the tree.

In at least one embodiment, when the structure 300 is traversed in a depth first manner (i.e., from the left-most path to the right most path as arranged in the tree), the MID page leaf nodes that occur in the depth first traversal correspond to consecutive sequential LBA subranges of a LUN. In at least one embodiment, when the overall tree including MD page top node 302 and all its descendant nodes are traversed in this depth first manner, the MD page leaf nodes that occur in the depth first traversal correspond to consecutive sequential LBA subranges of a LUN.

In at least one embodiment as described herein, each of the MD pages and data blocks in the example 300 can be of a predetermined size and each of the MD pages can hold a known number of entries containing pointer or address values. In such a case and in combination with the correspondence of sequential consecutive LBA ranges of each MD leaf page, an embodiment can perform a calculation to determine the MD page at a particular level that is accessed in the tree MD mapping structure 300 to determine the data block for a particular LUN and LBA. Similarly, it is a straightforward mathematical calculation to determine the index, offset of entry in a particular page or node to be accessed in connection with obtaining data blocks stored at the particular LUN and LBAs of the LUN. Each MD page in 300 can be known to include MD relevant for accessing data on a particular LUN and one or more LBAs of that LUN. For example, consistent with discussion above, the element 310a denotes the data blocks for LBAs 0-511 of a LUN. In order to access the data block for an LBA of the LUN in the LBA subrange 0-511, MD pages 302, 304 and 310 can be traversed in sequential order. In particular, the first entry or offset of the MD page top 302 can contain the address of the MD page mid 1 304; the first entry or offset of the MID page mid 1 304 can contain the address of the MD page leaf 1 310; and the first entry or offset of the MD page leaf 1 310 can contain the address of one of the data blocks of 310a.

In a similar manner, a mapping can be made regarding what MD pages of the structure 300 and entries thereof are used in connection with obtaining data blocks containing data for any particular LUN and LBA. In at least one embodiment, the particular MD pages used to access a data block including data for a particular LUN and LBA can be known based on such mappings and correspondence of LBA subranges to particular MD leaf pages.

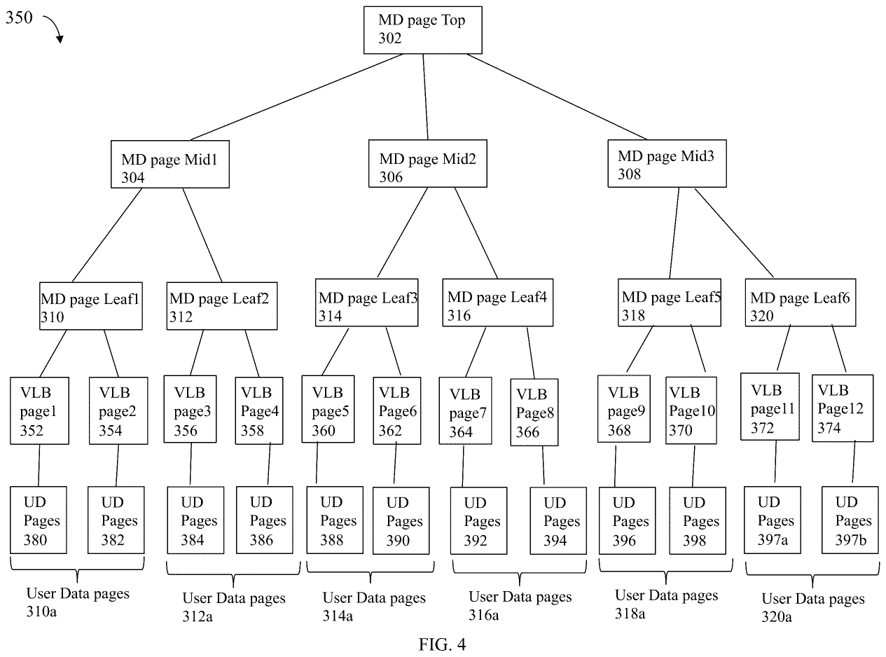

Referring to FIG. 4, shown is a more detailed version of a hierarchical structure used as the mapping structure 108 that can be used in an embodiment in accordance with the techniques of the present disclosure. The structure 350 is similar to the structure 300 as described and illustrated in FIG. 3 with the added difference that more detail is provided regarding the intervening layer of a VLB (virtualization layer block) MD pages between the MD page leaves and the UD pages. Thus, in such an embodiment, the structure 350 includes 4 levels of MD pages as opposed to the possible 3 levels as allowed in the more generalized structure 300 represented in FIG. 3. In this case, each sequence of MD pages traversed in a path from the MD page top or root to access a particular UD page includes 4 MD pages-MD page top 302, one of the MD page Mid nodes (e.g., one of 304, 306 or 308), one of the MD page leaf nodes (e.g., one of 310, 312, 314, 316, 318 and 320), and one of the VLB pages (e.g., one of 352, 354, 356, 358, 360, 362, 364, 366, 368, 370, 372 and 374).

In at least one embodiment, the use of VLBs as a layer in the hierarchy between the MD leaf nodes and the UD pages can be used to facilitate different data storage services, such as relocating UD between different physical storage location, data deduplication, and the like. An entry of the VLB associated with a particular physical storage location can be remapped without requiring remapping of a MD leaf to the UD page.

The UD pages 380 and 382 denote two portions of UD pages corresponding to UD pages 310a of FIG. 3 including data for LBAs 0-511. The UD pages 384 and 386 denote two portions of UD pages corresponding to UD pages 312a of FIG. 3 including data for LBAs 512-1023. The UD pages 388 and 390 denote two portions of UD pages corresponding to UD pages 314a of FIG. 3 including data for LBAs 1024-1535. The UD pages 392 and 394 denote two portions of UD pages corresponding to UD pages 316a of FIG. 3 including data for LBAs 1536-2047. The UD pages 396 and 398 denote two portions of UD pages corresponding to UD pages 318a of FIG. 3 including data for LBAs 2048-2559. The UD pages 397a and 397b denote two portions of UD pages corresponding to UD pages 320a of FIG. 3 including data for LBAs 2560-3072.

In furtherance of the example above regarding UD page X and now with reference to FIG. 4, assume more specifically that UD page X is located in the set of UD pages denoted by 384. In this case, the MD page sequence including the MD pages traversed in order to access UD page X 384 includes MD page 302, MD page 304, MD page 312, and VLB page3 356.

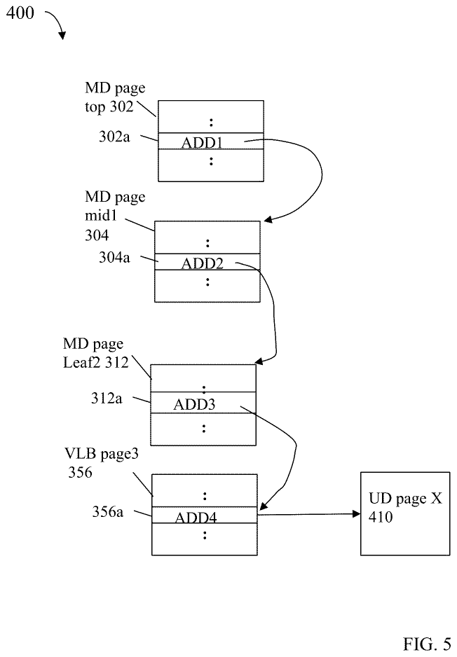

Referring to FIG. 5, shown is a more detailed representation 400 of the MD pages of the sequence traversed to access the UD page X 384 included in the set of UD pages 312a. As noted above, the MD page sequence includes MD page 302, MD page 304, MD page 312, and VLB page3 356. In the example 400, MD page top 302 includes an entry or address 302a that points to or references the MD page mid1 304. In at least one embodiment, the starting entry 302a in the first MD page 302 of the sequence can be determined based on the logical address including the desired UD stored in a page or block of storage (e.g., physical non-volatile storage location on the BE PDs of the system). For example, assume processing is performed to read the UD for LUN A, LBA 514 located in UD page X. In at least one embodiment, the logical address LUN A, LBA 514 can be used to determine the particular structure instance and thus the particular MD page top 302 to access. The LBA 514 of the logical address of the UD can also be used to determine an index or offset into the MD page 302 to determine the relevant entry, location or address 302a having a pointer, address or reference to the next MD page in the sequence to access the desired page including the UD for LUN A, LBA 514. An embodiment can generally use any suitable technique to map a corresponding logical address, such as an LBA of a particular LUN, to an entry in the top level MD page 302.

The MD page top 302 can be accessed and read from a PD to obtain the address or pointer ADD1 from location 302a. If the MD page 302 is already in cache, the cached copy can be used to obtain the address or pointer ADD1 from the location 302a. The address or pointer ADD1 of location 302a can then be used to identify the particular mid level MD page, such as MD page mid 1 304, that is accessed next in the sequence.

Continuing with the example 400, the MD page mid 1 304 can be accessed where the location 304a is read to obtain the address or pointer ADD2 from location 304a. In at least one embodiment, the particular entry or offset 304a of the MD mid1 page can be determined based on the logical address being mapped. The address or pointer ADD2 can then be used to identify the particular leaf level MD page, such as MD page leaf2 312, that is next accessed in the sequence. If the MD page mid 1 304 is not in cache, the on-disk copy of the MD page 304 on a PD can be accessed to read the address or pointer ADD2 from the location 304a. The address or pointer ADD2 identifies the MD page leaf 2 312. If the MD page 312 is not already in cache, the on-disk copy of the MD page 312 on a PD can be read to obtain the content of location 312a. In at least one embodiment, the particular desired entry or offset 312a of the MD leaf2 page 312 can be determined based on the logical address being mapped. The location 312a of the MD page leaf2 312 can be accessed and read to obtain the address or pointer ADD3 from location 312a. The address or pointer ADD3 can then be used to identify a particular entry of a VLB page, such as the entry 356a of the VLB page3 356, that is next accessed in the sequence. Thus, ADD3 can denote the location or address of the entry 356a in the VLB page 3 356.

If the VLB page 356 is not already in cache, the on-disk copy of the VLB page 356 on a PD can be read to obtain the content of location 356a. The location 356a of the VLB page 3 356 can be accessed and read to obtain the address or pointer ADD4 from the location 356a. The address or pointer ADD4 can then be used to identify the particular UD page X 410 where the UD page X can next be read. If the UD page X is not in cache, the on-disk copy of the UD page X can be read in from a PD.

The example 400 of FIG. 5 includes the path or traversal of MD pages in the structure 350 from the MD page root or top 302 to the UD page X of 384 including the desired UD for the logical address LUN A, LBA 514. The path or traversal of MD pages 302, 304, 312, 356 and 384 denotes the sequence of MD pages read and accessed in order to obtain the UD page X of 384.

In at least one embodiment, each VLB can be a VLB page or node as described herein including multiple entries, such as 512 entries, where each such VLB entry can include one or more fields of information such as the address or pointer to a physical storage location of stored content or data. Additionally in at least one embodiment, each VLB entry pointing to or associated with stored content or data can also include a reference count denoting a number of references or logical addresses that store the content or data. In at least one embodiment, multiple MD leaf entries corresponding to multiple logical addresses of used data or content can all reference or point to the same VLB entry thereby denoting that such multiple logical addresses all store the same content or data associated with the VLB entry.

The reference count of a VLB entry can be updated in connection with deduplication processing and/or as used data or content stored at various logical addresses changes. For example, deduplication processing can be performed on new data written to a target logical address by a write I/O operation. Deduplication processing can determine that the new data is a duplicate of existing data stored in a data block. Rather than store another copy of the same data in another data block, deduplication processing can include alternatively having the target logical address reference the single existing copy of the data as stored in the data block. As part of deduplication processing, the reference count associated with the single existing copy of the data block can be incremented as each additional reference to the same data block is made. In a similar manner, the reference count can be decremented as content of a particular logical address is modified or deleted to no longer be considered a duplicate of the single existing copy of the data block.

For a read I/O operation received at a node of a dual node system or appliance such as in an active-active configuration, servicing the read operation can include reading one or more data blocks or storage locations as well as reading information from one or more MD pages such as, for example, of the MD or mapping structure as described in connection with FIGS. 3-5.

For a write I/O operation received at a node of a dual node system or appliance such as in an active-active configuration, servicing the write operation can include reading information from one or more MD pages. Servicing the write operation can include updating one or more data blocks or storage locations as well as updating one or more MD pages such as, for example, of the MD or mapping structure as described in connection with FIGS. 3-5.

In at least one embodiment, the MD or mapping information used in connection with stored user data can be stored on non-volatile storage, such as on the BE PDs of the appliance or data storage system. At least some of the MD pages of mapping information for all such user data can be stored in a volatile memory cache of each of the nodes of the appliance or system. Depending on the write operation, one or more logical addresses can be updated with new data or content by a write operation. Additionally, one or more MD pages used to map the one or more logical addresses to one or more physical storage locations storing the new data can also be updated, for example, to reference the one or more physical storage location including the new data or content.

With a log-structured system in at least one embodiment, as recorded writes of the log are processed and flushed or destaged to the BE PDs, the content written by the recorded writes of the log can be stored at new subsequent physical storage locations on the BE PDs. Additionally, the MD or mapping information corresponding to the logged writes being flushed can also be accordingly updated to reference the new subsequent physical storage locations on the BE PDs containing the content. In a dual node appliance or system with an active-active configuration as described herein, both nodes of the system can concurrently receive and service write I/Os, as well as other received requests and commands using shared resources such as, for example, the MD or mapping structure described in connection with the FIGS. 3-5.

In at least one embodiment, updates or modifications to the MD pages of the MD or mapping structure described in connection with the FIGS. 3-5 can also similarly be recorded in entries or records of a persistently stored metadata log and then flushed or destaged from the metadata log to persistent BE storage of the BE PDs. In at least one embodiment, the MD pages of the MD or mapping structure such as described in connection with the FIGS. 3-5 can be persistently stored in a MD page store on the BE PDs of the system. In some contexts herein, the copy of a MD page as stored in the MD page store on the BE PDs can also be referred to herein as the on-disk copy of the MD page.

In some existing implementations, when an update is made to a MD page, the entire resulting MD page with the update applied can be stored in the metadata log file. In such implementations, an excessive amount of storage can used in connection with the metadata log file in that each MD page update can include storing an entire updated MD page in the metadata log file. Additionally, excessive amounts of node-local volatile memory of the nodes can be used in connection with node-local cached copies of portions of the metadata log file.

In at least one implementation, many read and write operations performed with respect to a MD page may only need, respectively, to read or update one field or value of the MD page. For example, a MD update to a MD page can require only updating a relatively small number of bytes, such as 4 bytes or 8 bytes, of a much larger MD page, such as a 4K byte MD page. However, as noted above, existing workflows for some implementations to perform reads and writes to the MD page can include loading the entire MD page into the cache or volatile memory of a node, if the MD page is not already in the cache or volatile memory of the node.

In this manner, existing implementations and workflows such as noted above can consume an excessive of amount of system resources, such as memory and CPU or processor execution time, resulting in performance degradation.

To improve upon the foregoing in at least one embodiment, a metadata log architecture can be used which includes a metadata log where updates to MD pages are recorded using only the changes, updates or “deltas” made to the MD pages. For example, many updates to a MD page can be an update or write of a relatively small number of bytes, such as 4 bytes or 8 bytes, of a much larger MD page, such as a 4K byte MD page.

In at least one embodiment in accordance with the techniques of the present disclosure, the metadata updates, changed content, changes or “deltas” made to MD pages (rather than complete updated MD pages) can be recorded in a metadata log as stored on a log tier of non-volatile memory. Additionally, in at least one embodiment in accordance with the techniques of the present disclosure, the metadata updates, changes or deltas made to at least some of the MD pages can also be stored in local volatile memories of the nodes of the system. The node local in-memory copy of the metadata changes, updates or deltas made to MD pages as stored on each of the nodes can also sometimes be referred to herein as the in-memory log, in-memory delta log or in-memory metadata log used by each node in connection with performing processing in accordance with the techniques of the present disclosure.

In at least one embodiment, each metadata update, change or delta made to a MD page may be expressed in the form of a tuple represented as (LI, EI, T, V) where:

LI denotes the logical index of the MD page. The LI can be a unique index of the MID page that is updated. The LI can be used to uniquely identify the MD page in the MD or mapping structure such as described elsewhere herein (e.g., FIGS. 3-5). In at least one embodiment, the LI can denote or can be the logical address, offset or location of the MD page. In at least one embodiment, the logical address, offset or location of the MD page can also be or denote the physical address, location or offset of the MD page as stored persistently on non-volatile storage, such as of the BE PDs of the data storage system.

EI denotes the entry index denoting a particular entry, offset or location in the MID page denoted by LI.

T denotes the type of metadata update. For example, in at least one embodiment there can be multiple predefined types or allowable values for T. For example, the predefined types or values for T may include one or more of: IDP denoting an update to an address or indirect pointer used to reference a data block (e.g., the indirect pointer may be point to, or be the address of, a VLB entry that further includes an address of, or pointer to, the data block containing user data); INCREF denoting an update to increment by 1a reference count of a VLB entry associated with a data block containing content that may be stored at one or more logical addresses; DECREF denoting an update to decrement by 1 a reference count of a VLB entry associated with a data block containing content that may be stored at one or more logical addresses. Generally, an embodiment can include any suitable number of predefined types that may vary with the supported metadata updates or changes.

V denotes the updated value to be stored.

It should be noted that the particular value of T denoting a particular type can also denote the size of the data payload V or updated value V of the tuple. For example, a type for T denoting an address can indicate that the size of V is the size or number of bytes or bits of an address or pointer. As another example, a type of T denoting an integer count or counter can indicate that the size of V is the size of an integer, such as 32 or 64 bits. In some instances, the value of the type T can imply performing an operation such as increment a counter by 1, or decrement a counter by 1, as noted above. In such cases and in some embodiments, the value for V of the tuple can be implied and omitted when T indicates to perform an increment or decrement operation of a field since such an increase or decrease can be with respect to a current or existing value of the counter.

In at least one embodiment, the metadata changes, updates or deltas made to MD pages as recorded in the in-memory metadata logs of the nodes can be in the form of tuples. In at least one embodiment, the metadata changes, updates or deltas made to MD pages as recorded in the metadata log stored on NVRAM can also be in the form of tuples.

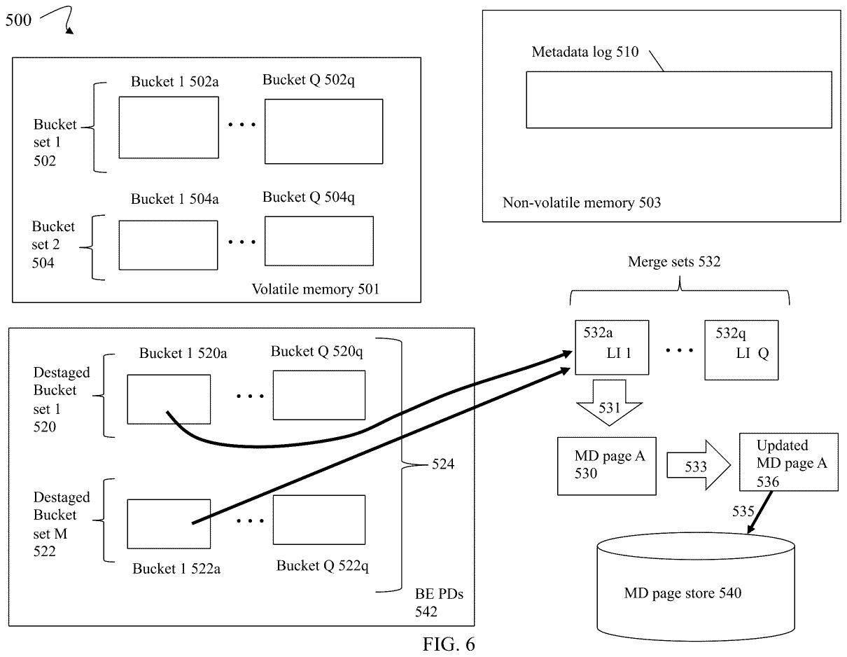

Referring to FIG. 6, shown is an example 500 illustrating structures and associated data flow in at least one embodiment in accordance with the techniques of the present disclosure.

The example 500 includes volatile memory 501, non-volatile memory 503 and non-volatile storage on the BE PDs 542. The volatile memory 501 can denote a volatile memory as included in each node of the appliance or system which includes node local in-memory structures and cached data that can be used in connection with the techniques herein. In particular, the volatile memory 501 includes bucket sets 502, 504 of logged metadata changes, updates or deltas. The non-volatile memory (e.g., NVRAM) 503 includes the metadata log 510 of metadata updates, changes or deltas. Consistent with other discussion herein, the non-volatile memory 503 can be accessible to both nodes of the system.

Collectively, the structures or bucket sets 502, 504 can denote the in-memory metadata log or in-memory delta log including the recorded metadata updates or deltas to MD pages for a particular node. Thus, each node in a dual node appliance can include an instance of the volatile memory 501 and associated structures or bucket sets 502, 504.

In at least one embodiment in accordance with the techniques herein, metadata changes, updates or “deltas” made to MID pages can be recorded and stored in a volatile memory structure in the volatile memory 501 of each node of the system. In this manner, an individual write or update to a MD page can be recorded as a single metadata update or entry in the volatile memory structure. For example, a write that updates only a 4 byte or 8 byte field of a 4K byte MD page can be recorded in the volatile memory structure as a single metadata update. Each metadata update can be represented as a tuple as discussed elsewhere herein in more detail. In at least one embodiment, each tuple can be relatively small in comparison to the size of each MD page.

The volatile memory 501 of each node can include volatile memory structures 502, 504. In at least one embodiment, the structures 502, 504 can denote two bucket sets 502, 504 where at any point in time, one of the two buckets sets 502, 504 can be designated as the active set and the remaining bucket set can be designated as the destaging, frozen, or inactive set. Each metadata update to a MD page can be added to a corresponding one of the buckets of the active bucket set that is uniquely associated with the MD page. For example at a first point in time, the bucket set 1 502 can be active and the bucket set 2 504 can be inactive, where received metadata updates are stored in the bucket set 502. As described in more detail in the following paragraphs, the roles of active and inactive or destaging can be alternated or switched between the two bucket sets 502, 504 in a continuous manner as the currently active set is deemed full or ready for destaging to the BE PDs 542.

The bucket set 1 502 includes the buckets 502a-502q, and the bucket set 2 504 includes the buckets 504a-504q, where there are “q” metadata pages. In each of the bucket sets 502, 504, each bucket can correspond uniquely to a different MD page. The metadata updates of a particular bucket are the recorded metadata updates to the MD page associated with the particular bucket of each bucket set. For example, MD page A can be uniquely associated with, and mapped to, the first buckets 502a, 504a, respectively, in each of the bucket sets 502, 504. In this manner, the bucket 1 502a includes the metadata updates made to the MID page A when the bucket set 502 is the active set; and the bucket 1 504a includes the metadata updates made to the MD page A when the bucket set 504 is the active set.

Each of the bucket sets 502, 504 in at least one embodiment can be further organized as a hash table of buckets where each MD page is mapped to a particular bucket using a hash function. The hash function can map the logical index (LI) uniquely identifying a MD page to a corresponding bucket of metadata updates for the MD page. In at least one embodiment, each of the bucket sets 502, 504 can denote a hash table of buckets implemented as an array, where the hash value HV1 of the LI of a MD page denotes the index of the array and the bucket associated with the MD page. Within each bucket associated with a MD page, the metadata updates can be sorted in a time order, from oldest to newest, based on when the metadata updates are received in the system. In at least one embodiment, each bucket (e.g., 502a) of metadata updates for a MD page can be organized in a binary tree. The metadata updates can be represented as nodes or entries in the binary tree. The metadata updates or nodes of the binary tree can be sorted, at least in part, based on the time order of when the metadata updates are received by the system. The increasing time order can indicate the order in which the metadata updates or changes are applied to the MD page associated with the bucket or binary tree.

More generally, an embodiment in accordance with the techniques herein can use any suitable volatile memory structure(s) and organization to store the metadata updates, changes or deltas to the MD pages.

In at least one embodiment, when a new metadata update U1 is made to a MD page, the metadata update U1 can be represented as a tuple. The metadata update U1 can be inserted into the active bucket set as follows. The hash function H is used to calculate a hash value HV of the LI of the MD page (e.g., H(LI)=HV). The HV can denote the bucket uniquely associated with the MD page being updated. For example, assume the bucket set 502 is the active set and assume that the MD page A is being updated with the new metadata update U1. The MD page A can have an LI that generates a hash value=1 mapping to the first bucket, bucket 1 502a, of the bucket set 502. The bucket 502a can be a binary tree including metadata updates to the MD page A. The metadata update U1 can be inserted into the sorted binary tree of 502a based, at least in part, on when the metadata change U1 was received.

Consistent with other discussion herein, the volatile memory 501 can include 2 sets of buckets 502, 504. At a first point in time T1, a first set of buckets, such as 502, can be designated as the active set and the second set of buckets 504 can be designated as the inactive set of buckets. Consistent with other discussion herein, each bucket in a set includes the metadata updates or changes for a particular one of the MD pages associated with the bucket. Thus, metadata changes received for a particular MD page are located in the bucket associated with the MD page. The role assignments of active and inactive can be continuously switched between the two bucket sets 502, 504 of a node at subsequent points in time as the currently designated active set becomes full. In at least one embodiment, the role assignment switching between the two sets of buckets can be performed when at least one bucket in the active set becomes full, or more generally reaches a predefined maximum size limit. In some implementations, each data container can have a predefined data limit before the data container is considered “full”. For example, metadata updates to a MD page associated with each bucket can be written to the BE PDs of the system as a separate page (e.g., 4 KB). In this example, the page size can determine the predefined data limit of a bucket. In other words, once a bucket includes a page-worth of metadata changes, processing can determine that the data container is “full”.

To further illustrate, at a second point in time T2 subsequent to T1, the first set of buckets 502 currently designated as the active set becomes full and, in response, the second set of buckets 504 can be assigned as the active set and the first set 502 can be assigned as the inactive set. At the second point in time, metadata updates can be destaged from the inactive first set of buckets 502 in volatile memory to the BE PDs 542 such as, for example, in the first phase of destaging as mentioned elsewhere herein. New metadata updates received subsequent to T2 while the bucket set 502 is inactive or destaged are stored in the set of buckets 504 designated as the currently active set of buckets. At a third point in time T3 subsequent to T2, the second set of buckets 504 currently designated as the active set becomes full, and in response, the first set of buckets 502 can be assigned as the active set and the second set 504 assigned as the inactive set. Metadata updates can now be destaged from the second set 504 designated as the inactive set while subsequent metadata updates are now stored in the first set 502 designated as the active set. The foregoing switching of roles of active and inactive between the two sets of buckets 502, 504 can be repeatedly performed in an ongoing manner where new metadata updates are stored in the currently designated active set and where metadata updates of the other currently designated inactive set are destaged from the volatile memory 501 to the BE PDs 542.

In at least one embodiment in accordance with the techniques herein, one or more sets of the metadata updates for the MD pages can be destaged in a first phase of MD log destaging from the volatile memory 501 to the BE PDs 542 providing non-volatile backend storage. As mentioned above, metadata updates can be destaged in the first phase of destaging from the particular one of the bucket sets 502, 504 designated as the inactive set. Over time, multiple bucket sets 524 can be destaged from the volatile memory 501 (e.g., of each of the nodes) to the BE PDs 542 in the first phase of destaging. The destaged bucket sets 524 in this example include M destaged bucket sets indicating that M sets of Q buckets have been destaged from the volatile memory 501 (e.g., as included in each of the nodes) to the BE PDs 542, where the M destaged bucket sets 524 are awaiting further processing in the subsequent second phase of destaging.

The destaged bucket sets 524 of metadata updates for the MD pages can be stored and organized on the BE PDs in any suitable structures and organization. For example, each destaged bucket set of metadata updates for MD pages can be organized into buckets of bucket pages, where each bucket can correspond or map uniquely to a single MD page. For example, the bucket 1 520a of the destaged bucket set 1 520 can include metadata updates for the MD page A as noted above. The bucket (e.g., 520a) of one or more bucket pages associated with a single MD page (e.g., MD page A) can include one or more metadata changes made to the MD page, where the metadata changes can be represented as tuples in the volatile memory structure (e.g., bucket sets 502, 504) of the volatile memory 501. The metadata changes in each bucket, such as 520a, of 524 can be sorted based on insertion time and therefore denote the sorted increasing time order in which the metadata changes are applied to the MD page. In at least one embodiment, the bucket pages of each bucket of 524 can be organized as a list rather than, for example, a binary tree structure as described above in connection with the organization of metadata updates in the volatile memory 501. In at least one embodiment as denoted by the element 524, there can be multiple sets of metadata updates for MD pages stored on the BE PDs 542, where each of the multiple destaged bucket sets of 524 can denote a set of metadata updates destaged from the buckets sets 502, 504 of volatile memory at a different point in time.

In a second phase of destaging, metadata changes, updates or “deltas” from the multiple destaged bucket sets 524 made to the same single MD page can be aggregated and combined into a working set (sometimes referred to as a data container working set) of metadata updates for the MD page. The second phase of destaging can aggregate and combine the metadata updates for each MD page across the multiple destaged sets (520, 522) of metadata updates as stored on the BE PDs in the first phase of destaging. Thus a working set or merge set of metadata updates for a single MD page can denote aggregated metadata updates to the MD page, where the metadata updates can be located in the multiple destaged sets of updates 524 stored on the BE PDs 542. An existing or current version of the MD page can be read from the BE PDs. The working set of metadata changes for the MD page can be applied to, or combined with, the current MD page to thereby result in an updated version of the MD page. The updated MD page can then be persistently stored on the BE PDs replacing the prior current or existing version of the MD page.

To further illustrate, consider the MD page A 530 having an associated LI=1 that maps to the first bucket (e.g., 520a, 522a) in each of the M destaged bucket sets of 524. The second phase of destaging can aggregate and combine the metadata updates for the MD page A 530 from the first buckets (e.g., 520a, 522a) across the multiple M destaged sets 524 of metadata updates as stored on the BE PDs 542 in the first phase of destaging. The element 532a can denote the merge set of aggregated updates from the first buckets 520a, 522a of the destaged sets 524 for the MD page A 530. Thus the merge set or working set 532a of metadata updates for the MD page 530 can denote aggregated metadata updates to the MD page, where the metadata updates can be located in the multiple destaged sets 524 of updates stored on the BE PDs. An existing or current version 530 of the MD page can be read from the BE PDs. The merge set or working set 532a of metadata changes for the MD page A can be applied to (531) the current MD page A 530 to thereby generate (533) an updated version of the MD page A 536. The updated MD page 536 can then be persistently stored (535) on the MID page store 540 of the BE PDs replacing the prior current or existing version of the MD page 530.

Generally, the element 532 denotes the merge sets of aggregated metadata updates for all the MD pages. In this example, there are Q MD pages, where each of the Q MD pages can be uniquely associated with a corresponding one of the merge sets 532a-q based on the LI of each of the Q MD pages.

In at least one embodiment in accordance with the techniques herein, the metadata changes, updates or deltas can be recorded in the metadata log 510 The metadata log 510 can be stored in the non-volatile memory 503, such as non-volatile Random Access Memory (NVRAM). In some implementations, the metadata log 510 can store metadata updates in time order (e.g., sorted oldest to newest). In some implementations, the metadata log 510 can be used to recover and reconstruct in-memory structures, such as structures of the volatile memories of the nodes of the data storage system. The metadata log 510 can be used to perform such recovery or reconstruction of the in-memory structures, for example, in response to a failure of the volatile memory of a node, or in response to a restart or reboot of a node or data storage system.

In some implementations and in response to destaging or writing the one or more metadata changes from the volatile memory 501 to the BE PDs 542 in the first phase of destaging, processing can be performed to release or free the corresponding part of the metadata log storing the destaged metadata changes. In at least one embodiment, the persisted metadata log 510 can be implemented as a ring buffer. Ring buffers are generally known in the art. A ring buffer can be represented as a logical ring of records or entries. The ring buffer can be maintained using pointers, such as a head pointer and a tail pointer, where new entries of the ring can always be allocated from the head and space reclamation can always be done from the tail. When an entry at the tail is flushed or destaged, the entry can be freed and thus reclaimed for reuse. The tail can be advanced as entries are flushed. In a similar manner, as entries are allocated, the head pointer is advanced. In at least one embodiment, entries from the metadata log 510 can be reclaimed as corresponding entries denoting the same metadata changes or deltas are destaged in the first phase of destaging from the in-memory metadata logs of the nodes (e.g., volatile memories 501 of the nodes) to the BE PDs 542. In such an embodiment, the destaging of metadata updates or changes as recorded in the in-memory metadata logs of the nodes can be synchronized with reclaiming corresponding entries from the persisted metadata log 510.

In at least one embodiment, when a single bucket set from volatile memory is destaged, corresponding entries from the persisted metadata log 510 stored in NVM 503 can also be reclaimed. In at least one embodiment, the destaging of an in-memory metadata log structure (e.g., such as a single bucket set 502) and reclaiming corresponding entries from the persisted metadata log 510 stored in NVM can be done atomically. In at least one embodiment, the metadata log 510 stored on the NVM can be a ring buffer as noted above where new metadata log 510 entries are added to the head and removed from the tail. In such an embodiment, the corresponding entries of the metadata log 510 can be reclaimed by moving the tail of the ring buffer to free the corresponding entries of the ring buffer. In such an embodiment, synchronization between the in-memory metadata logs of the nodes and the persisted metadata log 510 can be maintained so that flushing or destaging an in-memory metadata log in the first phase and reclaiming corresponding entries in the persisted metadata log 510 are done atomically. In particular in at least one embodiment, reinitializing or resetting the in-memory metadata log which has been destaged (e.g., in the first phase) can be performed atomically with movement of the tail of the metadata log 510 to reclaim corresponding entries for the destaged entries of the in-memory metadata log. It should be noted that in embodiments where a single entry of the persisted metadata log can be referenced across multiple bucket sets, the entry of the persisted metadata log cannot be reclaimed until all such references across the multiple bucket sets have been destaged or flushed in the first phase from volatile memory to the BE PDs 542.

It should be noted that destaging the in-memory metadata log can generally be performed in a single phase or other suitable manner. For example, destaging the metadata log can be performed by processing and merging bucket sets without intermediate storage on the BE PDs. Rather, destaging the metadata log can include determining the merge sets using destaged bucket sets and merge sets stored in volatile memory.

Consistent with other discussion herein in at least one embodiment, updates or modifications can be with respect to user data or stored content modified by client or host write I/Os as well as with respect to metadata, such as updates or modifications to the MD structure or mapping information described above. As noted above in at least one embodiment to increase performance, the updates to user data can be stored (e.g., persisted temporarily) in a log or journal logging client or host writes, and the updates to the MID or mapping information can be stored (e.g., persisted temporarily) in a metadata log. One characteristic of a log structured system, such as in connection with the metadata log and log of client updates or writes, is that updates or modifications (which are recorded in an associated log and then flushed to long term storage of the BE PDs) may not physically overwrite or update the same BE PD physical location storing the old data or existing content (e.g., no physical in place update). Rather, the newly written or updated data is typically written to a different physical location on the BE PDs. Thus, the BE PDs can retain the valid old data in the original physical location for some time before being reclaimed for reuse by garbage collection processing.

Garbage collection (GC) can be performed in connection with storage management of the BE PDs to reclaim and reuse free or invalidated physical storage as new data is written. In some cases, “holes” of storage storing old, unused or invalid content can be interspersed among portions of storage storing current valid content. Garbage collection can include performing processing which allows multiple holes of storage including unused or invalid data to be compacted into a single larger contiguous storage portion which can then be reused. Thus garbage collection processing can include moving first storage portions of valid data or content interspersed among holes of invalid content from a source to a target location to thereby make free or available a larger contiguous storage portion including the holes of invalid content.

Consistent with other discussion herein, an entry from the log of user or client updates (sometimes referred to as the UD (user data) log) can be an update to a logical address (e.g., LUN and LBA) which writes content to a UD page. Flushing the entry can include destaging the updated UD page to a backend storage location on non-volatile storage (e.g., BE PD location). Additionally, flushing and destaging the entry from the UD log can include updating the corresponding MD pages which map the logical address to its corresponding BE PD location including the content stored at the logical address. In at least one existing system, the mapping information including MD pages as described herein can thus be updated. For example, such updating of the mapping information can include updating MD of any of the top, mid, leaf, and VLB metadata pages used in connection with mapping the logical address to the BE PD location including the content stored at the logical address. In at least one existing implementation, updating the corresponding mapping information and MD pages can include loading all the MID pages into the cache if any such MD pages are not already in cache. The MD pages of the mapping information can be characterized as a chain forming an access sequence of top MD page, mid MD page, leaf MD page and VLB page, where each MD page in the sequence can be accessed serially and also in the strict consecutive order of the sequence since a first page of the sequence can reference a next consecutive page, or location thereof, in the sequence.

Consistent with other discussion herein, data storage systems have components whose responsibility is to map the user-visible logical address space to the internal physical address space, and implement various features such as, for example, snapshots, data compression, data deduplication, and the like. Such mapping and features may rely on different types of metadata to be implemented. This metadata can be typically stored persistently as, for example, 4K blocks of physical storage where different MD pages can reference each other by their physical block-addresses. In at least one embodiment, each MD page when allocated can be assigned a unique physical storage address, offset or location on non-volatile storage where the MD page is persisted. In a model or system using physical addresses or locations without corresponding logical addresses, there is generally no flexibility to move a MD page from an existing physical location to a new physical location since all MD pages referencing the to-be-moved MD page would have to be found and their references would need to be updated to reference the new physical location. Put another way, in at least one system not using the techniques of the present disclosure, the chain or MD pages of mapping information can include pages of metadata that reference other pages of metadata by their physical storage locations or addresses. As a result, metadata can be typically implemented as an in-place over-write system. In such a system, MD pages can remain in the same physical locations where updates to the MD pages are performed in-place and overwrite the same existing physical location. In such a system where MD pages can reference each other by their corresponding physical storage locations or addresses, if an updated version to a MD page is rewritten to a new physical location, all references to the MD page by other MD pages would also have to undesirably be updated to refer to the new physical location. Thus, the MD pages can be persistently stored at fixed physical addresses such as on non-volatile BE PDs of the storage system. The BE PDs used to store the metadata using overwrites or in-place updates can be configured as RAID-level storage of one or more RAID groups. For performance reasons, metadata may have to be stored in a mirrored RAID configuration, such as a RAID-1 configuration, which has a small write performance cost for such in-place updates in comparison to an alternative parity-based RAID configuration such as RAID-5 or RAID-6. However, although the mirrored RAID configuration for the metadata may have less write performance costs as compared to parity-based RAID configurations, the mirrored RAID configuration can generally result in excessive use of storage capacity in comparison to the RAID parity-based configurations. Additionally, because of MD pages referencing each other by physical addresses or physical storage locations, defragmentation and reclaiming of capacity allocated to metadata may become an intractable problem. Furthermore, in systems where the BE PDs or storage tier used to store the metadata are SSDs (solid state drives) such as flash-based storage, continually updating by overwriting to the same SSDs can result in exceeding a maximum number of allowed daily writes (writes per day or WPD) thereby leading to SSD wear out. The SSDs such as flash-based storage can be optimized for use in LSSs where writes to a logical storage object, such as a MD page, are written to a new physical location each time the MD page is updated. Thus, in systems where the MD pages are persistently stored on non-volatile SSDs as the BE PDs, the SSDs can implement an internal LSS where it can be further advantageous to implement a LSS of the metadata at the system level to further facilitate minimizing write amplification and reducing SSD wear.

Based on the foregoing, there exists motivation to implement the persistent metadata storage, such as on one or more storage tiers of the BE PDs, as a LSS which does not perform in place metadata updates and does not update an existing MD page stored at a physical address or location by overwriting current content of the physical storage address or location of the MD page with the new or updated content. Rather, in a LSS, updates to the metadata can be performed by writing the updated version of a MD page to a new physical location each time the MD page is updated.

However, use of a LSS metadata system where each updated version of a MD page is written to a new physical location creates new challenges. Since the MD pages can reference one another, it can be impractical and undesirable to have the MID pages reference each other by their physical storage locations since, for example, storing an updated version of a first MD page to a new physical location would require updating all other referencing MD pages to now refer to the new physical location. As a result, MD pages can reference each other using logical addresses which can then be mapped by an intervening layer or mechanism to corresponding physical addresses or physical locations. In at least one embodiment, the logical addresses of the MID pages, including top, mid, leaf and VLB metadata pages, can be indirect pointers or addresses that indirectly reference the physical storage addresses and locations of the MD pages through the intervening layer or mechanism. The intervening layer or mechanism can maintain a new type of mapping that, for MD pages, translates a logical address of a MD page to its current corresponding physical address or location. In this manner, a first MD page can reference a second MD page, or entry thereof, using a logical address of the second MD page. The new type of mapping can use a translation table, sometimes generally referred to herein as a TT, to map the logical address of the second MD page to its corresponding current physical location. When the second MD page is updated so that the updated version is stored at a new physical location, the TT can be updated to reference the new physical location of the second MD page and where the first MD page can continue to reference the second MD page using the logical address that is mapped, by the TT, to the new physical location. In at least one embodiment, each MD page can be assigned a logical address included in the TT where the logical addresses of the MD pages can remain fixed or the same for the lifetime of the MD pages, and where the physical storage locations or addresses of persistently stored copies of the MD paged can change over time as updated versions of the MD pages can be continually rewritten to new physical storage locations or addresses. The TT can translate a logical address, offset or location (LPA) of a MD page to its corresponding physical address, offset or location (PPA).

In at least one embodiment, as updated MD pages are stored in new physical addresses or storage locations over time, corresponding TT updates can be made to the TT to reflect the current physical address or storage location of MD pages at various points in time. In at least one embodiment, TT updates to the TT can also be managed and handled in accordance with a LSS where the TT itself can be characterized generally as another type of metadata.

In at least one embodiment, pages of metadata can be persistently stored in storage units denoted as PLBs (physical large blocks) in a metadata (MD) tier of non-volatile storage. Each PLB of metadata can have a corresponding PLB descriptor that generally describes content or data stored in the corresponding PLB. As a metadata page is updated and stored in a new physical address or storage location of a target PLB in accordance with a LSS, the target PLB's corresponding descriptors can also be updated to reflect the metadata page now stored in the target PLB. In at least one embodiment, such updates to a descriptor of the target PLB of metadata can also be managed and handled in accordance with an LSS.

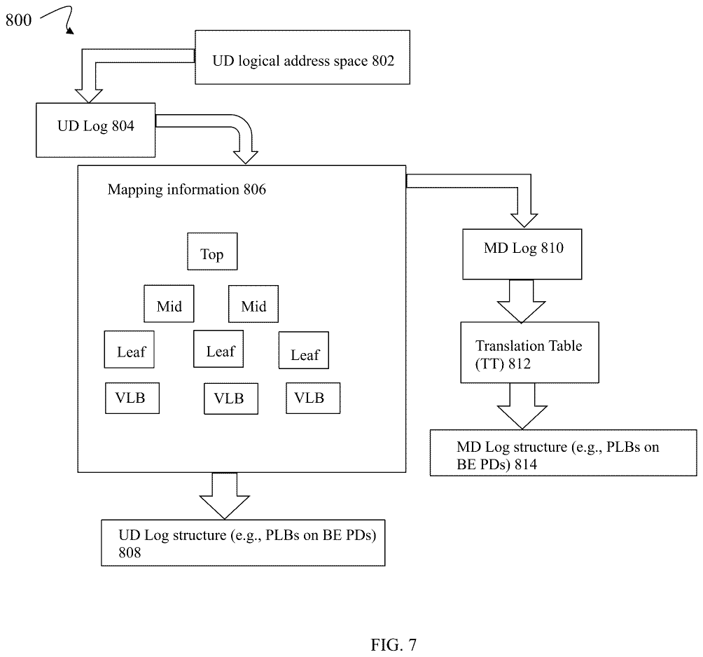

Referring to FIG. 7, shown is an example 800 illustrating components of a log structured MD architecture in at least one embodiment in accordance with the techniques of the present disclosure.

The example 800 provides a component level view of functionality regarding log structured mapping metadata can be include components in at least one embodiment in accordance with the techniques of the present disclosure. The example 800 includes UD logical address space 802, UD log 804, mapping information 806, UD log structure 808, MD log 810, translation table (TT) 812, and MD log structure 814. The UD log structure 808 can denote BE non-volatile storage, such as on BE PDs of the storage system, that persistently stores UD or content, for example, written by write operations. In at least one embodiment, the logs 804 and 810 can be persistently stored on a form of non-volatile storage such as on BE PDs. In at least one embodiment, the UD log structure 808 and the MD log structure 814 can have corresponding log structures as described elsewhere herein (e.g., such as in connection with FIGS. 2B-2C). In at least one embodiment consistent with other discussion herein, content persisted to each of the log structures 808, 814 can be written to consecutive sequential storage locations in an ongoing manner. In at least one embodiment, storage of 814 can be included a physical storage portion or tier sometimes referred to herein as the MD tier. In prior descriptions such as in connection with FIG. 6, the MD page store 540 can correspond to the MD tier.

As an example, assume a write W1 writes content C1 to a target logical address LA1 included in the UD logical address space 802. Consistent with other discussion herein in at least one embodiment, the write W1 can be recorded persistently in the UD log 804. At a later point in time, the recorded write W1 can be flushed from the UD log 804, where such flushing can include creating and/or updating one or more corresponding MD pages of the mapping information 806 used to map LA1 to a physical storage location PAI included in a new physical storage location of a physical large block (PLB) of storage of the UD log structure 808. Updates made to a page of MD (e.g., MD top, mid, or leaf, or a VLB page) included in the mapping information 806 can be stored persistently in entries of the MD log 810. Consistent with discussion herein, such metadata updates stored in the MD log 810 can be made, for example, in connection with flushing the recorded write W1 from the UD log 804. Recorded metadata updates of the MD log 810 can also be flushed or destaged. As a result of the metadata updates to a page of MD M1 that are flushed from the MD log 810, an updated version of the metadata page M1 can be generated and stored at a new physical storage location PA2 on a PLB of the MD log structure 814. Additionally, corresponding information of the TT 812 can be updated to now map a logical address of MI to its new storage location PA2.

As another example, assume a subsequent read R1 requests to read content C1 from the UD logical address LA1 (e.g., where LA1 can be included in the UD logical address space 802). In at least one embodiment, the existing mapping information 806 used to map LA1 to PA2 where C1 is stored can be used to service R1. Logical addresses of pages of metadata (including top, mid, leaf and VLB metadata pages of the mapping information 806) can be used and referenced. For example, a MD top page can reference MD mid pages using their corresponding logical addresses; a MD leaf page can reference addresses of VLB pages using their corresponding logical addresses; and the like. Put another way, pages of metadata of mapping information 806 can reference other pages of metadata in accordance with their logical addresses. The TT 812 can operate to translate a logical address of a MD page, such as the logical address L1 of MD page M1, to a corresponding physical address or location of the MD page, such as physical address PA1 of MD page M1, in the MD log structure 814.

In at least one embodiment, metadata pages can also be stored in volatile in-memory cache for faster access where the metadata page M1, if stored in the cache, can be accessed from the cache using MI's logical address L1. If M1 is not in cache when requested for reading such as when processing the read R1, a read cache miss results. Read cache miss processing in this example can include reading the MD page M1 from persistent storage, such as from its current physical storage location PA2 in the MD log structure 814. To access a physical storage location of a metadata page in the MD log structure 814, the TT 812 can be used. In this manner in at least one embodiment read cache miss processing with respect to a metadata page that is not in cache, such as a volatile cache, can use the TT 812 to map the logical address L1 of the MD page MI to its corresponding storage location PA2 in the MD log structure 814.

The element 812 can generally denote use of one or more TTs. In at least one embodiment as discussed in more detail elsewhere herein, two TTs can be represented by the element 812 including: a first TT, MD TT, used for mapping or translating top, mid, and leaf MD pages; and a second TT, VLB TT, used for mapping or translating VLB pages. Thus although examples herein for illustration purposes can include the foregoing two TTs, an embodiment can alternatively use a single TT, or more generally, any suitable number of TTs including the same information.

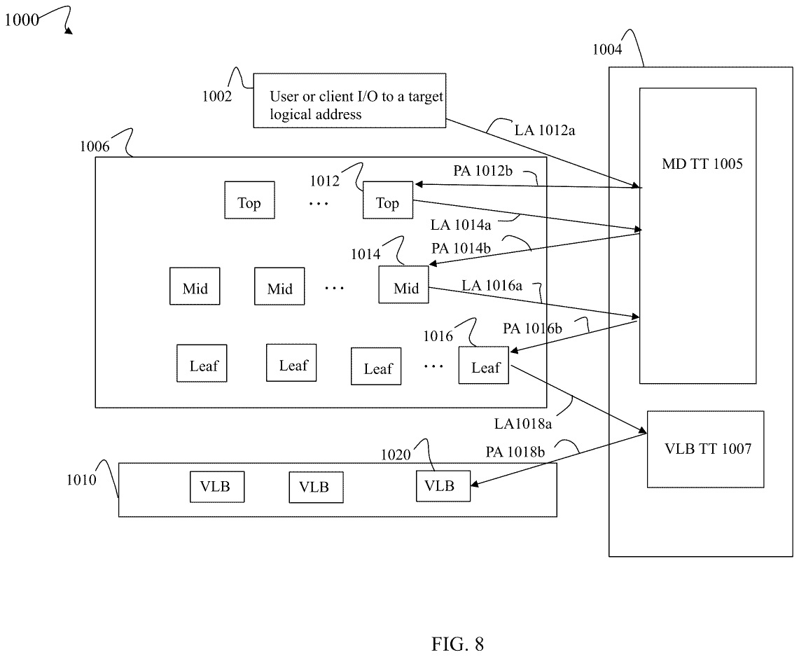

Referring to FIG. 8, shown is an example 1000 illustrating further use of TTs in at least one embodiment in accordance with the techniques of the present disclosure.

In at least one embodiment, the elements 1004, 1006 and 1010 can denote different portions of non-volatile storage. The portion 1004 can persistently store the MD TT 1005 and the VLB TT 1007. The portion 1006 can persistently store top, mid and leaf MD pages. The portion 1010 can persistently store VLB pages. Element 1002 can denote a user or client I/O that includes a target logical address UD1 of the UD logical address space 802.

In at least one embodiment, TTs 1005, 1007 can include entries each mapping a logical address LA of a page of metadata to a corresponding physical address PA. To map an LA of a MD page to the corresponding PA where the MD page is persistently stored in the MD tier, processing can read the PA from a TT entry or element with the index LA, which can be represented as PA=TT [LA]. In at least one embodiment, the TTs 1005, 1007 can be structures maintained as set of MD pages of a new MD page type, such as a new type “TT”.

In the example 1000, the element 1006 represents the non-volatile physical storage of the log structured system for persistently storing top, mid and leaf MD pages. The element 1010 represents a portion of the non-volatile storage used for persistently storing the VLB pages also considered metadata in at least one embodiment. The elements 1006 and 1010 can correspond to portions of the MD log structure 814 of example 800 and the MD page store 540 of FIG. 6 in at least one embodiment. Generally, the storage of 1004, 1006 and 1010 can be non-volatile storage, for example, of the MD tier that can include BE PDs of the storage system. The storage 1006 can be configured for storing a MD page to a new physical storage location each time the MD page is updated. The storage 1010 can be configured for storing a VLB page to a new physical storage location each time the VLB page is updated.

In at least one embodiment, the TTs 1005, 1007 can be accessed through cache (e.g., volatile memory) like other metadata pages. Consistent with discussion elsewhere herein in at least one embodiment, using the mapping information 806 of MD pages to map a user data or client target logical address to its corresponding physical location storing the content of the target logical address can require the mapping information of MID pages to be in cache. The mapping information can be characterized as forming a chain of MD pages including a top MD page, a mid MD page, a leaf MD page and a VLB page. A cached copy of a metadata page of the chain can be accessed in the cache based on its corresponding LA. If one of the MD pages of the mapping information is not stored in cache such as when servicing a read that reads the content from the target logical address, a cache miss results thereby triggering processing that loads the MD page from its current physical location on the non-volatile storage of 1006, 1010 into the cache for use in servicing the read. The TTs 1005, 1007 can be used to map a logical address or LA of a metadata page to its corresponding physical address or persistent storage location PA in connection with a cache miss of the MD page. The TTs 1005, 1007 can be cached in order to be used in connection with the foregoing mapping of LAs to corresponding PAs for metadata pages (e.g., top, mid, leaf and VLB pages) of the chain of mapping information.

For example, consider a read I/O 1002 to read data from a UD target logical address UD1. For the UD target logical address UD1, the logical address LA 1012a of the MD top page 1012 can be determined. If the MID top page 1012 is not in cache, cache miss processing can be performed where 1) the LA 1012a is then mapped by the MD TT 1005 to its corresponding physical address PA 1012b identifying the physical address or storage location of the MD top page 1012 in 1006; and then 2) the MD top page 1012 is loaded from its PA in 1006 into the cache and used to obtain the logical address LA 1014a of the next MD page, the mid MD page 1014, in the chain. Otherwise, if the MD top page 1012 is already in cache, the cached copy thereof can be used to obtain the LA 1014a of the next page, the mid MD page 1014, in the chain.

Processing can determine whether or not the mid MD page 1014 is in cache. If the mid MD page 1014 is not in cache, cache miss processing can be performed where 1) the LA 1014a is then mapped by the MD 1005 to its corresponding physical address PA 1014b identifying the physical address or storage location of the MD mid page 1014 in 1006; and then 2) the MD mid page 1014 is loaded from its PA in 1006 into the cache and used to obtain the LA 1016a of the next MD page, the MF leaf page 1016, in the chain. Otherwise if the MD mid page 1014 is already in cache, the cached copy thereof can be used to obtain the logical address LA 1016a of the MD leaf page 1016.

Processing can determine whether or not the MD leaf page 1016 is in cache. If the MD leaf page 1016 is not cache, cache miss processing can be performed where 1) the LA 1016a is then mapped by the MD TT 1005 to its corresponding physical address PA 1016b identifying the physical address or storage location of the MD leaf page 1016 in 1006; and then 2) the MD leaf page 1016 is loaded from its PA 1016b in 1006 into the cache and used to obtain the logical address LA 1018a to the VLB 1020 in the chain.

Processing can determine whether or not the VLB page 1020 is in cache. If the VLB page 1020 is not in cache, cache miss processing can be performed where 1) the LA 1018a is mapped by the VLB TT 1007 to its corresponding physical address PA 1018b identifying the physical address or storage location of the VLB page 1020; and then 2) the VLB page 1020 is loaded from its PA 1018b into cache and used to obtain the physical storage location where the requested content C1 for the target logical address UD1 is stored.

In connection with the foregoing, if a MD page of the mapping information chain is in the cache, the associated cache miss processing and thus associated TT mapping can be omitted. When a MD page, such as a top, mid or leaf MD page, is updated, the updated version of the page can be written to a new physical location, new PA, in the storage 1006. Additionally, when the MD page is updated and written to a new physical address PA, corresponding mapping information in the MD TT 1005 is also updated. In particular, the entry of the MD TT 1005 for the MD page is updated to now reference the new PA (e.g., MD TT 1005 is updated to map the MD page's fixed logical address to the new PA). When a VLB is updated, the updated version of the page can be written to a new physical location, new PA, in the storage 1010. Additionally, when the VLB page is updated and written to a new PA, corresponding mapping information in the VLB TT 1007 is also updated. In particular, the entry of the VLB TT 1007 for the VLB page is updated to now reference the new PA (e.g., the VLB TT 1007 is updated to map the VLB page's fixed logical address to the new PA).

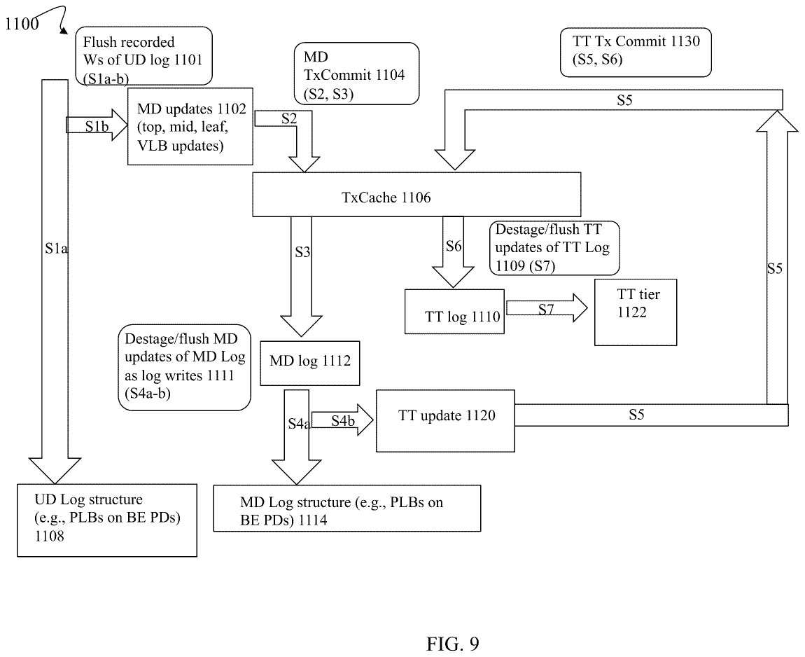

Referring to FIG. 9, shown is an example 1100 illustrating various processing or workflows in at least one embodiment in accordance with the techniques of the present disclosure.

The example 1100 includes a flush workflow or processing 1101 when flushing writes Ws as recorded in the UD log. Consistent with other discussion herein, flushing a recorded write W1 from the UD log (e.g., element 804 of the example 800), where W1 writes content C1 to UD logical address UD1, can include flows S1a-b. S1a can denote storing the written content C1 at a physical address of location PA1 in the UD log structure 1108 in a PLB of storage on the MD tier (e.g., stored on BE PDs). S1b can denote creating and/or updating one or more metadata pages of mapping information used to map UD1 to PA1, where PA1 currently includes the content C1 stored at UD1. Thus, S1b can include performing MD updates 1102 denoting top, mid, mid, leaf and/or VLB page updates. The MD updates 1102 (resulting from flushing the recorded write W1 from the UD log) can be included in a MD Tx (transaction) commit operation, workflow or processing 1104 where the MD updates 1102 to one or more pages are committed in the flow S2 to the Tx Cache 1106 and committed in the flow S3 to the MD log 1112. In at least one embodiment, the Tx Cache 1106 can denote a volatile memory cache. In at least one embodiment, the Tx Cache 1106 can include an in-memory or volatile memory copy of the MD log 1112, where the MD log 1112 can denote the persisted copy of the MD log stored on non-volatile storage.

In a manner similar to flushing entries of the UD log, recorded MD updates included in entries of the MD log 1112 (and also the in-memory copy in Tx Cache 1106) can be destaged or flushed as represented by element 1111. Destaging or flushing MD updates of the MD log as log writes 1111 can result in performing processing denoted by the flows S4a-b. S4a can denote applying one or more MD updates to a MD page to generate an updated version of the MD page, where the updated version of the MD page can be stored persistently at a new physical storage location of the MD log structure 1114. S4b can denote a TT update 1120 that needs to be made to a TT, where the TT update 1120 is in accordance with the new physical storage location. In particular in at least one embodiment, the TT update 1120 can include updating the TT to map the existing logical address of the updated MD page to the new physical storage location. In at least one embodiment, there can be a corresponding unique entry in the TT for each top, mid, leaf and VLB page of metadata such that each MD page updated results in updating the MD page's corresponding mapping entry of the TT with the MD page's new physical storage location or address.

One or more TT updates 1120 can be included in a TT Tx Commit operation, workflow or processing 1130, where the TT updates are committed in the flow S5 to the in-memory copy of the TT log as can be stored in the Tx Cache 1106, and committed in the flow S6 to the TT log 1110. In at least one embodiment, the Tx Cache 1106 can include an in-memory or volatile memory copy of the TT log 1110, where the TT log 1110 can denote the persisted copy of the TT log stored on non-volatile storage. The element 1109 can denote the workflow, processing or operation of destaging or flushing (in the flow S7) the TT updates from the TT log to a TT tier 1122. The TT tier can denote non-volatile storage storing persisted copies of the two most recent versions of the TT. In at least one embodiment, one or more TT updates can be applied to a current version of the TT to generate an updated version of the TT. The updated version of the TT can be a complete instance of the TT that is persisted to the TT tier. In at least one embodiment, the two most recent versions of the TT can be stored in the TT tier such that each time a new complete instance of the TT is destaged, it can replace the older of the two persisted TT instances of the TT tier 1122.

In at least one embodiment, the TT tier 1122 can also be log-based or have an associated log structure in that generally the multiple TT instances stored in the TT tier 1122 can be written sequentially. In particular, each TT instance can be written sequentially to the TT tier 1122. Additionally in at least one embodiment, the multiple TT instances stored in the TT tier 1122 can be logically sequential with respect to one another in accordance other discussion herein (e.g., such as in connection with FIGS. 2A-D). Furthermore, each time a new or updated version of a TT is written to the TT tier in accordance with the LSS, the new or updated version can be written to a new storage location that is different from an existing storage location or address storing the TT version prior to updating.

In at least one embodiment, multiple changes to the TT can be accumulated in the TT log. Subsequently, the multiple changes or updates to the TT can then be applied to a current or most recent version of the TT as stored in the TT tier to generate an updated version of the TT. The updated version of the entire TT can then be written out to the TT tier, such as replacing the older or oldest persisted version of the TT stored on the TT tier. Thus in at least one embodiment, the TT tier can generally persistently store multiple complete instances of the TT where such persisted instances can denote logically consecutive versions of the TT. In at least one embodiment as discussed in more detail herein, the most recent two versions of the TT can be persisted to the TT tier. However more generally any suitable number of complete copies of versions of the TT can be stored in the TT tier. In at least one embodiment, the updated version of the TT can be written sequentially and stored to a new location in the TT tier, thereby replacing the oldest persistent TT version of the TT tier.

In at least one embodiment, each instance of the TT can be relatively small in size which is the reason why the entire TT can be written out each time there is a set of updates or changes applied to the TT without adversely impacting performance of the system.

In at least one embodiment, the most current version of the entire TT can be stored in volatile memory such as in cache. The most current version of the TT can include the most recent persisted version of the TT stored in the TT tier with all TT updates of the TT log applied. In the event of a system failure or other event such as a reboot causing loss of the in-memory or cached copy of the most current version of the TT, the most current version of the TT can be restored as a result of reapplying the TT updates of the persisted TT log 1110 to the most recent persisted version of the TT stored in the TT tier 1122.

As described elsewhere herein, for example, such as in connection with FIGS. 3, 4, and 5, a first MD page, such as a MD MID page, can include multiple entries where each such entry can include a pointer, address, reference, offset, or index to a MD leaf page. In at least one implementation not in accordance with the techniques of the present disclosure, the foregoing pointer or address of a MD MID page entry can directly reference the MD leaf page, where the pointer or address can be the physical address or location of the MD leaf page as stored on BE non-volatile storage. Thus, if the referenced MD leaf page is stored in a new physical location, the entry of the MD MID page must be updated also to include the new physical location or address.

In contrast to the foregoing in at least one embodiment in accordance with the techniques of the present disclosure, the entry of the MD MID page can generally include a logical address LA of a MD leaf page that is mapped or translated by the MD TT 1204 to the physical storage location or address PA of the MD leaf page as stored in a PLB of the MD log structure of the MD tier. More generally in at least one embodiment in accordance with the techniques of the present disclosure, MD page entries can reference other MD and VLB pages by their logical addresses rather than physical addresses. For example, a MD MID page entry can reference a MD leaf page using the MD leaf page's logical address that can then be mapped or translated, such as using a MD TT, to the physical address of the MD leaf page.

When updates to a MD page are flushed from the MD log, such updates can be applied to a current version V1 of the MD page as persistently stored in the MD log structure to generate an updated version V2 of the MD page. In accordance with an LSS, the updated version V2 of the MD page can then be persistently stored as the most recent copy of the MD page of the MD log structure, where the updated version V2 of the MD page can be stored at a new physical storage location or address that is different from the existing physical storage location or address of V1 of the MID page. Thus, as a MD page is updated and then persistently stored as part of flushing or destaging the MID log, the physical storage location or address of the MD page will change and the changed physical storage location or address can be noted in the appropriate TT, such as the MD TT for top, mid and leaf MD pages and similarly in the VLB TT for VLB pages. In at least one embodiment, the logical addresses of the MD pages and the VLB pages can remain the same even though the physical storage locations or addresses of such MD pages as stored in the MD log structure can change.

In at least one embodiment, at least some of the entries of the MD TT and VLB TT can be stored in memory such as volatile cache memory. Consistent with other discussion herein, version V1 of a MD page leaf1 can be stored on the BE non-volatile storage at a physical or address or location PA1. Subsequently, flushing updates from the MD log that update MD page leaf1 from version V1 to version V2 result in storing MD page leaf1 V2 at a new current physical address or location PA3, and also trigger a corresponding update U12 to the MD TT, where U12 is added to the TT log. U12 can identify, for example, that update or change to the TT entry corresponding to MD page leaf1 to identify PA3 (rather than PA1 ) as the current physical storage location or address for MD page leaf1.

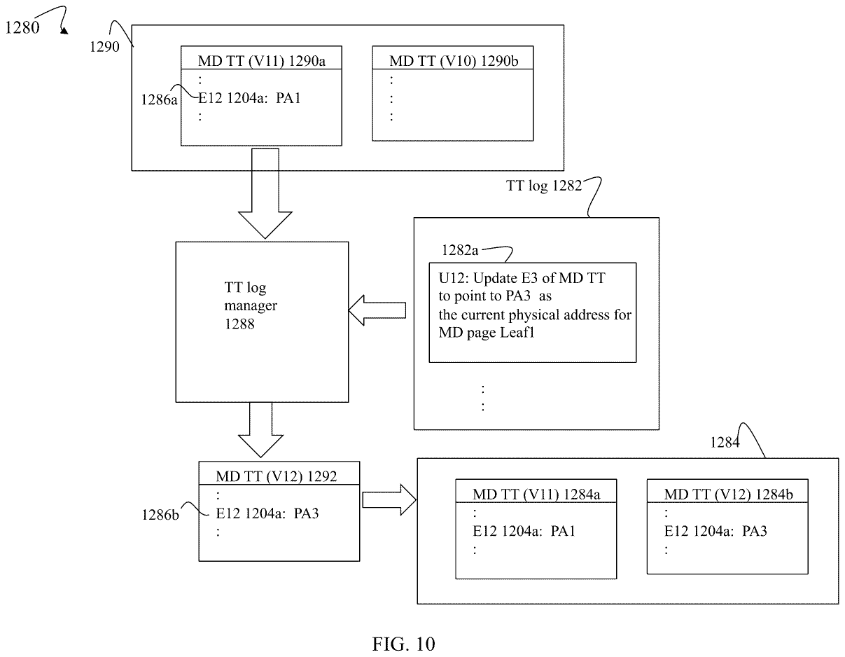

Referring to FIG. 10, shown is an example 1280 illustrating in further detail use of the TT log in connection with the foregoing update U12 for the MID TT in at least one embodiment.

As illustrated in the example 1280 of FIG. 10, an update U12 for the entry E12 1204a identifying PA3 as the current physical address or location of current version of the MD page Leafl can be recorded in the TT log. At a later point in time, U12 can be flushed from the TT log and applied to the most recent persistent copy of the MD TT.

To further illustrate the foregoing, reference is made to the example 1280 that includes element 1290 representing the two most recently persistently stored copies 1290a-b of the MID TT. In particular, element 1290a denotes the most recent persisted version V11 of the MD TT and element 1290b denotes the older persisted version V10 of the MD TT. In at least one embodiment, management of the persisted versions of the TTs, including the VLB TT and the MD TT, can be performed by a TT log manager component 1288.

At various points in time and responsive to the occurrence of one or more trigger conditions, the TT log manager 1288 can apply updates from the TT log 1282 to the most recent persisted copies of the VLB TT and MD TT to generate updated versions of the VLB TT and MD TT, where such updated versions can replace the older/oldest persisted copies of the VLB TT and MD TT. The example 1280 illustrates application of MD TT updates but similar processing can be performed in connection with application of VLB TT updates as also discussed elsewhere herein in more detail.

The TT log manager 1288 can receive inputs including the most recent persisted version of the MID TT, MD TT V11 1290a, and updates from the TT log 1282. The updates of the TT log 1282 can include update U12 1282a. In at least one embodiment, the update U12 1282a can be recorded as an entry in the TT log 1282 in a manner similar to that as described herein in connection with the MD log (e.g., as in connection with FIG. 6 elsewhere herein). The TT log manager can apply the update U12 1282a to the entry E12 1204a of the MD TT (V11) 1290a to generate an updated MD TT (V12) 1292. In this example, V11 of the entry E12 1286a of 1290a is updated to V12 of the entry E12 1286b of 1292. In particular, the MD TT (V12) 1292 can correspond to the in-memory version of 1204 of the example 1250. The MD TT (V12) 1292 can be persistently stored and can replace the older/oldest version V10 1290b. Element 1284 includes the two most recent versions V11 and V12 1284a-b of the MID TT as persistently stored in the MD tier by the TT log manager.

In the example 1280, 1290 denotes the two persisted versions 1290a-b of the MD TT before the TT log manager applied the above-noted updates and 1284 denotes the two persistent versions 1284a-b of the MD TT after the TT log manager applied the above-noted updates. As can be observed by comparing 1290 and 1284, the oldest version V10 1290b of 1290 is replaced with the updated version V12 1284b, and element 1290a and 1284a correspond to the same version V11 of the MD TT not replaced in connection with applying the updates of the TT log 1282.

Although only a single update is illustrated in connection with the example 1280, more generally, the TT log 1282 can be flushed or destaged where multiple updates of the TT log 1282 can be applied to both the most recently persistent version of the VLB TT and the MD TT.

Consistent with discussion herein in at least one embodiment, element 1292 can denote an updated version of the MD TT that can correspond to the current in-memory version of the MD TT, such as can be stored in a volatile memory cache. More generally in at least one embodiment, at any point in time, the current most up to date version of the MID TT can be constructed by reading the most recent persisted version of the MD TT from the MD tier and applying the MID TT updates of the TT log; and the current most up to date version of the VLB TT can be constructed by reading the most recent persisted version of the VLB TT from the MD tier and applying the VLB TT updates of the TT log.

The foregoing use of TTs, such as the MID TT for mapping logical addresses of top mid and leaf MD pages to corresponding current physical storage addresses or locations of such pages, can be generalized and applied for use in connection with any other type of suitable metadata such as VLB pages. Consistent with other discussion herein in at least one embodiment, VLBs can have their own logical address space, VLBAS, as well as corresponding VLB TT and VLBPS of the MD tier.

In at least one embodiment, the MD tier can be a parity protected tier that supports log structure writes. In at least one embodiment, the MD tier can include BE non-volatile PDs configured into RAID 5 or RAID 6 groups of PDs. In at least one embodiment, content can be stored in the persistent MD tier in PLBs where pages of metadata can be grouped and written into PLB structures that are, for example, each 2 MBs in size. As metadata is updated, the updated version of the metadata can be stored in a new location thereby producing holes of invalid or unused storage portions in the PLBs storing the old or prior metadata version. In at least one embodiment, the overall utilization of storage in each PLB storing valid content can be tracked and used for garbage collection to compact PLBs (e.g., copy valid content from multiple partially filled source PLBs to a single target PLB to thereby free the multiple source PLBs).

In at least one embodiment, metadata can be compressed as it is persistently stored. In at least one embodiment, a single MD tier can generally include all metadata physical storage (e.g., include MDPS as well as VLBPS). However in at least one embodiment, storage within the MD tier can be segregated by type at the PLB or other suitable storage unit level. For example, the MID tier can include the first group of metadata pages of types top, mid and leaf MD pages, where pages of the first group can be persistently stored in a first portion of the MD tier sometimes referred to herein as the MDPS. The MD tier can also include the second group of metadata pages of type VLB where pages of the second group can be persistently stored in a second portion of the MD tier sometimes referred to herein as the VLBPS.

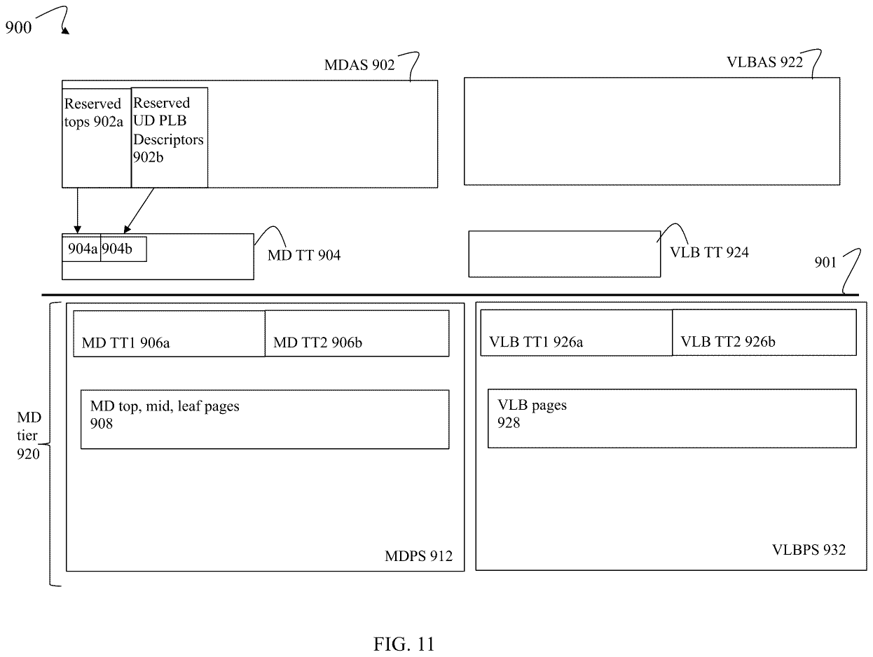

Referring to FIG. 11, shown is an example 900 illustrating the various in-memory logical address spaces and physical storage spaces in at least one embodiment in accordance with the techniques of the present disclosure.

The example 900 includes line 901 where components above the line 901 can denote the logical in-memory representations and where components below the line 901 can denote corresponding physical storage areas of the MD tier 920.

The in-memory logical representations can include the MDAS 902, MD TT 904, VLBs 922 and VLB TT 924.

In at least one embodiment consistent with other discussion herein, the mapping information of metadata pages can be partitioned into a first portion or group of metadata types including MD top, mid and leaf pages; and a second portion of a single metadata type including VLB pages. Generally although both VLB pages and MD top, mid and leaf pages can be considered metadata, in the example 900, the MDAS 902 and its associated MD TT 904 can represent logical in-memory representations related to the first group of MD pages; and the VLBAS 922 and its associated VLBTT 924 can represent logical in-memory representations related to the second group of VLB pages.

In at least one embodiment, other types of MD pages than those discussed specifically herein can used by other services and can be included generally in the MD tier 920. For example in at least one embodiment another type of MD page can be used to track free MD pages such as within the MD tier. In at least one embodiment, other supported types of MD than those specifically discussed herein can be included in the MDPS 912 and can be mapped or translated by the MID TT 904.

The MD tier 920 can include the MDPS 912 and the VLBPS 932. The MDPS 912 can include MD TT1 906a, MD TT2 906b, and top, mid and leaf MD pages 908 of the MD log structure 1114. The MD pages 908 can be stored in accordance with a log-based structure as described elsewhere herein in connection with the MD log structure 1114 of the example 1100. The VLBPS 932 can include the VLB TT1 926a, VLB TT2 926b and VLB pages 928 of the MD log structure 1114 of the example 1100. The VLB pages 928 can be stored in accordance with a log-based structure as described elsewhere herein in connection with the MD log structure 1114 of the example 1100.

Elements 906a-b can denote the two physical storage areas storing the most recently persisted two instances of MDTTs included in the MD tier 920. To illustrate, at a first point in time T11, MD TT1 906a can denote a first version V1 of a persisted MD TT and MD TT2 906b can denote a second version V2 of a persisted MD TT, where V2 can denote a more recent version than V1. At a second point in time T2 subsequent to T1, accumulated updates of the MD TT can be flushed from the TT log 1110 and applied to the most recent persisted version V2 of MD TT 906b to generate MD TT V3, where MD TT V3 can then replace the oldest/older persisted version V1 of 906a. At a third point in time T3 subsequent to T2, accumulated updates of the MD TT can again be flushed from the TT log 1110 and applied to the most recent persisted version V3 of MD TT 906a to generate MD TT V4, where MD TT V4 can then replace the current oldest/older persisted version V2 of 906b. Thus, at each of the foregoing points in time T2 and T3, the most persisted version can serve as a “source” to which flushed MD TT updates of the TT log are applied to generate a further updated version of the MD TT that is then stored at a “target” or “destination” physical storage location replacing the oldest/older persisted version of the MD TT. At consecutive points in time when MD TT updates are flushed and applied as noted above, the roles of “source” and “target” with respect to the physical storage locations of 906a-b can switch.

Elements 926a-b can denote the two physical storage areas storing the most recently persisted two instances of VLBTTs included in the MD tier 920. To illustrate, at a first point in time T11, VLB TT1 926a can denote a first version V1 of a persisted VLB TT and VLB TT2 926b can denote a second version V2 of a persisted MD VLB, where V2 can denote a more recent version than V1. At a second point in time T2 subsequent to T1, accumulated updates of the VLB TT can be flushed from the TT log 1110 and applied to the most recent persisted version V2 of VLB TT 926b to generate VLB TT V3, where VLB TT V3 can then replace the oldest/older persisted version V1 of 926a. At a third point in time T3 subsequent to T2, accumulated updates of the VLB TT can again be flushed from the TT log 1110 and applied to the most recent persisted version V3 of VLB TT 926a to generate VLB TT V4, where VLB TT V4 can then replace the current oldest/older persisted version V2 of 926b. Thus, at each of the foregoing points in time T2 and T3, the most persisted version can serve as a “source” to which flushed VLB TT updates of the TT log are applied to generate a further updated version of the VLB TT that is then stored at a “target” or “destination” physical storage location replacing the oldest/older persisted version of the VLB TT. At consecutive points in time when VLB TT updates are flushed and applied as noted above, the roles of “source” and “target” with respect to the physical storage locations of 926a-b can switch.

In at least one embodiment, the elements 902, 904, and 906a-b can grow, or generally vary, with the number of pages in 908; and the elements 922, 924 and 926a0b can grow, or generally vary, with the number of pages in 928.

In at least one embodiment, the MD top, mid, leaf pages 908 and VLB pages 928 can be stored in a single log structure as denoted by the MD log structure 1114 (e.g., the example 1100 of FIG. 9) where metadata can be stored in PLBs by the various metadata types. For example in at least one embodiment, pages of the metadata types top, mid and leaf 908 can be stored in the same PLB but not with VLB pages; and VLB pages 928 can be stored in the same PLB but not with pages of types top, mid and leaf. Such segregation at the PLB level can vary with embodiment based, at least in part, on the types of metadata, associated uses, expected frequency of updates, and the like.

In at least one embodiment, a portion of the MID TT 904 can be statically allocated and reserved for well-known metadata addresses such as reserved MD top pages and reserved UD PLB descriptors. Element 902a can denote the logical addresses of the reserved MD top pages that are mapped by corresponding entries 904a of the MD TT 904. Element 902b can denote the logical addresses of reserved UD PLB descriptors that are mapped by corresponding entries 904b of the MD TT 904. In at least one embodiment, each PLB of UD (e.g., such as included in the UD log structure 1108 of FIG. 9) can have an associated PLB descriptor with a corresponding MDAS logical address where the PLB descriptor can be included in the MD tier 920 (e.g., MDPS 912).

It should be noted that the example 900 and related discussion herein generally illustrates an embodiment including two address spaces, the MDAS 902 and the VLBAS 922, along with two types of TTs, the MD TT and the VLB TT. More generally, depending on the types of metadata, an embodiment in accordance with the techniques of the present disclosure can also include one or more additional address spaces and corresponding TTs both associated, respectively, with one or more additional types of metadata that can be included in an embodiment.

Consistent with discussion above, and with reference back to FIG. 6, in the following paragraphs the non-volatile metadata log 510 or the persisted metadata log or journal may also sometimes be referred to as an RDL or raw persisted or non-volatile MD data log; and a single bucket set, such as each of 502 and 504, of the volatile in-memory metadata log, may also be referred to an HBSB (hash-based sorted buckets). Thus, consistent with discussion above such as with reference back to FIG. 6, each node can have an active HBSB, such as bucket set 502, and an inactive or destaging HBSB, such as bucket set 504. A pair of HBSBs including an active bucket set and an inactive or destaging bucket set, may in some contexts also be referred to collectively as the in-memory or volatile memory MD logs or instances. Thus, as shown in FIG. 6, a storage node can write copies of delta updates as tuples to both the active in-memory MD log and also the RDL. The RDL can persistently store the respective tuples, deltas or MD updates in a time order sequence such as from older to newest. In contrast, MD updates, deltas or tuples stored in an in-memory MD log local to a storage node can be organized in a different manner to facilitate efficient and quick retrieval organized in hash buckets as discussed elsewhere herein. Within an HBSB, each hash bucket including MD updates for a single corresponding MD page, the MD updates, deltas or tuples can be organized in a time order sequence based on when the MD updates are received at the storage node.

In at least one embodiment, TT logs can be stored both in-memory (e.g., in a volatile memory cache such as in the form of HBSBs) and on persistent non-volatile storage (e.g., NVRAM such as an RDL). In at least one embodiment, two instances of the in-memory TT log (e.g., active and frozen or inactive HBSBs) can be used in a manner similar to that as described elsewhere in connection with the MD log such as, for example, in connection with FIG. 6.

In at least one embodiment consistent with other discussion herein, the VLB TT and the MID TT can each be managed and maintained separately or in the aggregate. In at least one embodiment, the VLB TT and MID TT can be managed and maintained in the aggregate as a single TT having corresponding TT log entries that are flushed to a single persisted TT.

With reference back to FIGS. 9 and 11 in at least one embodiment, each PLB of UD stored in the UD log structure 1108 can have an associated PLB descriptor that generally describes that particular PLB. The PLB descriptor describing a UD PLB can sometimes be referred to as a UD PLB descriptor. In at least one embodiment, PLB descriptors such as UD PLB descriptors can be characterized as another type of metadata. In at least one embodiment, the UD PLB descriptors can be stored in the MD tier and can have corresponding logical addresses in the MDAS 902. In such an embodiment, changes or updates to UD PLB descriptors can be recorded as entries in the MD log. The UD PLB descriptor updates of the MD log can be flushed or destaged in a manner similar to other recorded MD updates of the MD log. In at least one embodiment, pages of UD PLB descriptors can be stored in the MD tier 920 where such pages can be mapped and translated by corresponding mapping entries of the MD TT 904 to their current corresponding physical storage locations in the MD tier. As with other pages of metadata stored in the MD tier, the pages of UD PLB descriptors can be stored in the MD log structure (e.g., stored in a log-structure manner) such that updates to a UD PLB descriptor can be recorded in the MD log and when flushed, result in an updated UD PLB descriptor written to a new physical location in the MD log structure of the MD tier rather than perform in-place updates.

In at least one embodiment in accordance with the techniques of the present disclosure, each PLB stored in the MD tier can generally be referred to as a MD PLB (e.g., thus different types of metadata such as pages of top, mid and leaf MD pages as well as VLB pages and TTs can be stored in MD PLBs). Each MD PLB of the MD tier can have a corresponding PLB descriptor that can be referred to herein as a MD PLB descriptor. Each PLB descriptor associated with a corresponding PLB can generally describe the corresponding PLB. For example, a PLB descriptor can include information describing the content or data stored in the PLB (e.g., locations and sizes of the various stored content stored in the PLB), indicate when the PLB was most recently updated, include a physical address or location of storage mapped to the PLB, track a reference count of the total number of pages stored in the PLB, and the like.

In at least one embodiment in accordance with the techniques of the present disclosure, it can be desirable and advantageous to store and manage the MD PLB descriptors in accordance with techniques of a LSS. In at least one embodiment, the MD PLB descriptors themselves may not be included in the MID tier, and changes or updates to such MD PLB descriptors cannot be made using the MD log as used with recording changes to the content stored in PLBs of the MD tier. Put another way, the MD PLB descriptors in at least one embodiment are located external to the MID tier and can have their updates recorded in a different log than the MD log of updates for the MD tier. In at least one embodiment, MD PLB descriptors can be stored in a new boot tier (NBT) with its own associated NBT log, where the NBT tier and NBT log can be separate from, respectively, the MD tier and the MD log.

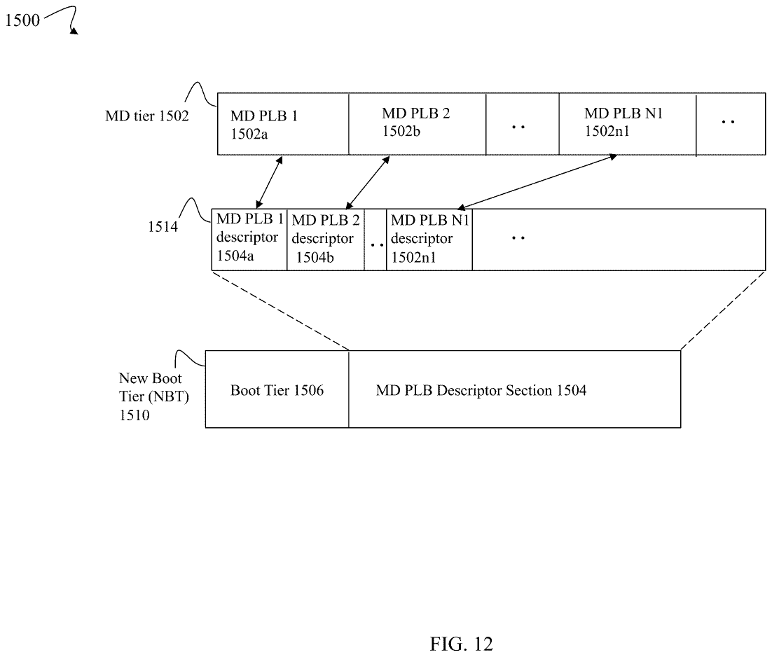

Referring to FIG. 12, shown is an example 1500 illustrating MD PLB descriptors, associated MD PLBs of the MD tier, and the NBT in at least one embodiment in accordance with the techniques of the present disclosure.

The example 1500 includes the MD tier 1502 with MD PLBs 1502a, 1502b, . . . , 1502N1, and so on. Each of the MD PLBs of 1502 can have an associated MD PLB descriptor included in a MD PLB descriptor section 1504. In at least one embodiment, the NBT 1510 of storage can be defined that includes a boot tier 1506 and the MD PLB descriptor section 1504. Element 1514 provides further details regarding the MD PLB descriptor section 1504 that includes MD PLB descriptors 1504a, 1504b, . . . 1504N1, and so on, corresponding respectively to MD PLBs 1502a, 1502b, . . . , 1502N1, and so on, of the MD tier 1502.

The NBT 1510 can be used to manage feature related boot strapping data as well as management of the MD PLB descriptors associated with MD PLBs of the MD tier. The boot tier 1506 can generally include information needed in connection with typical booting and rebooting of the system. For example, the boot tier 1506 can include fixed or well known addresses or locations denoting the starting address from where the boot process loads instructions and/or data to boot the system. The boot tier 1506 can include, for example, a copy of the operating system or otherwise a location of where the operating system can be loaded from at boot time. In at least one embodiment, the boot tier 1506 can identify locations where the TTs and metadata pages of various types are located. For example with reference to FIG. 11, the boot tier 1506 can identify locations of the TTs 906a-b, 926a-b, the MD top, mid and leaf pages 908, and the VLB pages 928 within the MD tier.

In at least one embodiment, the boot tier 1506 and the MD PLB descriptor section 1504 can share their own instance of a log referred to herein as the NBT log used to manage changes to content stored storage areas 1504 and 1506.

In at least one embodiment, the boot tier 1506 can be a fixed size section of storage for boot tier information. For example, space can be allocated for a super block at the start of the boot tier 1506.

Afterwards, pages of a specified size, such as 4 KB pages, can be reserved from the boot tier 1506 for features (e.g., services, layered products) to register, where such features can utilize the storage of the pages of the boot tier 1506 as may be needed. In at least one embodiment, the pages of the boot tier can be expected to have relatively few or a small number of changes infrequently.

In at least one embodiment, changes to the boot tier 1506 can be handled using bulk write operations and a staging area.

In at least one embodiment, the MD PLB descriptor section 1504 can increase in size as needed as the size of the MD tier 1502 increases. Thus in at least one embodiment, the section 1506 can be a fixed predefined size that does not change over the lifetime of the system, and the section 1504 can be a variable size section. The size of section 1504 can increase as the number of MD PLBs of the MD tier increases.

The size of 1504 can increase over time to store that additional MD PLB descriptors needed to describe MD PLBs added to the MD tier.

As illustrated in the example 1500, there can be a direct physical mapping between the MD PLB descriptors of the MD PLB descriptor section 1504 and the MD PLBs of the MD tier 1502. In at least one embodiment, storage can be allocated as additional storage that is mapped into the MID tier 1502. In at least one embodiment, as storage is removed and replaced in the MD tier, the replacement storage can occupy the same mapping as the original storage.

In at least one embodiment, descriptors of the section 1504 can also be stored in storage units corresponding to PLBs. Thus the PLB can also be the atomic unit of storage or granularity when writing content to the NBT 1510.

In at least one embodiment, storage for the NBT can be RAID-5 or RAID-6 configured storage.

Generally in at least one embodiment and consistent with other discussion herein, performing an update to a MD page stored in a MD PLB of the MD tier can result in a cascade of subsequent events initially summarized below and then followed by more detail in subsequent paragraphs. Updates can be recorded in the MD log. The MD log can be subsequently flushed or destaged resulting in updates recorded in the TT log and NBT log. When the TT log is flushed or destaged, further updates can be recorded in the NBT log. The NBT log can be flushed or destaged to apply updates to PLBs of the NBT tier. When the NBT log is flushed or destaged, no further updates are generated or recorded to thus end the cascade of recording changes in logs and flushing such logs in at least one embodiment.

In further detail in at least one embodiment, if there is an update U1 to a page P1 stored in a first MD PLB1 (e.g., PLB of the MD tier), U1 can be recorded in the MD log. Subsequently, the MD log can be flushed where U1 is applied to an existing version of P1 to generate an updated version of P1, and the updated version of P1 can be written to a new physical storage location in a new second MD PLB2 that is different from the first MD PLB1. As a result of flushing the MD log and storing the new updated version of P1 in the second MD PLB2, the corresponding MD PLB descriptor, DESC2, for MD PLB2 can also be accordingly updated. In at least one embodiment, update(s) to DESC2 can include updating information of DESC2 to: identify a particular location of MD PLB2 where the updated version of P1 is stored; identify a size of the updated version of P1 stored in MD PLB2; identify a date/time when the updated version of P1 is stored in MD PLB2; and increment a reference count tracking the total number of MD pages stored in MD PLB2. In at least one embodiment, the foregoing reference count can be used to track per PLB utilization or consumption of PLB storage for storing valid current content.

In at least one embodiment, each MD PLB descriptor describing a corresponding MD PLB can also include size information regarding the amount of storage of the MD PLB consumed for each page of content stored in the MID PLB. In at least one embodiment supporting compression at a per page level of granularity, such size information for each page stored in the MD PLB can vary and can denote the size of the compressed page stored in the MD PLB. For example, in at least one embodiment, pages of MD can be uniform in size and can be 4K bytes in uncompressed original form. Each of the foregoing pages of MD stored in a MD PLB can be stored in a compressed form where each individual 4K page is compressed and then stored in its corresponding compressed form. The size information of the MD PLB descriptor can include a size of each compressed page stored in the MD PLB. Thus, for example, as pages of content are added to MD PLB, its corresponding MD PLB descriptor's size information can be updated to reflect the size of compressed added pages stored in the MD PLB.

As a result of flushing the MD log and storing the new updated version of P1 in the second MD PLB2, a mapping entry E1 of a TT used to map P1 can be updated by an update U2 to now reference the new physical storage location of the updated version of P1. The update U2 to E1 of the TT (where TT can be either the VLB TT or MD TT depending on the type of MD of P1) can be recorded in the TT log. At a later point in time, the TT log can be flushed resulting in applying U2 to the TT where an updated version of the TT can be destaged or stored in a new MD PLB3 of the MD tier and where MD PLB3's corresponding MD PLB descriptor, DESC3, can also be accordingly updated.

As a result of updating E1 of TT such as when recording U2 in the TT log, the MD PLB descriptor DESC1 that is associated with MD PLB1 (storing the prior version of P1 before updating) can be updated to indicate that storage of MD PLB1 is no longer used for storing P1. For example in at least one embodiment, DESC1 can include a reference count that is decremented by 1 such as using a decref operation. The foregoing reference count (sometimes also referred to as a count) can track the number of current valid pages stored in MD PLB1. The reference count can be used, for example, for tracking utilization of portions of MD PLB1 that are consumed storing valid current content.

In at least one embodiment in accordance with the techniques of the present disclosure, updates to pages of MD PLBs can include updates to top, mid and leaf MD pages; updates to VLB pages; updates to the VLB TT; and/or updates to the MD TT. The foregoing updates to pages of the MD PLBs can be recorded in the MD log. Subsequently flushing the MD log results in applying updates to a first set of MD pages that are rewritten to new MD PLBs of the MD tier. Additionally, responsive to rewriting the first set of MD pages to the new MD PLBs of the MD tier, corresponding MD PLB descriptors of the new MD PLBs can also be accordingly updated. Additionally, rewriting the first set of MD pages to the new PLBs of the MD tier can also result in updates to mapping entries of a TT, where such TT updates can be recorded in a TT log. Subsequently, the TT log is flushed with TT updates applied to generate an updated version of the TT stored or destaged in a new MD PLB of the MD tier and also resulting in updating a corresponding MD PLB descriptor for the new PLB now storing the updated TT.

In at least one embodiment, updates to MD PLB descriptors can be recorded as entries in the NBT log. In at least one embodiment, as a result of storing updated MD pages and updated TTs in new MD PLBs of the MD tier, MD PLB descriptors that correspond to the new MD PLBs are also accordingly updated. Additionally, other MD PLB descriptors are also accordingly updated, where the other MD PLB descriptors correspond to old MD PLBs storing the prior version of the MID pages before updating. Such other MD PLB descriptors that use a reference count to track the total number of MD pages stored therein can be updated, for example, to decrement the total number of MD pages. In at least one embodiment, the foregoing decrement can be performed as a result of updating an entry of a TT for a MD page to reference a new physical storage address or location of an updated MD page rather than the prior physical storage address or location of a prior version of the MD page.

In at least one embodiment, the NBT log can be generally flushed or destaged in a manner similar to that as described herein, for example, with the TT log. Flushing or destaging the NBT log can include applying updates to MD PLB descriptors and writing the updated MD PLB descriptors to new physical storage locations. Each updated version of a MD PLB descriptor can be determined by applying relevant updates of the NBT log to a most recent persisted version of the MD PLB descriptor. The updated version of the MD PLB descriptor can be written to a new physical storage location or address (e.g., new PLB) of the section 1504 of the NBT 1510 in a log-based manner. Thus the new physical storage location can be different from the existing physical storage location of the most recent persisted version of the MD PLB descriptor in the section 1504.

The foregoing description regarding a cascading of events resulting from flushing or destaging the MD log, along with other items, in at least one embodiment is further described in more detail in the following paragraphs.

In at least one embodiment, both an in-memory (e.g., volatile or cache memory) instance and a non-volatile persisted instance of the NBT log can be managed, maintained and used in connection with the techniques of the present disclosure. In at least one embodiment, the non-volatile NBT log can be an RDL as discussed elsewhere herein in a manner similar to the non-volatile persisted instance of the MD log and TT log. As with other logs discussed herein, the changes tracked in the RDL instances of the NBT log can be used primarily for recovery purposes and can mirror the changes or updates tracked in the in-memory instance of the NBT log. In at least one embodiment, the in-memory or volatile instance of the NBT log can track recorded updates in an in-memory table. In at least one embodiment, each time the NBT log is flushed or destaged, recorded updates of the NBT log can be applied to the most recent persisted version of the NBT to generate an updated version of the NBT. In at least one embodiment, there can be aggregated management of updates for both the boot tier 1506 and MD PLB descriptor section (MPDS) 1504 of the NBT 1510 including rewriting the entire NBT, where such updates can be stored in the NBT log.

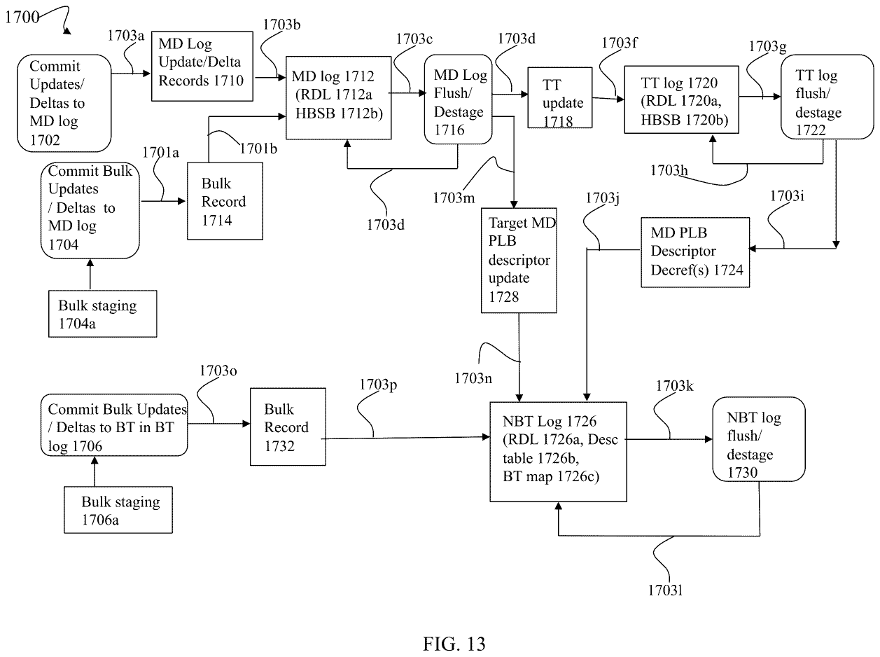

Alternatively in at least one embodiment, the updates of the boot tier 1506 and the MD PLB descriptor section 1504 can be managed separately. For example, updates to the MD PLB descriptor section 1504 can be handled independently of updates to the boot tier 1506. In at least one embodiment, changes or updates to the MDPS 1504 can be recorded in an in-memory DESC delta table (also referred to as a DESC table) which is then flushed to corresponding descriptors (e.g., PLB descriptors) of the MDPS 1504. In at least one embodiment, the DESC table can have a format or layout of entries or rows with an update to the MDPS 1504 recorded in each DESC table entry. In at least one embodiment, changes or updates to the BT 1506 can be recorded in an in-memory BT delta table (also referred to as a BT table) which is then flushed to corresponding descriptors of the BT 1506. In at least one embodiment, changes to BT pages can be stored in an in-memory BT delta table via a bulk operation. With a bulk operation in at least one embodiment, multiple updates to one or more pages of the BT can be committed and stored in the in-memory BT delta table in a single transaction. In at least one embodiment, a persistently stored RDL as discussed elsewhere herein can be used to also persistently store updates to the MDPS 1504 and can be used, for example, primarily for recovery purposes in at least one embodiment. In at least one embodiment, a common RDL can be used to persistently store updates made to both the sections 1504 and 1506 of the NBT 1510. In such an embodiment, the common RDL can be used to recover the contents of the in-memory DESC delta table, for example, in the case of a reboot, failure, or other event in which the system may be rebooted or restarted. Referring to FIG. 13, shown is an example 1700 illustrating processing flows in at least one embodiment in accordance with the techniques of the present disclosure.

The example 1700 illustrates the cascades of flushing or destaging among the various logs described herein in at least one embodiment in accordance with the techniques of the present disclosure. The example 1700 summarizes processing flows described above in at least one embodiment in accordance with the techniques of the present disclosure.

Processing can be performed to commit updates or deltas to the MD log 1702 of a single transaction to the MD log 1712. As a result, MD log update or delta records 1710 can be generated (1703a) and recorded (1703b) in the MD log 1712. In at least one embodiment, the MD log 1712 can be used for recording updates to top, mid and leaf MD pages and also VLB pages. In at least one embodiment, the MD Log 1712 can include a persisted version RDL 1712a (e.g., stored in non-volatile storage such as NVMRAM) and an in-memory version HBSB 1712b (e.g., storage in volatile memory such as volatile cache memory). Records of updates from the MD log 1712 can be provided as input (1703c) to MD log flush or destage processing 1716. Records of updates flushed or destaged the MD log 1712 can be dropped or removed (1703d) from the MID log 1712.

As a result of flushing or destaging 1716 the MD log, updates can be made to a page P1 where the updated version of page P1 is stored in a new physical address or storage location PA1 of a target MD PLB5 of the MD log structure. The target MD PLB descriptor corresponding to the target MD PLB5 is updated (1728) to reflect the fact that the target MD PLB5 now stores the updated version of page P1, where the target PLB descriptor update 1728 is generated (1703m) as a result of flushing or destaging the MD log 1716. The update 1728 is recorded (1703n) in the NBT log 1726. In at least one embodiment, the NBT log 1726 can include a common RDL 1726a used to persistently store updates to both the BT 1506 and the MPDS 1504. In at least one embodiment, the NBT log 1726 can also store updates to the MPDS 1504 in volatile memory in the Desc (descriptor) table 1726b, and updates to BT 1506 in volatile memory in the BT map 1726c. The BT map 1726c can represent, for example, an in-memory BT delta tables such as noted above. The Desc table 1726b can represent, for example, an in-memory DESC delta table such as noted above. In at least one embodiment, the target MD PLB descriptor update 1728 can be recorded in the RDL 1726c and the Desc table 1726b.

Also as a result of flushing or destaging 1716 the MD log, a TT update 1718 can be made to a mapping entry E1 of a TT (e.g., the MD TT and/or VLB TT). Consistent with discussion herein, the updated mapping entry E1 can identify the current physical address or storage location PA1 in the target MD PLB storing the updated version of page P1. The TT update 1718 can be generated (1703d) and recorded (1703f) in the TT log 1720. In at least one embodiment, the TT log 1720 can include a corresponding persisted RDL 1720a (e.g., stored in non-volatile storage such as NVRAM) and an in-memory HBSB 1720b (e.g., stored in volatile memory such as a volatile cache). The TT log 1720 can be flushed or destaged 1722. As records of the TT log 1722 are flushed or destaged, they can be dropped or removed (1703h) from the TT log 1722.

Flushing or destaging the TT log 1722 results in updating the persistently stored TT and storing the updated version of the TT in a new physical address or storage location PA2 in a MD PLBX. Also as a result of 1722 in at least one embodiment, a MD PLB DESC Y can be updated (1724). The MD PLB DESC Y can correspond to the MD PLB Y that stored the prior version of the page P1 (noted above) prior to updating (e.g., where the mapping entry E1 was updated to indicate that the updated version of P1 is stored at the current physical address or storage location of PA1). In particular, the update 1724 to the MD PLB DESC Y can be a “decref” operation that decrements the reference count of the MD PLB DESC Y by 1 to reflect the fact that P1 is no longer stored in the MID PLB Y.

The MD PLB descriptor update 1724 that is a decref can be generated (1703i) as a result of TT log flushing or destaging 1722, where the update (e.g., decref) 1724 can be recorded (1703j) in the NBT log 1726.

In at least one embodiment, bulk updates can also be performed in connection with the MD log 1712. Element 1704a denotes the bulk update staging area, for example, where updates to one or more pages of metadata can be collected and then committed in a single transaction 1704. The committed bulk updates 1704 to the MD log result in generating (2702s) the bulk record 1714 that is recorded (1701b) in the MD log 1712.

In at least one embodiment, bulk updates can be performed in connection with updates to the BT 1506. Element 1706a denotes the bulk staging area, for example, where updates to one or more pages of the BT can be collected and then committed in a single transaction 1706. The committed bulk updates 1706 to the BT result in generating (17030) the bulk record 1732 that is recorded (1703p) in the NBT log 1726. In at least one embodiment, the BT updates of 1732 can be recorded in the RDL 1726b and the BT map 1726c).

The NBT log 1726 can be flushed or destaged 1730 resulting in updates to the BT 1506 and/or MPDS 1504. As updates are flushed or destaged from the NBT log 1726, such updates can be dropped or removed (17031) from the NBT log 1726.

In summary, the example 1700 indicates that flushing or destaging the MID log 1712 can result in updates recorded in the TT log as well as the NBT log. Flushing or destaging the TT log can result in updates recorded in the NBT log. When the NBT log is flushed or destaged, no update or delta records are generated.

Systems can include various structures stored in a cache such as a fast volatile memory, where such structures can sometimes also referred to herein as in-memory or volatile memory structures. As discussed herein, a TT or translation table can be used to perform address translations of logical to physical addresses or locations for various metadata pages in a log structured system or LSS. In this context in at least one embodiment, metadata (MD) pages can generally include top, mid and leaf MD pages as well as VLB pages discussed above. A TT can be used to translate a logical address of a MD page to a corresponding physical address or location where the MD page is stored on BE non-volatile storage. As discussed above, an embodiment can generally include one or more TTs that map metadata page logical addresses to corresponding current physical storage locations or addresses where the metadata pages are stored. In at least one embodiment, the general class of MD pages can include top, mid and leaf MD pages and VLB pages. In at least one embodiment, a first TT can be used to map logical addresses of top, mid and leaf MD pages to corresponding physical addresses, and a separate second TT can be used to map logical addresses of VLB pages to corresponding physical addresses. As a variation, an embodiment can use a single TT for mapping logical to physical addresses of all such MD pages including top, mid and leaf MD pages and VLB pages.

In at least one embodiment, versions of the TT log can be persistently stored. Additionally, an in-memory TT log (sometimes also referred to as a TT delta log) can be stored in volatile memory. As noted above in at least one embodiment, the in-memory TT log can include an active and frozen TT log pair denoting changes, deltas, or updates to TT entries of top, mid, and leaf MD pages and VLB pages. Role or state switching of active and frozen between the two TT logs can be performed in a manner similar to that as discussed herein in connection with the in-memory MD log. The active TT log of the pair can be used for storing newly added TT updates. When the active TT log is full, it can transition to the frozen state where it is then flushed to generate an updated version of the TT that is persistently stored or destaged. The in-memory TT log structures can be indexed by MD page logical addresses that are mapped to corresponding physical addresses or locations on BE non-volatile storage where the respective MD pages are stored.

In a log structured system or LSS consistent with other discussion herein, multiple pages of data or content can be aggregated and then written out contiguously in large storage portions, such as PLBs, where such PLBs can be tracked or described by corresponding PLB descriptors. In particular, a PLB descriptor for a PLB can include space account information describing the amount of PLB storage that is considered to be consumed or used storing content. As updated versions of data or content in an LSS are rewritten persistently to PLBs of the LSS, new storage is allocated utilizing free or empty PLBs. The foregoing process can generate holes of invalid or stale content corresponding to stale or invalid versions of data existing in other PLBs.

An LSS can delay the space accounting for the storage of the PLBs, for example, in efforts to improve performance. Due to the delay or deferred space accounting for PLBs, the respective space accounting information for the PLBs can inaccurately specify amounts or percentages of consumed and free storage. In particular, the delay in space accounting for PLBs can result in the respective accounting information indicating larger than actual percentages or amounts of consumed storage accounting (i.e., since the space account information for the PLBs can denote amounts or percentages of consumed and free storage that can mistakenly account for storing both invalid and valid versions of the same data page).

The partially consumed PLBs including both valid content and the holes of invalid content can be further processed by the system for reuse. For example, such processing can include GC. In at least one embodiment, GC processing can be performed responsive to the occurrence of one or more conditions such as, for example, when the system is reaching a point of maximum storage consumption, or when storage needs to be re-allocated.

In at least one embodiment, GC processing can include taking several partially consumed source PLBs and moving the content of the source PLBs to a target PLB essentially defragmenting the source PLBs. In at least one embodiment, GC processing can include performing a clean operation where two or more partially consumed source PLBs have their content written to a free target PLB. The target PLB can be 100% free and each of the source PLBs has a corresponding percentage of consumed or free storage such that the content of all the source PLBs can fit on the single free target PLB. With the clean operation, the net expected gain can be at least 1 free PLB. During the GC processing, any deferred storage accounting debt that has yet to be performed is unknown. Generally the storage accounting debt can refer to storage accounting processing that is performed to reclaim the storage capacity of stale or invalid data for reuse.

Such storage accounting debt or processing can include, for example, decrementing any counters or other information denoting utilized or consumed storage to reflect the stale or invalid content such that the storage capacity of the stale or invalid content is reclaimed, denoted as free and available for reuse. For example, consider two source PLBs, PLB1 and PLB2, each of which has space accounting information indicating that each of the two source PLBs are 50% utilized or consumed. In this example, assume that PLB2 has deferred space accounting that needs to be performed to account for stale or invalid content stored on PLB2. Such deferred space accounting for PLB 2 can account for up to 50% of its consumed or utilized storage.

However, during the clean operation of GC processing, the actual amount of deferred space accounting and corresponding percentage of PLB2's storage containing invalid content is unknown but has a maximum value of 50%. In this case, the clean operation can use the current space accounting information indicating the PLB2 is 50% utilized and PLB1 is 50% utilized.

After the clean operation, the two source PLBs, PLB1 and PLB2 are each 100% free/ 0% utilized or consumed, and the target PLB is 100% utilized or consumed. After the clean operation of GC processing, performing the deferred space accounting for PLBs can occur resulting in the target PLB being between 50 % and 100% utilized based on the amount of invalid content of PLB 2 moved to the target PLB during the clean operation. In the worst case where PLB2 has a deferred space accounting debt of 50% such that PLB2contained only invalid content, 50% of the target PLB's storage could have been used to store other valid content from one or more other source PLBs. Thus although the space accounting information of the source PLBs can be inaccurate and can overstate the amount of consumed or utilized PLB storage, GC processing can use the available space accounting information thereby leading to inefficiencies such as noted above due to the deferred space accounting or deferred updating of the PLB space accounting information. Additionally, another drawback of the foregoing is that the copying or moving content from a partially filled source PLB to the target PLB can also move invalid or stale content as reflected in the potentially inaccurate PLB space accounting information. As discussed below in more detail in at least one embodiment, the in-memory TT can be used with the techniques of the present disclosure to overcome this latter drawback and determine, during GC processing, whether a particular MD page stored in a PLB of the LSM is valid or alternatively invalid or stale. The foregoing can be performed, for example, to avoid copying stale or invalid content during GC such as when moving or copying data with a clean operation.

In at least one embodiment using LSM for storing MD pages, LSM can handle the tracking of deltas, changes or updates to the LSM physical locations or addresses of persisted MD pages within the in-memory TT. In at least one embodiment, as a new instance or version of a MD page is persisted to a new physical address in storage of the LSM, the prior physical address of the prior instance or version of the MD page can be tracked using a predecessor entry or predecessor structure of the in-memory TT. In at least one embodiment, if the same MD page is updated and rewritten out multiple times to multiple different physical addresses, predecessors can be used to track all such multiple updates to the physical address or location where the MD page is stored. In at least one embodiment, the in-memory TT can track the updates, changes or deltas made to a TT entry corresponding to the MD page whose physical address or location changes.

In at least one embodiment, space accounting for the PLBs of the LSM can be performed as part of flushing the TT log and destaging or persisting a new TT to storage of the LSM. At this time, the space accounting information of the LSM PLBs can be updated including performing deferred decref processing to appropriately update (e.g., decrement) utilization information regarding consumed and/or free storage of the PLBs. In at least one embodiment, PLB space accounting information for a PLB can include a reference count denoting the number of pages of the PLB which are consumed or utilized. In this manner in at least one embodiment, a percentage denoting utilization or consumed storage of the PLB can be determined. For example, if the PLB has a total storage capacity of M pages and the reference count indicates that N pages are consumed, then the PLB has a utilization percentage which can be expressed as N/M. As a variation, free storage of the PLB can be expressed as 1−(N/M). In such an embodiment, deferred space accounting can include deferred decref processing that accordingly decrements PLB reference counts, and possibly other information, to account for stale or invalid content stored on the PLBs.

In at least one embodiment, space accounting and thus deferred decref processing can be performed in bulk, such as in a single transaction, for PLBs of the LSM storing a destaged TT. The destaged TT can denote an updated version of the TT after applying all changes or updates when the TT log is flushed. At this time, the deferred dec ref processing can occur and the corresponding PLBs will have their storage counts updated. The frequency of the bulk processing can depend, at least in part, on the frequency of the TT destages and TT log flushing events. Because the entire TT (and therefore address space) is destaged in at least one embodiment, all decrefs for the entire TT address space can be processed with each TT destage and each TT log flush. With deferred space accounting and thus deferred decref processing, the reference counts or PLB space accounting information may not accurately reflect the state of the PLBs with respect to actual consumption or utilization for storing valid content. However, the mapping of the MD page logical to physical addresses as maintained in the TT is accurate and always identifies the physical address or location of the current or most up to date version of the corresponding MD page in LSM storage.

In at least one embodiment with reference back to FIG. 13, deferred decref processing can include processing as denoted by element 1724 to commit updates or decrements for the PLB reference counts and also updates or decrements for the PLB delayed counts discussed elsewhere herein in more detail.

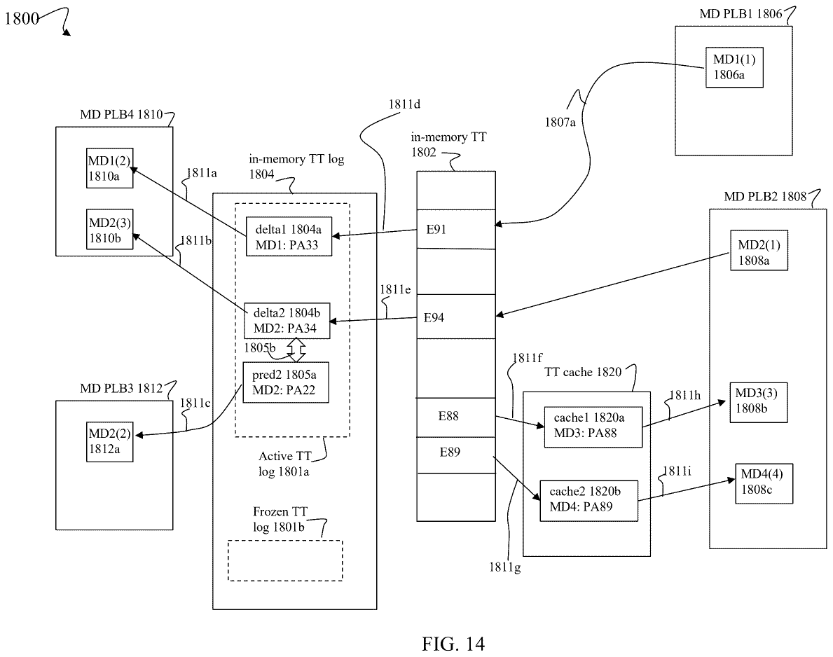

Referring to FIG. 14, shown is an example 1800 illustrating structures that can be used in at least one embodiment in accordance with the techniques of the present disclosure.

The example 1800 includes the following volatile memory structures: the in-memory TT log 1804, the in-memory TT 1802, and the TT cache 1820. The example 1800 includes the following PLBs of LSM non-volatile storage: PLBs 1806, 1808, 1810 and 1812.

The in-memory TT 1802 can be indexed using logical addresses of MD pages. In at least one embodiment, the in-memory TT 1802 can be a hash table where a hash function HF can be used to map a logical address LA of a MD page to a hash table (HT) entry or line, where the HT entry can be associated with an entry identifying the physical address or location PA of the current most up to date version of the MD page as stored in a PLB of the LSM. In at least one embodiment, an HT entry of the TT 1802 can be associated with i) a delta entry denoting a TT log entry of the TT log 1804 that includes PA, or ii) a cache entry of the TT cache 1820 that includes PA. In at least one embodiment, if querying the TT 1802 to obtain the current PA for the LA of a MD page results in a miss (e.g., where HT(LA)-HT entry which is not associated with a corresponding cache or delta entry including PA for the MD page), a new cache entry can be created in the TT cache 1820 and associated with the corresponding HT entry mapping to LA. The new cache entry can be updated to store the current PA of the MD page. The current PA for the MID page can be obtained by reading the corresponding TT entry for the MD page from BE non-volatile storage where the persisted TT is stored in the LSM. In at least one embodiment, the in-memory TT 1802 can be queried to determine the physical storage location or address PA of any MD page given the MD page's logical address LA.

The in-memory TT log 1804 can include delta entries each corresponding to an update to a TT log entry recorded in the TT log 1804. Thus each time a MD page is written to a new physical storage location or address PA, a corresponding TT log entry can be recorded in the TT log 1804. Consistent with other discussion herein in at least one embodiment, the in-memory TT log 1804 can include 2 instances-an active TT log 1801a and a frozen or inactive TT log 1801b. New TT log entries can be added as delta entries to the active TT log 1801a but not the frozen TT log 1801b which is being flushed. The frozen TT log 1801b can include entries similar to those as illustrated in FIG. 14 for the active TT log with the difference that no new entries can be added to the frozen TT log. Consistent with other discussion herein, the entries of the frozen TT log 1801b are flushed and applied to the persisted TT to generate an updated TT, where the updated TT can be persisted on PLBs of the LSM. In at least one embodiment where the TT log 1804 uses two instances switching between active and frozen roles, a first TT log having the frozen role, such as 1801b, can be flushed while the other second TT log, such as 1801a, is active. After the first frozen TT log 1801b is flushed, roles can be switched where the first TT log 1801b transitions from frozen to active, and where the second TT log 1804a transitions from active to frozen and can be flushed to generate a new persisted TT version that is destaged. The foregoing can be repeated so that the first and second TT log instances 1801a-b repeatedly alternate roles of active and frozen.

In at least one embodiment, once the TT log 1801a becomes frozen and its updates denoted as delta entries are flushed, TT log 1801a can be empty and the delta entries can be converted to corresponding cache entries of the TT cache 1820.

The TT cache 1820 can include cached TT entries of the TTs. In at least one embodiment, not all TT entries of the TTs (including a VLB TT and MD TT) can be cached in the TT cache 1820. Thus in at least one embodiment, the TT cache 1820 can store selected TT entries mapping MD page logical addresses to corresponding physical address or locations based, at least in part, on one or more TT cache management policies. In at least one embodiment, TT cache entries of the TT cache 1820 can be managed in accordance with a least recently used or LRU caching policy. With an LRU policy, the most recently used TT entries for top, mid, leaf and VLB pages can be maintained and remain in the TT cache. The LRU policy can identify or order cached entries of the TT cache for eviction based on last or most recent time of access such that when it is necessary to evict an entry from the TT cache 1820, the LRU entry can be evicted, for example, to make room for storing a new TT entry in the TT cache 1820.

In at least one embodiment, TT log entries and predecessor entries of the TT log 1804 are not preemptable and cannot be evicted. In contrast in at least one embodiment, TT cache entries of the TT cache 1820 are preemptable via LRU semantics and can be evicted from the TT cache when needed, such as when memory is needed for new TT log entries or new TT cache entries.

In at least one embodiment, processing can query the in-memory TT 1802 using the logical address or LA of a MD page as a key to locate and access an entry, if any, that identifying the current physical address or location PA of the MD page as stored on BE non-volatile storage of the LSM. In at least one embodiment, at most a single entry denotes a current physical address for each MD page, where the single entry can be a cache entry or a delta entry mapped to a corresponding TT entry or line of the in-memory TT 1802.

In at least one embodiment, one or more predecessor type entries can be associated with a delta type entry (e.g., TT log entry) if a same MD page is rewritten multiple times to multiple different physical storage locations or addresses prior to the TT log associated with the delta type entry being frozen and flushed. In at least one embodiment, the predecessor type entries can be used to track and identify the prior physical storage locations on BE non-volatile storage of MD and VLB pages that are subsequently rewritten to new physical storage locations. As discussed elsewhere herein in at least one embodiment, MD and VLB pages can be persistently stored on BE non-volatile storage in PLBs or physical large blocks. Each time a particular MD page is rewritten to a new physical location, storage of the old prior copy of the MD page can be reclaimed and reused. The predecessor type UHT entries provide a mechanism in at least one embodiment to track such prior storage locations of old stale copies of MD pages where the MD pages have been rewritten multiple times prior to the TT log associated with such predecessor type entries being flushed. In at least one embodiment, the physical storage of old, stale or prior copies of MD pages can be reclaimed for reuse such as by garbage collection or GC processing. For example, in at least one embodiment where MD pages are stored persistently in PLBs of BE non-volatile storage, multiple MD pages can be stored in each single PLB. As MD pages are updated and then rewritten repeatedly to the PLBs, the old stale or prior version of the MD pages can be marked as invalid and can result in creating “holes” of invalid, stale or outdated content (e.g., old, prior stale versions of MD pages) among valid content (e.g., current valid versions of MD pages) within the same PLBs. As discussed elsewhere, garbage collection or GC processing can include a cleaning, compaction or copying process whereby valid content from multiple partially filled source PLBs can be copied to a single target PLB to thereby free the multiple source PLBs. The predecessor type entries can be used in at least one embodiment to facilitate tracking the storage locations of the PLBs that contain invalid content and thus can be used in connection with deferred decref processing such as described, for example, in connection with TT log flushing or destaging.

To further illustrate with reference to the example 1800, consider the following where: MD page MD1 has a corresponding logical address MD1LA1, MD page MD2 has a corresponding logical address MD2LA2, MD page MD3 has a corresponding logical address MD3LA3, and MD page MD4 has a corresponding logical address MD4LA4. The active TT log 1801a of the in-memory TT log 1804 can include delta entries denoting TT log entries 1804a-1804b, where delta entry 1804b is associated (1805b) with predecessor entry 1805a. The TT cache 1820 can include cache entries 1820a-b.

MD1LA1 can map to TT entry E91 of the TT 1802, where TT entry E91 is associated with (1811d) delta or TT log entry 1804a indicating that the PA33 is the physical address or location of the current version of MD page MD1. Delta or TT log entry 1804a can reference or point to (1811a) the element 1810a, where 1810a denotes PA33 of MD PLB4 1810 storing the current version 2 of MD page MD1 (e.g., denoted as MD1(2) ). It should be noted that the notation MDx(N) is used to denote version N of MD page MDx, where N is an integer and where each time a new version of MDx is written, its corresponding version number can be incremented by 1. Thus the higher the version number, the more recent the version.

MD2LA2 can map to TT entry E94 of the TT 1802, where TT entry E94 is associated with (1811e) delta or TT log entry 1804b indicating that the PA34 is the physical address or location of the current version of MD page MD2. Delta or TT log entry 1804b can reference or point to (1811b) the element 1810b, where 1810b denotes PA34 of MD PLB4 1810 storing the MD page MD2(3). A predecessor entry 1805a is associated with delta or TT entry 1804b. The predecessor entry 1805a indicates that the previous version 2of MD2 (denoted as MD2(2) ) is stored at PA22. The predecessor entry 1805a can reference or point to (1811c) the element 1812a, where 1812a denotes PA22 of MD PLB3 1812 storing the MD page MD2(2) .

MD3LA3 can map to TT entry E88 of the TT 1802, where TT entry E88 is associated with (1811f) cache entry 1820a indicating that the PA88 is the physical address or location of the current version of MD page MD3. Cache entry 1820a can reference or point to (1811h) the element 1808b, where 1808b denotes PA88 of MD PLB2 1808 storing the current version 3 of MD page MD3 (e.g., denoted as MD3(3)).

MD3LA4 can map to TT entry E89 of the TT 1802, where TT entry E89 is associated with (1811g) cache entry 1820b indicating that the PA89 is the physical address or location of the current version of MD page MD4. Cache entry 1820b can reference or point to (1811i) the element 1808c, where 1808c denotes PA89 of MD PLB2 1808 storing the current version 4 of MD page MD4 (e.g., denoted as MD4(4)).

In the example 1800, MD pages stored at i) the physical location or address 1806a of MD PLB1 1806; and ii) the physical location or address 1808a of MD PLB2 1808 have not yet had their corresponding space accounting information updated and can count as consumed storage. In the example 1800, element 1806a can store version 1 of MD page MD1 (e.g., denoted as MD1(1)), and element 1808a can store version 1 of MD page MD 2 (e.g., denoted MD 2(1)). In the example 1800, both of the foregoing pages can be stale or invalid and corresponding to MD pages that have been updated with later more recent versions. With reference to the example 1800 and to further illustrate, MD page MD 1 has a first version 1806a which was replaced with a later version 1810a. MD page MD2 has a first version 1808a which was replaced with a second version 1812a, and the second version 1812a was replaced with the current third version 1810b.

Thus, storage associated with 1808a, 1812a and 1806a contain stale or invalid content that can be reclaimed, and for which corresponding PLB accounting information can be updated to reflect such reclamation.

In at least one embodiment, the in-memory TT can be queried to determine the corresponding physical address or location PA for a given logical address LA of a MD page. In at least one embodiment during GC processing, the LSM knows the allocation of storage for the PLBs being cleaned in GC processing due to the in-memory TT. Thus the in-memory TT can be queried and information thereof generally used in connection with GC processing to determine whether a page P1 of storage of a PLB contains invalid stale MD data and to therefore allow for the page P1 of storage of the PLB to be reclaimed at the time of GC. Thus for example, the reference count of a PLB's space accounting information can indicate that the PLB is 50% utilized. During GC processing, information in the in-memory TT can be used to determine, for example, that the PLB is actually only 25% utilized by determining that 25% of the supposed 50% utilized storage actually contains invalid stale content. Additionally in at least one embodiment as discussed in more detail elsewhere herein, the in-memory TT can be used to determine which MD pages stored on a PLB are valid and which are otherwise invalid or stale. In at least one embodiment, the foregoing can be performed in connection with cleaning a partially filled source PLB to move all its valid MD pages to a target PLB thereby free or cleaning the source PLB to be 100% free.

In at least one embodiment, when MD pages are moved or freed from a PLB, processing of corresponding decrefs to accordingly decrement counts of the PLB's space accounting information can be performed as part of deferred decref processing when the TT log is flushed and the TT is destaged.

In at least one embodiment, during GC processing, two or more partially filled source PLBs can have their valid content moved to a new free target PLB. The net result of the foregoing can be one or more free PLBs. During GC processing, the TT can be used to determine which MD pages are associated with the source PLBs to be cleaned. In this case, only valid content can be selected and moved from the source PLBs to the target PLB. The foregoing can be used in at least one embodiment to avoid moving invalid content. Additionally in at least one embodiment, left over or remaining decref processing for the cleaned source PLBs can be handled using corresponding delayed counts for the source PLBs. Consistent with other discussion herein, the delayed count for a PLB can denote a buffer or temporary count that is consumed when deferred decref processing is performed to update the PLB's space accounting information to accurately reflect the current state of valid content of the PLB.

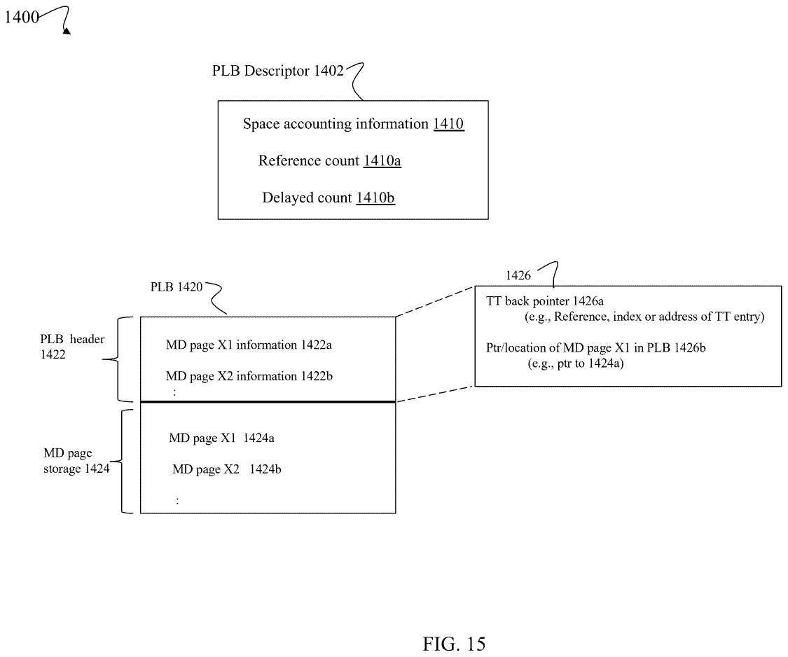

Referring to FIG. 15, shown is an example 1400 providing further detail of structures that can be used in at least one embodiment in accordance with the techniques of the present disclosure.

The example 1400 includes PLB descriptor 1402 as discussed elsewhere herein. In at least one embodiment, the PLB descriptor describing a corresponding PLB can include space accounting information 1410 used in connection with performing space accounting processing such as, for example, deferred decref processing to decrement counts in connection with storage capacity of stale or invalid content stored on the PLB. In at least one embodiment, the deferred decref processing of the space accounting can be performed during flushing the TT log and destaging a new version of the TT to storage of the LSM. In at least one embodiment, the PLB's space accounting information 1410 can include a reference count 1410a and a delayed count 1410b. The fields 1410a-b, and uses thereof, are described in more detail elsewhere herein. The PLB descriptors for MD can be as also discussed elsewhere herein, for example, in connection with FIG. 12.

The example 1400 includes PLB 1420 providing further details regarding the layout of a PLB used in storing MD pages, where the PLB can be included in LSM storage such as, for example, if the MD tier 1502 of FIG. 12. The PLB 1420 can include a header 1422 and MD page storage 1424. The header 1422 can include information regarding each MD page stored in the PLB. The header 1422 can include MD page X1 information 1422a, MD page X2 information 1422b, and so on, to describe each MD page stored in the MID page storage 1424 section of the PLB 1420. The MD page storage 1424 can include each MD page described in the header 1422. For example, the MD page storage 1424 can include i) MD page X1 1424a described by MD page X1 information 1422a; ii) MD page X2 1424b described by MD page X2 information 1422b, and so on for each MD page stored in 1424.

The element 1426 provides further detail regarding data that can be included in each set of MD page information of 1422. For example, the element 1426 provides further detail regarding fields of data that can be included in MD page X1 information 1422a regarding the MD page X1 1424a. More generally, each set of MD page information of 1422 can also include similar information for another corresponding MD page stored in the PLB. The MD page X1 information 1426 for MD page X1 can include TT back pointer 1426a which is a reference, index or address of a TT entry which is associated with information used to map the logical address LA1 of MD page X1 to the physical address PA1 of the current version of MD page X1. For example with reference to FIG. 14, the TT back pointer for MD page MD1(1) 1806a can reference (1807a) TT entry E91 of . In at least one embodiment, TT back pointer can denote the index or offset of the TT entry E91 in the TT. The MD page X1 information for MD page X1 can also include field 1426b identifying a reference, location or address of the MD page X1 as stored in the MD page storage 1424. For example, for the MD page X1, the field 1426b can identify the address or location of 1424a storing the MID page X1 in the PLB's MD page storage 1424.

In at least one embodiment, a MD page X stored at the physical address PAX in the PLB can be determined as valid content if the MD page's TT entry maps the MD page's logical address LA1 to a corresponding physical address PA1, where PA1 equals or matches PAX. Otherwise if PA1 does not equal PAX, then it can be determined that MD page X stored at PAX in the PLB is invalid or stale content. For example, with reference to FIG. 14, assume that the physical address of MD page MD1(1) 1806a is PAX. The MD page MD1(1) 1806a can be determined as invalid or stale content because the TT entry E91 is associated with a delta entry 1804a indicating that the current physical address for MD page M1 is PA33 corresponding to a newer version 2 of the MD page MD1, denoted as MD1(2) 1810a (e.g., PA33 does not equal or match PAX). In contrast, the MD page MD1(2) 1810a having physical address PA33 can be determined as valid content because the TT entry E91 is associated with a delta entry 1804a indicating that the current physical address for MD page M1 is PA33 corresponding to MD1(2) 1810a.

It should be noted that in at least one embodiment, the TT back pointer for each MD page of a PLB can be stored in the PLB's corresponding header. More generally, the TT back pointer for a MD page can be stored in any suitable location for use with the techniques of the present disclosure. For example as a variation in at least one embodiment, the TT back pointer for a PLB can be extracted from the PLBs content rather than fro a corresponding PLB header.

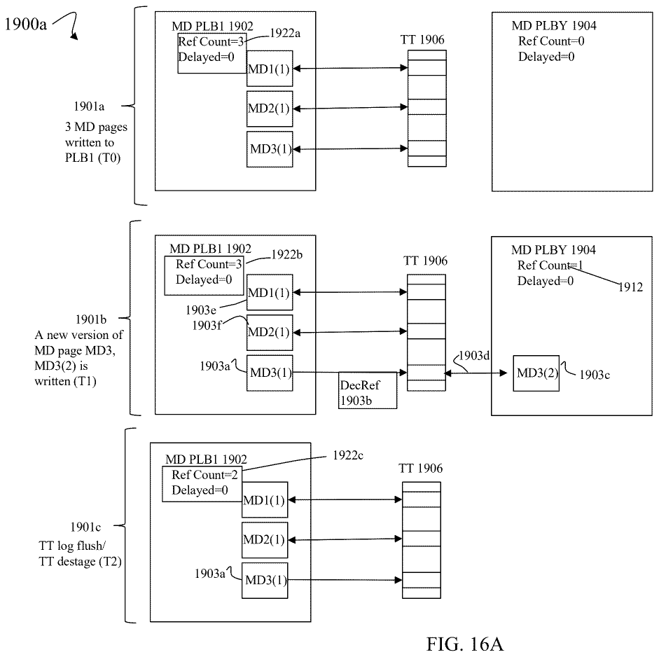

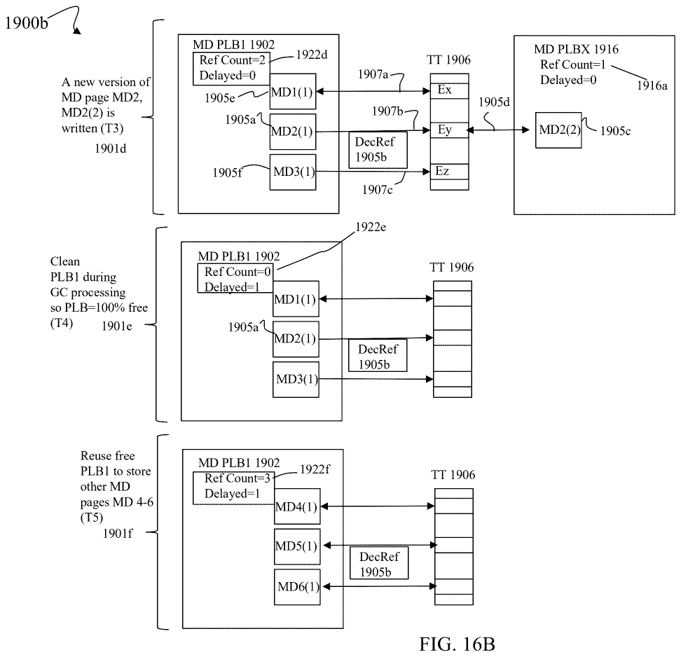

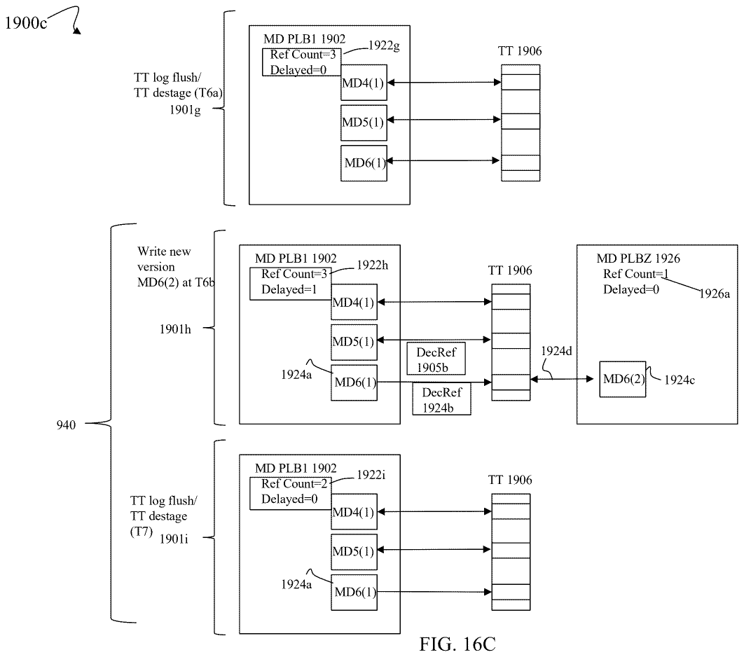

With reference FIGS. 16A-C, shown are examples 1901a-c illustrating use of the techniques of the present disclosure in at least one embodiment. For illustration in the following examples, assume that each PLB can hold at most 3 MD pages so that a page reference count of 3 for a PLB means that the PLB is 100% utilized or consumed, and has 0% free storage. In contrast, a page reference count of 0 for the PLB means that the PLB is 0% utilized or consumed and thus 100% free.

As new versions of updated MD pages are determined as a result of flushing the MD log, the new versions of the MD pages can be written to PLBs.

The illustration starts with reference to element 1901a showing the state of PLBs 1902 ,1904, and the TT 1906 at a start state TO where 3 MD pages MD1-3 are written to PLB 1902. In at least one embodiment, the TT 1906 can denote the in-memory TT such as described, for example, in connection with FIG. 14 and elsewhere herein.

At TO 1901a, MD PLB 1902 can include a reference (ref) count of 3 denoting the storing of MID pages MD1(1), MD2(1) and MD3(1), where “(1)” denotes version 1 of each of the foregoing MD pages. At TO 1901a, MD PLB Y 1904 as a ref count of 0 and a delayed count of 0. Element 1922a shows space accounting information for MD PLB1 1902 where the ref count=3 and delayed=0 correspond respectively to fields 1410a-b of FIG. 15 for the particular PLB 1902.

At time T1 following TO a new version of MD page MD3, MD3(2) 1903c is written to PLB Y 1904 where MD PLB 1904′s ref count is updated (1912) to 1. Element 1901b denotes the state of the illustrated structures at time T1 after MD3(2) is written. At time T1 1901b, i) MD1(1) 1903e and MD2(1) 1903f as stored in PLB 1902 are valid; ii) MD3(1) as stored in PLB 1902 is invalid; and iii) MD3(2) as stored in PLB 1904 is valid. Thus MD page MD3's latest version 2, denoted MD3(2), is now tracked (1903d) by the TT 1906. However the consumed or utilized capacity of PLB1 1902 is still reported as 3 as denoted by the reference count (ref count) of 1922b. In response to storing a new version 1 of MD page MD 3 at time T1 1901b, a decref 1903b to decrement the space accounting information of PLB 1902 can be collected and deferred for processing until the next TT log flush and next TT destage. In at least one embodiment, the decref 1903b can be a decrement that is applied at a later point in time to either the ref count or delayed count of PLB 1902 during the TT log flush and TT destage in connection with deferred decref processing.

At time T1 1901b, since the MD page MD3(1) 1903a is now replaced by a later version MD3(2) 1903c, MD3(2) can have a corresponding first delta entry in the TT log and also associated with a corresponding TT entry of the TT 1906. Since MD3(1) 1903a is now invalid, its delta entry can be converted to a predecessor entry which is associated with the first delta entry denoting MD3(2) consistent with discussion elsewhere herein regarding the in-memory TT (e.g., FIG. 14). In at least one embodiment, the decref 1903b can correspond to the predecessor entry of the TT 1906. Thus collecting or creating a decref 1903b that is deferred and later processed as part of deferred decref processing can be denoted by the corresponding predecessor entry of the TT.

In at least one embodiment, the current value of ref count for PLB 1902, or more generally any PLB, can denote the reported current consumed pages of the PLB for space accounting purposes such as GC collection. The delayed count for the PLB is not used in connection with reporting and determining PLB storage utilization or consumption.

At time T2, following T1, the TT log can be flushed and applied to the persisted TT to generate an updated version of the TT which is destaged or written out to non-volatile storage of the LSM. In at least one embodiment, flushing the TT log can flush the frozen TT log and apply the updates of the frozen TT log to the TT to generate the updated version of the TT which is destaged. Element 1901c denotes the state of the illustrated structures at time T2 after the TT log is flushed and TT destaged. In connection with flushing the TT log and destaging the new version of TT 1906, the decref 1903b can be processed as part of deferred decref processing. In connection with 1901c, decref 1903b can be applied to the ref count of 1922b to result in decrementing the ref count for PLB 1902 from 3 to 2 as denoted by 1922c. More generally, the deferred decref processing can be performed based on a policy described in more detail below which results in applying the decref 1903b to the ref count of 1922b in this particular scenario or state because the corresponding delayed count of 1922b is currently 0. Thus in at least one embodiment, deferred decref processing of T2 can include performing a decref for each predecessor entry of the TT 1906 where the decref 1903b corresponds to one such predecessor entry previously created at time T1 discussed above.

Consistent with other discussion herein in at least one embodiment, updates or changes to PLB descriptors can be made in an LSS by recording the updates in a log, such as the NBT log 1726 of FIG. 13, where foregoing PLB descriptor updates can then be flushed (1730) from the NBT log and applied to corresponding PLB descriptors. In an LSS, the application of PLB descriptor updates in connection with 1730 can result in generating new versions of corresponding PLB descriptors, which are then destaged and written out the non-volatile storage. In at least one embodiment, updates to the PLB descriptors to update the reference counts and delayed counts thereof in connection with deferred decref processing and also in connection with GC processing can be implemented by committing corresponding updates as records of the NBT log 1726.

At time T3 following T2 as illustrated by element 1901d, a new version 2 of MD page MD2 (e.g., denoted as MD2(2) 1905c) can be written to PLB X 1916 and the ref count 1916a for PLBX 1916 can be incremented from 0 to 1 to account for the newly stored MD page MD 2(2) 1905c. Element 1901d denotes the state of the illustrated structures at time T3 after MD2(2) is written. At time T3 1901d, i) MD1(1) as stored in PLB 1902 is valid; ii) MD2(1) and MD3(1) as stored in PLB 1902 are invalid; and iii) MD2(2) as stored in PLB 1916 is valid. Thus MD page MD2's latest version 2, denoted MD3(2) 1905c, is now tracked (1905d) by the TT 1906. However the consumed or utilized capacity of PLB1 1902 is still reported as 2 as denoted by the reference count (ref count) of 1922d. In response to storing a new version 1 of MD page MD2 at time T3 1901d, a decref 1905b to decrement the space accounting information of PLB 1902 can be collected and deferred for processing until the next TT log flush and next TT destage. In at least one embodiment, the decref 1905b can be a decrement that is applied at a later point in time to either the ref count or delayed count of PLB 1902 during the TT log flush and TT destage in connection with deferred decref processing.

At time T3 1901d, since the MD page MD2(1) 1905a is now replaced by a later version MD2(2) 1905c, MD2(2) can have a corresponding first delta entry in the TT log and also associated with a corresponding TT entry of the TT 1906. Since MD2(1) 1905a is now invalid, its delta entry can be converted to a predecessor entry which is associated with the first delta entry denoting MD2(2) consistent with discussion elsewhere herein regarding the in-memory TT (e.g., FIG. 14). In at least one embodiment, the decref 1953b can correspond to a predecessor entry of the TT 1906. Thus collecting or creating a decref 1905b that is deferred and later processed as part of deferred decref processing can be denoted by the corresponding predecessor entry of the TT.

At time T4 following T3, GC processing can be performed. In at least one embodiment, GC processing at T4 can select two or more partially filled source PLBs to have their valid content copied to a single target PLB as part of a clean operation. In this example, such GC processing can select the partially filled source PLBs based on their reported space accounting as denoted by the reference counts (1410a) of each of the PLBs. In at least one embodiment, the source PLBs can be selected such that all aggregated content from the source PLBs fits on the single target PLBs. In this example, for the source PLBs selected, adding their respective reference counts must be equal to or less than 3 (e.g., where 3 denotes a fully consumed or 100% utilized target PLB). In this example, assume that PLB 1902 is selected as one of the source PLBs whose content is to be moved or copied to the target PLB. Thus GC processing can use the reference count of 2 of 1922b for PLB 1902 as denoted by 1901d in connection with selecting PLB 1902 as a source PLB for the clean operation. Based on the reference count of 2 of 1922d for PLB 1902 as denoted by 1901d, GC processing initially assumes that at most 2 MD pages of PLB 1902 need to be moved, relocated or copied to the target PLB.

During the GC clean operation at T4, the selected PLB 1902 can be scanned to determine which stored MD pages are valid and which are invalid. GC processing can then move or relocate to the target PLB only those MD pages of PLB 1902 that are determined as valid. In at least one embodiment, the TT 1906 can be used in connection with determining which MD pages of the source PLB 1902 being cleaned are valid or alternatively invalid, whereby cleaning moves or relocates only valid MD pages of 1902 to the target PLB. In this example at time T4, scanning PLB 1902 can include determining whether each of the MD pages MD1(1) 1905e, MD2(1) 1905a, and MD3(1) 1905f stored in the PLB 1902 is valid or invalid such as using the TT 1906.

In at least one embodiment, the TT can be used in connection with determining whether a particular version or instance of a MD page of a source PLB, such as 1902, is valid or otherwise invalid/stale. In FIGS. 16A-C, a valid MD page instance can be denoted by a bidirectional arrow between the MD page and the TT, and an invalid MD page instance can be denoted by a one directional or unidirectional arrow from the MD page to a TT entry (e.g., the TT does not include a TT entry that maps to the invalid MD page instance where the logical address of the MD page maps to an associated index of the TT entry).

In at least one embodiment, when scanning PLB 1902, processing can be performed to determine whether each MD page version or instance stored therein is valid or invalid by determining whether the TT has a TT entry corresponding to the MD page which points to or references the MD page instance. In at least one embodiment with reference back to FIG. 15, the TT back pointer for a version X of a MD page Pl stored at physical address or location PAA of the PLB 1902 can point back to or reference a corresponding TT entry of the TT 1906 associated with a corresponding delta entry DE for the MD page P1. The delta entry DE can identify the current physical address PAC for the current valid version Y of the MD page. If the physical address PAC of DE of the TT equals or matches PAA, then the version X of the MD page P2 is valid, and otherwise the version X of the MD page is invalid. Thus in at least one embodiment, when the TT back pointer for a MD page of the MD PLB 1902 points back to or references a TT entry which also references or points to the MD page as stored in the MD PLB 1902, then the MD page is valid, and otherwise the MD page is invalid.

Thus in at least one embodiment, a MD page, or TT back pointer thereof, stored in a PLB can point to or reference a corresponding TT entry. If the MD page is a valid copy or version, then the corresponding TT entry should also point or reference the particular MD page to the same MD page copy or version, and otherwise, processing can determine that the particular MD page copy or version is invalid.

With reference to 1901d, i) MD1(1) 1905e and MD2(2) 1905c are both valid instance or versions of MD pages as denoted by the corresponding bidirectional arrows 1907a, 1905d, and ii) MD2(1) and MD3(1) are both invalid or stale versions of MD pages as denoted by the corresponding unidirectional arrows 1907b-c. Thus with reference to 1901d, as a result of scanning PLB 1902 as a source PLB for the clean operation or processing, GC processing can determine that MD1(1) 1905e, or its TT back pointer, points to the TT entry Ex, and that Ex also points to or references the physical address or location of MD1(1) 1905e, thereby indicating that MD1(1) 1905e is a valid copy or version of MD1. As a result of scanning PLB 1902 as a source PLB for the clean operation or processing, GC processing can determine that MD2(1) 1905a, or its TT back pointer, points to the TT entry Ey, but that Ey does not also point to or reference the physical address or location of MD2(1) 1905a, thereby indicating that MD2(1) 1905a is a invalid copy or version of MD1. Rather, the TT entry Ey references (1905d) MD2(2) 1905c. As a result of scanning PLB 1902 as a source PLB for the clean operation or processing, GC processing can determine that MD3(1) 1905f, or its TT back pointer, points to the TT entry Ez, but that Ez does not also point to or reference the physical address or location of MD3(1) 1905f, thereby indicating that MD3(1) 1905f is a invalid copy or version of MD1. Rather, the TT entry Ez can reference another version or instance of MD2 not illustrated in FIG. 16B for simplicity. For example, TT Ez can reference MD3(2) of PLB 1904 as denoted in 1901b.

In this example at time T4, processing can determine that only MD1(1) (1905a) of PLB 1902 is valid, and that the remaining stored MD pages (e.g., MD2(1) 1905e and MID3(1) 1905f) of the PLB 1902 are invalid.

During the clean operation of GC processing, MD page 1905e is moved to the target PLB because it is valid, but MD pages 1905a, 1905f are not moved to the target PLB because they are invalid. It is noted that MD page 1905a has an associated deferred decref 1905b that will be processed later during the next TT log flush and next TT destage. In this example at time T4, the GC clean operation cleaned 1 page, MD page 1905e, from PLB 1902 as a result of moving or relocating MD page 1905e to the target PLB. In connection with the clean operation, the ref count for PLB 1902 as denoted by 1922d can be decremented by the number of pages cleaned or moved from the PLB 1902. In this example in connection with the clean operation, the ref count=2 for PLB 1902 as denoted by 1922d can be decremented by 1 for the number of pages cleaned or moved from the PLB 1902 to the target PLB, whereby the updated ref count=1 for PLB 1902 at this point.

When the GC clean operation completes, any remaining or left over reference count for PLB 1902 as denoted by a positive reference count value indicates the number of decrefs of PLB 1902 that have been deferred and not yet processed. The remaining or left over reference count for PLB 1902 can be assigned or transferred to the delayed count for PLB 1902. In this example, the reference count=1 for PLB 1902 thereby denoting the number of deferred decrefs to the space accounting for PLB 1902 that have not yet been processed. In this case, the left over or remaining reference count=1 for PLB 1902 can be transferred to the delayed count for PLB 1902 and processed later in connection with the next TT log flush and next TT destage. The foregoing transferring the remaining reference count to the delayed count of PLB 1902 results in zeroing the reference count so that PLB 1902 now reports 100% free storage capacity.

The element 1901e denotes the state of the structures at time T4 after completing the GC clean operation where valid content from PLB 1902 is copied, moved or relocated to a target PLB. In particular, element 1922e denotes the ref count=0 for PLB 1902 and the delayed count of 1 for PLB 1902. The delayed count=1 in 1922e for PLB 1902 denotes the deferred or outstanding decref 1905b to be processed in the next TT log flush and next TT destage. In at least one embodiment, the sum of the ref count plus the delayed count for a PLB can equal a second quantity, where the second quantity is the sum of the number of valid pages stored in the PLB plus the number of deferred decrefs for stale invalid pages of the PLB that have not yet been accounted for in space accounting information for the PLB.

At a time T5 following T4, the PLB 1902 can be reused as a 100% free PLB to store new MD pages such as MD pages MD4(1), MD5(1) and MD6(1) as illustrated in element 1901f. In 1901f, MD PLB 1902 retains its delayed count=1 since the next TT log flush and TT destage have not yet occurred.

Below are two variations of processing that can occur following time T5.

As a first variation, processing described below at time T6a with reference to element 1901g can occur following T5. As a second variation, processing described below with reference to element 940 at times T6b followed by T7 can occur after T5.

For the first variation at time T6a following T5, assume that the TT log is flushed and a new corresponding version of the TT is destaged. In connection with T5, the deferred decref 1905b can be processed and thus committed such as to the NBT log 1726. In at least one embodiment, a policy can be specified in connection with deferred decref processing to apply a deferred decref, such as 1905b, for a PLB to the PLB's delayed count if the PLB's delayed count is >0, and otherwise to apply the deferred decref to the PLB's reference count. In this example prior to the next TT log flush and TT destage of T6a, the PLB 1902 can have corresponding counts as denoted by 1922f of 1901f at T 5, where the reference cont=3 and the delayed count=1. As a result applying the above-noted deferred decref policy results in applying the single decref 1905b to the delayed count of 1922f where the delayed count for PLB 1902 is decremented from 1 to 0. The reference count remains at 3.

Thus in at least one embodiment, deferred decref processing of T6a can include performing a decref for each predecessor entry of the TT 1906 where the decref 1905b corresponds to one such predecessor entry previously created at time T3 discussed above.

The element 1901g denotes the state of structures of the system at time T6a after performing the above-noted TT log flush and TT destage, including completing the deferred decref processing and processing the decref 1905b. The final space accounting for PLB 1902 at time T6a is 3 as denoted by the reference count of 1922f.

For the second variation at time T 6b following T5, reference is made to element 1901h of 1940. Assume that MD page MD6 is rewritten so that a new version 2 of MD page MID6 (e.g., MD6(2) 1924c) is written out to PLB Z 1926 of LSM storage, where MD6(2) 1924c is the new version replacing MD6(1) 1924a. In the scenario of T6b, a second delayed decref 1924b can be created for MD6(1) 1924a. The element 1901h denotes the state of structures at time T6b after writing out the new version MD6(2) to the PLB 1926. The ref count 1926a for PLB 1926 is 1 denoting the single MD page 1924c stored therein.

At time T6b 1901h, i) MD4(1) and MD5(1) as stored in PLB 1902 are valid; ii) MD6(1) as stored in PLB 1902 is invalid; and iii) MD6(2) as stored in PLB 1926 is valid. Thus MD page MD6's latest version 2, denoted MD6(2) 1924c, is now tracked (1924d) by the TT 1906. However the consumed or utilized capacity of PLB 1 1902 is still reported as 3 as denoted by the reference count (ref count) of 1922h. In response to storing a new version of MD page MD6 at time T6b, a decref 1924b to decrement the space accounting information of PLB 1902 can be collected and deferred for processing until the next TT log flush and next TT destage. In at least one embodiment, the decref 1924b can be a decrement that is applied at a later point in time to either the ref count or delayed count of PLB 1902 during the TT log flush and TT destage in connection with deferred decref processing in accordance with the deferred decref policy. Consistent with other discussion herein in at least one embodiment, the deferred decref 1924b can be tracked in the TT by a corresponding predecessor entry (denoting MD6(1)), where the predecessor entry is associated with the TT log entry (e.g., delta entry) and TT entry for the current valid MD page version MD6(2).

For the second variation at time T7 following T6b, assume that the TT log is flushed and a new corresponding version of the TT is destaged. In connection with T7, the deferred decrefs 1905b and 1924b can both be processed and thus committed such as to the NBT log 1726. In at least one embodiment, the policy (also referred to as a deferred decref policy) can be specified in connection with deferred decref processing to apply a deferred decref, such as 1905b and 1924b, for a PLB to the PLB's delayed count if the PLB's delayed count is >0, and otherwise to apply the deferred decref to the PLB's reference count. In this example prior to the next TT log flush and TT destage of T7, the PLB 1902 can have corresponding counts as denoted by 1922h of 1901h at T6b, where the reference count=3 and the delayed count=1. As a result applying the above-noted deferred decref policy results in i) applying a first one of the decrefs 1905b, 1924b to the delayed count of 1922h where the delayed count for PLB 1902 is decremented from 1 to 0; and ii) applying a second one of the decrefs 1905b, 1924b to the ref count of 1922h where the ref count for PLB 1902 is decremented from 3 to 2.

The element 1901i denotes the state of structures of the system at time T7 after performing the above-noted TT log flush and TT destage, including completing the deferred decref processing and processing the decrefs 1905b and 1924b. The final space accounting for PLB 1902 at time 7 is 2 as denoted by the reference count of 1922i. Thus in at least one embodiment, deferred decref processing of T7 can include performing a decref for each predecessor entry of the TT 1906 where the decrefs 1905b and 1924b each correspond to one such predecessor entry previously created as discussed above.

In at least one embodiment when processing PLBs in connection with GC processing, determining which MD pages are valid and only copying such valid pages provides benefits that are now illustrated and described in more detail below. If it is unknown what MD pages of the consumed or utilized PLB storage are invalid, then the clean operation of GC processing can move all such stored MD pages (corresponding to consumed or utilized PLB storage as reported by the reference counts of such PLBs) to the target PLB. For example, assume GC processing selects two source PLBs each having a 50% reported utilization such that when content of the two source PLBs is combined and stored on the target PLB, the target PLB will have a reported 100% utilization. The outcome of GC processing can be 2 free source PLBS and a target PLB that is only 50% utilized.

However, for each of the two source PLBs, 25% of each source PLB's stored content can be invalid or no longer valid such as due to being replaced by newer updated versions of MD pages having older prior versions stored on the source PLBs A and B. For each source PLB A and B in a system not using the techniques of the present disclosure, there is an additional 25% of the PLB's storage that is no longer valid which will not be known using corresponding reference counts until the next deferred decref processing is completed with the next TT log flush/TT destage. As a result the target PLB can have a reported utilization of 100% until such deferred decref processing is completed to accurately update the target PLB's reference count to reflect the actual valid content thereof. The foregoing without using the techniques of the present disclosure can have adverse effects such as: i) increased write amplification as the clean operation of the GC processing includes rewriting or copying invalid data from the source PLBs to the target PLB; and ii) inefficient data packing during the GC clean operation. In connection with this latter inefficiency, for example, content of an additional third source PLB C having no more than 50% of its storage with valid content may have also had its valid data copied to the target PLB along with the two source PLBs if at GC processing, it is known more accurately what content of PLB utilized storage is now invalid.

Thus in at least one embodiment with reference to FIGS. 16A-C, each of the decrefs 1903b, 1905b, 1924b can be represented by a corresponding predecessor entry of the TT created when a first version or instance of a MD page is invalidated such as by processing that writes out a new updated second version of the MD page thereby invalidating the prior first version of the MD page. When deferred decref processing is performed such as in connection with TT log flushing and TT destage (e.g., at times T2, T6a and T7discussed above), for each predecessor entry of the TT, a decrement by 1 can be applied to either the reference count or delayed count of a corresponding PLB including the invalid MD page represented by the predecessor entry. Thus each predecessor entry can correspond to an invalid MD page stored in a PLB that has not yet been accounted for in the space accounting information of the PLB.

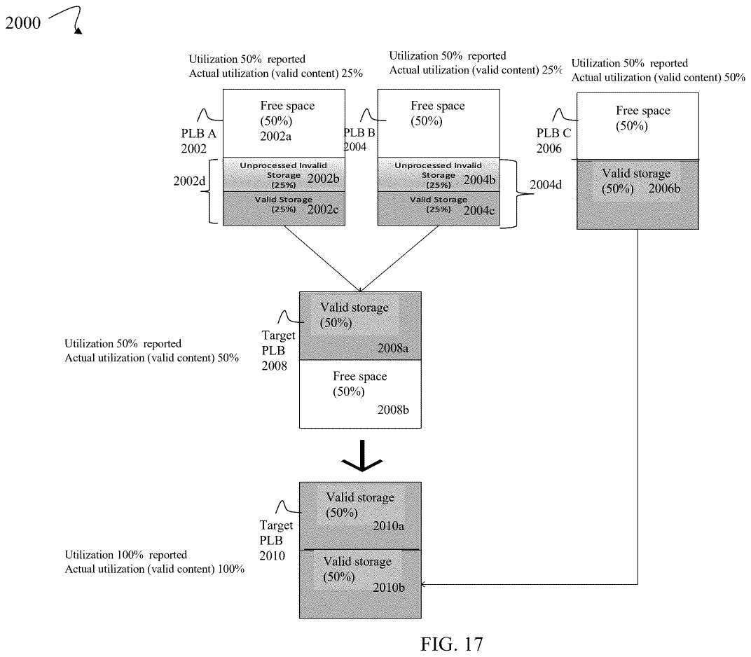

With reference to the example 2000 of FIG. 17, consider using the techniques of the present disclosure with storage of LSM when performing a clean operation of GC processing. The example 2000 includes PLB A 2002, PLB B 2004 and PLB C 2006. PLB A 2002 can be a source PLB as described above with space accounting via PLB A's reference count reporting 50% utilization and thus 50% free space (2002a). Of the 50% utilized storage (2002d) of PLB A, 25% can be invalid (2002b) and 25% can be valid (2002c). PLB B 2004 can be a source PLB as described above with space accounting via PLB B's reference count reporting 50% utilization and thus 50% free space (2004a). Of the 50% utilized storage (2004d) of PLB B, 25% can be invalid (2004b) and 25% can be valid (2004c). PLB C 2006 can be a source PLB 6 with space accounting via PLB C's reference count reporting 50% utilization and thus 50% free space (2006a). All of PLB C's 50% utilized storage (2006b) can be valid.

As a first step in at least one embodiment, GC processing can select PLBs 2002 and 2004 based on their reported utilizations of 50% each. Using the techniques of the present disclosure, GC processing can determine that actually only 25% of the content 2002c of PLB A 2002 is valid, and that only 25% of the content 2004c of PLB B 2004 is valid. The clean operation of GC processing can copy only the valid content 2002c, 2004c to the target PLB 2008 thereby resulting in the target PLB 2008 having 50% free space (2008b), 50% utilized storage (2008a), where 2008a includes only valid content.

As a result, GC processing can select another third source PLB C 2006 based on its reported utilization of 50% via its corresponding reference count to fill the remaining free space 2008a of the target PLB 2008. PLB C 2006 can be selected since it has a reported utilization of 50% and the target PLB 2008 has 50% free storage 2008b. GC processing can determine that all of PLB C's utilized storage 2006b contains only valid data whereby all the data of 2006b can be copied to the free space 2008b. The element 2008 shows the target PLB prior to copying valid data from the source PLB C 2006, and the element 2010 shows the target PLB after copying the valid data from the source PLB C 2006. As a final GC processing result after copying only valid data from the source PLBs 2002, 2004 and 2006, the target PLB 2010 can have a 100% utilization as reported by its reference count where all of the content (2010a-b) of PLB 2010 can be valid data.

Thus as discussed above in at least one embodiment in an LSM, during the clean operation of GC processing, the invalid content can be determined and not copied to the target PLB. As a result, an additional third source PLB C can be used as part of the clean operation of GC processing as illustrated in FIG. 17. In contrast to other discussion above without using the techniques of the present disclosure, the outcome of using the techniques of the present disclosure in connection with the example of FIG. 17 is 3 free source PLBs (2002, 2004, 2006) and a target PLB that is 100% utilized storing only valid content. In at least one embodiment, the techniques of the present disclosure can provide i) less write amplification by only copying valid content for the GC clean operation; and ii) better utilization of PLBs as a result of the clean operation of GC processing.

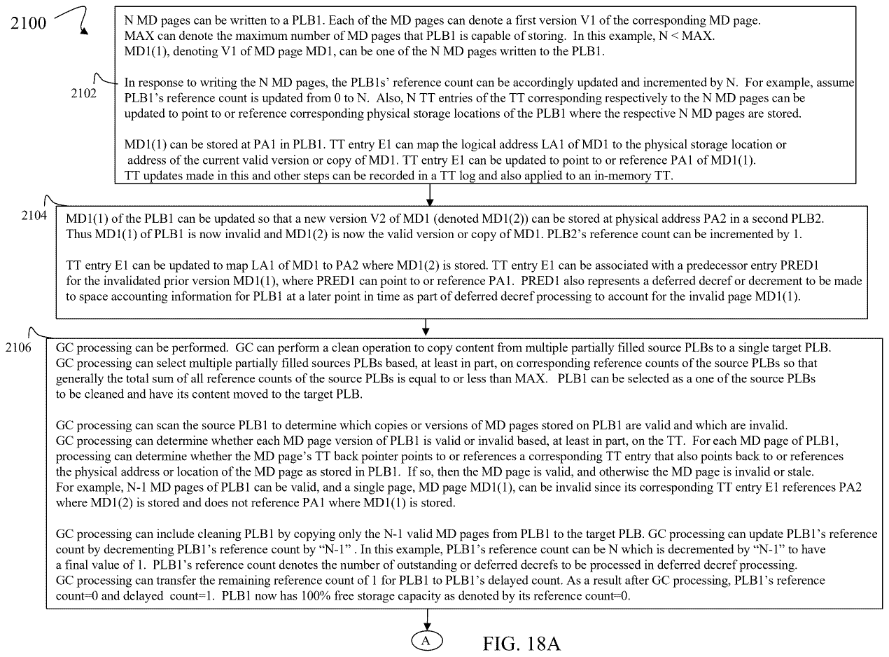

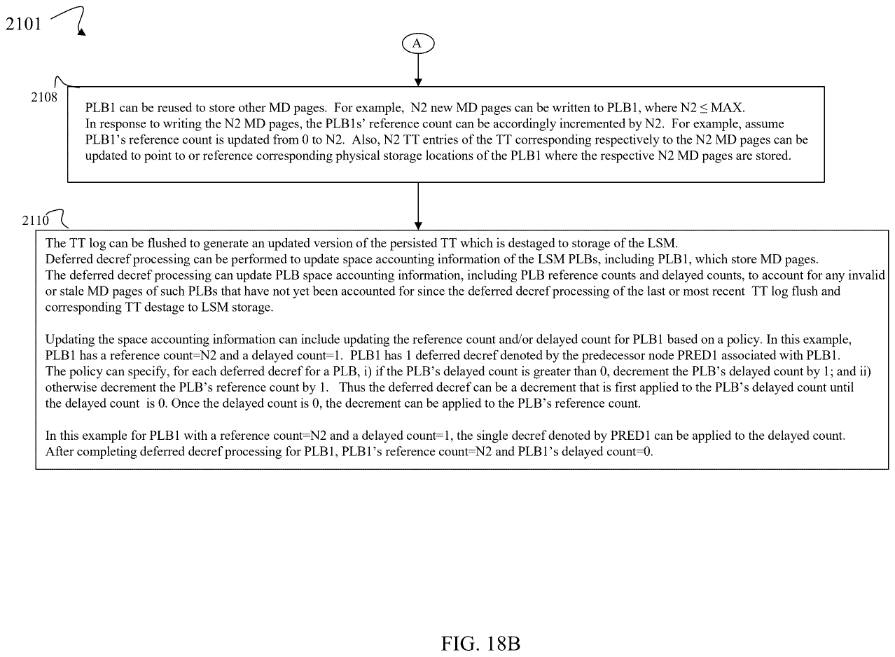

Referring to FIGS. 18A and 18B, shown is a flowchart 2100, 2101 of processing steps that can be performed in at least one embodiment in accordance with the techniques of the present disclosure. FIGS. 18A and 18B summarize processing described above.

At the step 2102, N MD pages can be written to a PLB1. Each of the MD pages can denote a first version V1 of the corresponding MD page. MAX can denote the maximum number of MD pages that PLB1 is capable of storing. In this example, N<MAX. MD1(1), denoting V1 of MD page MD1, can be one of the N MD pages written to the PLB1. In response to writing the N MD pages, the PLB1s' reference count can be accordingly updated and incremented by N. For example, assume PLB1's reference count is updated from 0 to N. Also, N TT entries of the TT corresponding respectively to the N MD pages can beupdated to point to or reference corresponding physical storage locations of the PLB1 where the respective N MD pages are stored. MD1(1) can be stored at PA1 in PLB1. TT entry E1 can map the logical address LA1 of MD1 to the physical storage location or address of the current valid version or copy of MD1. TT entry E1 can be updated to point to or reference PA1 of MD1(1). TT updates made in this step 2102 and other steps can be recorded in a TT log and also applied to an in-memory TT. From the step 2102, control proceeds to the step 2104.

At the step 2104, MD1(1) of the PLB1 can be updated so that a new version V2 of MD1 (denoted MD1(2) ) can be stored at physical address PA2 in a second PLB2. Thus MD1(1) of PLB1 is now invalid and MD1(2) is now the valid version or copy of MD1. PLB2's reference count can be incremented by 1. TT entry E1 can be updated to map LA1 of MD1 to PA2 where MD1(2) is stored. TT entry E1 can be associated with a predecessor entry PRED1 for the invalidated prior version MD1(1), where PRED1 can point to or reference PA1. PRED1 also represents a deferred decref or decrement to be made to space accounting information for PLB1 at a later point in time as part of deferred decref processing to account for the invalid page MD1(1). From the step 2104, control proceeds to the step 2106.

At the step 2106, GC processing can be performed. GC can perform a clean operation to copy content from multiple partially filled source PLBs to a single target PLB. GC processing can select multiple partially filled sources PLBs based, at least in part, on corresponding reference counts of the source PLBs so that generally the total sum of all reference counts of the source PLBs is equal to or less than MAX. PLB1 can be selected as a one of the source PLBs to be cleaned and have its content moved to the target PLB.

GC processing can scan the source PLB1 to determine which copies or versions of MD pages stored on PLB1 are valid and which are invalid. GC processing can determine whether each MD page version of PLB1 is valid or invalid based, at least in part, on the TT. For each MD page of PLB1, processing can determine whether the MD page's TT back pointer points to or references a corresponding TT entry that also points back to or references the physical address or location of the MID page as stored in PLB1. If so, then the MD page is valid, and otherwise the MD page is invalid or stale. For example, N−1 MD pages of PLB1 can be valid, and a single page, MD page MD1(1), can be invalid since its corresponding TT entry E2 references PA2 where MD1(2) is stored and does not reference PA1 where MD1(1) is stored.

GC processing can include cleaning PLB1 by copying only the N−1 valid MD pages from PLB1 to the target PLB. GC processing can update PLB1's reference count by decrementing PLB1's reference count by “N−1”. In this example, PLB1's reference count can be N which is decremented by “N−1” to have a final value of 1. PLB1's reference count denotes the number of outstanding or deferred decrefs to be processed in deferred decref processing. GC processing can transfer the remaining reference count of 1 for PLB 1 to PLB1's delayed count. As a result after GC processing, PLB1's reference count=0 and delayed count=1. PLB1 now has 100% free storage capacity as denoted by its reference count=0. From the step 2106, control proceeds to the step 2108.

At the step 2108, PLB1 can be reused to store other MD pages. For example, N2 new MD pages can be written to PLB1, where N2≤MAX. In response to writing the N2 MD pages, the PLB1s' reference count can be accordingly incremented by N2. For example, assume PLB1's reference count is updated from 0 to N2. Also, N2 TT entries of the TT corresponding respectively to the N2 MD pages can be updated to point to or reference corresponding physical storage locations of the PLB1 where the respective N2 MD pages are stored. From the step 2108, control proceeds to the step 2110.

At the step 2110, the TT log can be flushed to generate an updated version of the persisted TT which is destaged to storage of the LSM. Deferred decref processing can be performed to update space accounting information of the LSM PLBs, including PLB1, which store MD pages. The deferred decref processing can update PLB space accounting information, including PLB reference counts and delayed counts, to account for any invalid or stale MD pages of such PLBs that have not yet been accounted for since the deferred decref processing of the last or most recent TT log flush and corresponding TT destage to LSM storage.

Updating the space accounting information can include updating the reference count and/or delayed count for PLB1 based on a policy. In this example, PLB1 has a reference count=N2 and a delayed count=1. PLB1 has 1 deferred decref denoted by the predecessor node PRED1 associated with PLB1. The policy can specify, for each deferred decref for a PLB, i) if the PLB's delayed count is greater than 0, decrement the PLB's delayed count by 1; and ii) otherwise decrement the PLB's reference count by 1. Thus the deferred decref can be a decrement that is first applied to the PLB's delayed count until the delayed count is 0. Once the delayed count is 0, the decrement can be applied to the PLB's reference count.

In this example for PLB1 with a reference count=N2 and a delayed count=1, the single decref denoted by PREDI can be applied to the delayed count. After completing deferred decref processing for PLB1, PLB1's reference count=N2 and PLB1's delayed count=0.

The techniques herein can be performed by any suitable hardware and/or software. For example, techniques herein can be performed by executing code which is stored on any one or more different forms of computer-readable media, where the code can be executed by one or more processors, for example, such as processors of a computer or other system, an ASIC (application specific integrated circuit), and the like. Computer-readable media can include different forms of volatile (e.g., RAM) and non-volatile (e.g., ROM, flash memory, magnetic or optical disks, or tape) storage which can be removable or non-removable.

While the techniques of the present disclosure have been presented in connection with embodiments shown and described in detail herein, their modifications and improvements thereon will become readily apparent to those skilled in the art. Accordingly, the spirit and scope of the techniques of the present disclosure should be limited only by the following claims.

What is claimed is:

1. A computer-implemented method comprising:
storing N metadata (MD) pages in a first physical large block (PLB) of non-volatile storage, wherein the N MD pages include a first version of a first MD page, wherein a translation table (TT) includes TT entries used to map logical addresses of MD pages to corresponding physical locations of current valid versions of the MD pages, wherein N TT entries of the TT corresponding respectively to the N MD pages reference N corresponding physical locations of the first PLB where the N MD pages are stored, wherein a first TT entry E1 of the TT maps the logical address LA1 of the first MD page to a first physical location PA1 where the first version of the first MD page is stored in the first PLB;
incrementing a reference count of the first PLB by N, wherein the reference count denotes a number of MD pages currently stored in the first PLB;
storing a second version of the first MD page at a second physical address PA2 in a second PLB of non-volatile storage, wherein the second version of the first MD page denotes a more recent version of the first MD page than the first version of the first MD page, wherein said storing the second version of the first MD page results in the first version of the first MD page of the first PLB being invalidated;
in response to said storing the second version of the first MD page, performing processing including:
updating the first TT entry E1 to map LA1 to PA2 in the second PLB where the second version of the first MD page is stored; and
recording a first deferred decrement operation associated with the first PLB, wherein the first deferred decrement operation corresponds to the first version of the first MD page being invalidated;
performing garbage collection (GC) processing to combine content from multiple source PLBs to a target PLB, including:
selecting the first PLB as one of the multiple source PLBs based, at least in part, on the reference count of the first PLB;
scanning the first PLB to determine which MD pages stored on the first PLB are valid, wherein said scanning includes determining, using the TT, that the first version of the first MD page stored at PA1 of the first PLB is invalid;
copying first valid MD pages from the first PLB to the target PLB;
for each of the first valid MD pages copied from the first PLB to the target PLB, decrementing the reference count of the first PLB by one;
setting a delayed count of the first PLB to the reference count of the first PLB; and
setting the reference count of the first PLB to zero to denote that the first PLB has 100% free storage capacity; and
performing deferred decrement processing for the first PLB to process deferred decrement operations, including the first deferred decrement operation, associated with the first PLB, including:
updating space accounting information for the first PLB based, at least in part, on a policy, wherein the space accounting information for the first PLB includes the reference count of the first PLB and the delayed count of the first PLB, wherein the policy indicates, for each deferred decrement operation whether to apply said each deferred decrement operation to the reference count of the first PLB or the delayed count of the first PLB.

2. The computer-implemented method of claim 1, wherein the policy specifies that, if the delayed count is greater than 0, to apply said each deferred decrement operation to the delayed count of the first PLB, and to otherwise apply said each deferred decrement operation to the reference count of the first PLB.

3. The computer-implemented method of claim 2, wherein applying said each deferred decrement operation to the delayed count includes decrementing the delayed count by 1.

4. The computer-implemented method of claim 3, wherein applying said each deferred decrement operation to the reference count includes decrementing the reference count by 1.

5. The computer-implemented method of claim 1, wherein the delayed count of the first PLB denotes a number of deferred decrements for invalid pages of the first PLB that have not been applied to the space accounting information of the first PLB.

6. The computer-implemented method of claim 1, wherein said recording the first deferred decrement operation associated with the first PLB, includes:
creating a first predecessor entry of the TT, wherein the first predecessor entry denotes the first version of the first MD page being invalidated, wherein the first predecessor entry is associated with the first TT entry E1 of the TT corresponding to the first MD page, wherein the first predecessor entry denotes the first deferred decrement operation.

7. The computer-implemented method of claim 6, wherein said deferred decrement processing for the first PLB includes:
performing a deferred decrement operation for each of one or more predecessor entries associated with the first PLB, wherein said each predecessor entry denotes an invalid MD page stored on the first PLB.

8. The computer-implemented method of claim 1, wherein the TT includes an in-memory TT and a persisted TT stored on non-volatile storage in a log structured storage system (LSS).

9. The computer-implemented method of claim 8, wherein TT updates to the TT are recorded in a TT log and applied to the in-memory TT.

10. The computer-implemented method of claim 9, wherein the TT updates include a first TT update to update the first TT entry E1 to map LA1 to PA2 in the second PLB where the second version of the first MD page is stored.

11. The computer-implemented method of claim 10, wherein the persisted TT is a first version of the TT, and wherein the method further comprises:
performing first processing to flush the TT log and destage an updated version of the persisted TT.

12. The computer-implemented method of claim 11, wherein the TT log includes a frozen TT log and an active TT log, and wherein said first processing includes performing said deferred decrement processing for the first PLB.

13. The computer-implemented method of claim 12, wherein said first processing includes:
flushing the frozen TT log including the TT updates; and
applying the TT updates to the first version of the persisted TT to generate an updated TT which is destaged as a second version of the persisted TT.

14. The computer-implemented method of claim 11, wherein said determining, using the TT, that the first version of the first MD page stored at PA1 of the first PLB is invalid, further comprises:
determining whether the first TT entry E1 maps LA1 to PA1; and
responsive to determining that the first TT entry E1 does not map LA1 to PA1, determining that the first version of the first MD page stored at PA1 is invalid.

15. The computer-implemented method of claim 14, wherein the first PLB includes a first TT back pointer for the first version of the first MD page, wherein the first TT back pointer references the first TT entry El.

16. The computer-implemented method of claim 15, wherein a first version of a second MD page is stored at a third physical location PA3 of the first PLB, wherein a second TT entry E2 maps a second logical address LA2 of the second MD page to a current physical location of a valid version of the second MD page, wherein the second TT entry E2 maps LA2 to PA3, wherein a second TT back pointer of the first PLB references the second TT entry E2.

17. The computer-implemented method of claim 16, wherein said scanning the first PLB to determine which MD pages stored on the first PLB are valid further includes determining, using the TT, that the first version of the second MD page stored at PA3 of the first PLB is valid.

18. The computer-implemented method of claim 17, wherein said determining, using the TT, that the first version of the second MD page stored at PA3 of the first PLB is valid, further comprises:
locating the second TT entry E2 using the second TT back pointer;
determining whether the second TT entry E2 maps LA2 to PA3; and
responsive to determining that the second TT entry E2 maps LA1 to PA3, determining that the first version of the second MD page stored at PA3 is valid.

19. A system comprising:
one or more processors; and
a memory comprising code stored thereon that, when executed, performs a method comprising:
storing N metadata (MD) pages in a first physical large block (PLB) of non-volatile storage, wherein the N MD pages include a first version of a first MD page, wherein a translation table (TT) includes TT entries used to map logical addresses of MD pages to corresponding physical locations of current valid versions of the MD pages, wherein N TT entries of the TT corresponding respectively to the N MD pages reference N corresponding physical locations of the first PLB where the N MD pages are stored, wherein a first TT entry E1 of the TT maps the logical address LA1 of the first MD page to a first physical location PA1 where the first version of the first MD page is stored in the first PLB;
incrementing a reference count of the first PLB by N, wherein the reference count denotes a number of MD pages currently stored in the first PLB;
storing a second version of the first MD page at a second physical address PA2 in a second PLB of non-volatile storage, wherein the second version of the first MD page denotes a more recent version of the first MD page than the first version of the first MD page, wherein said storing the second version of the first MD page results in the first version of the first MD page of the first PLB being invalidated;
in response to said storing the second version of the first MD page, performing processing including:
updating the first TT entry E1 to map LA1 to PA2 in the second PLB where the second version of the first MD page is stored; and
recording a first deferred decrement operation associated with the first PLB, wherein the first deferred decrement operation corresponds to the first version of the first MD page being invalidated;
performing garbage collection (GC) processing to combine content from multiple source PLBs to a target PLB, including:
selecting the first PLB as one of the multiple source PLBs based, at least in part, on the reference count of the first PLB;
scanning the first PLB to determine which MD pages stored on the first PLB are valid, wherein said scanning includes determining, using the TT, that the first version of the first MD page stored at PA1 of the first PLB is invalid;
copying first valid MD pages from the first PLB to the target PLB;
for each of the first valid MD pages copied from the first PLB to the target PLB, decrementing the reference count of the first PLB by one;
setting a delayed count of the first PLB to the reference count of the first PLB; and
setting the reference count of the first PLB to zero to denote that the first PLB has 100% free storage capacity; and
performing deferred decrement processing for the first PLB to process deferred decrement operations, including the first deferred decrement operation, associated with the first PLB, including:
updating space accounting information for the first PLB based, at least in part, on a policy, wherein the space accounting information for the first PLB includes the reference count of the first PLB and the delayed count of the first PLB, wherein the policy indicates, for each deferred decrement operation whether to apply said each deferred decrement operation to the reference count of the first PLB or the delayed count of the first PLB.

20. One or more non-transitory computer readable media comprising code stored thereon that, when executed, performs a method comprising:
storing N metadata (MD) pages in a first physical large block (PLB) of non-volatile storage, wherein the N MD pages include a first version of a first MD page, wherein a translation table (TT) includes TT entries used to map logical addresses of MD pages to corresponding physical locations of current valid versions of the MD pages, wherein N TT entries of the TT corresponding respectively to the N MD pages reference N corresponding physical locations of the first PLB where the N MD pages are stored, wherein a first TT entry E1 of the TT maps the logical address LA1 of the first MD page to a first physical location PA1 where the first version of the first MD page is stored in the first PLB;
incrementing a reference count of the first PLB by N, wherein the reference count denotes a number of MD pages currently stored in the first PLB;
storing a second version of the first MD page at a second physical address PA2 in a second PLB of non-volatile storage, wherein the second version of the first MD page denotes a more recent version of the first MD page than the first version of the first MD page, wherein said storing the second version of the first MD page results in the first version of the first MD page of the first PLB being invalidated;
in response to said storing the second version of the first MD page, performing processing including:
updating the first TT entry E1 to map LA1 to PA2 in the second PLB where the second version of the first MD page is stored; and
recording a first deferred decrement operation associated with the first PLB, wherein the first deferred decrement operation corresponds to the first version of the first MD page being invalidated;
performing garbage collection (GC) processing to combine content from multiple source PLBs to a target PLB, including:
selecting the first PLB as one of the multiple source PLBs based, at least in part, on the reference count of the first PLB;
scanning the first PLB to determine which MD pages stored on the first PLB are valid, wherein said scanning includes determining, using the TT, that the first version of the first MD page stored at PA1 of the first PLB is invalid;
copying first valid MD pages from the first PLB to the target PLB;
for each of the first valid MD pages copied from the first PLB to the target PLB, decrementing the reference count of the first PLB by one;
setting a delayed count of the first PLB to the reference count of the first PLB; and
setting the reference count of the first PLB to zero to denote that the first PLB has 100% free storage capacity; and
performing deferred decrement processing for the first PLB to process deferred decrement operations, including the first deferred decrement operation, associated with the first PLB, including:
updating space accounting information for the first PLB based, at least in part, on a policy, wherein the space accounting information for the first PLB includes the reference count of the first PLB and the delayed count of the first PLB, wherein the policy indicates, for each deferred decrement operation whether to apply said each deferred decrement operation to the reference count of the first PLB or the delayed count of the first PLB.
